(19) United States
(12) Patent Application Publication
(10) Pub. No.: US 2004/0148248 A1
(43) Pub. Date: Jul. 29, 2004

(54) Secondary transfers of restricted interests

(76) Inventors: Laurence G. Allen, Greenwich, CT (US); George M. Regnery, Greenwich, CT (US)

Correspondence Address: FISH & RICHARDSON PC, 225 FRANKLIN ST, BOSTON, MA, 02110, US

(21) Appl. No.: 10/460,538

(22) Filed: Jun. 12, 2003

Related U.S. Application Data
(60) Provisional application No. 60/437,817, filed on Jan. 3, 2003.
(60) Provisional application No. 60/438,200, filed on Jan. 6, 2003.

(51) Int. Cl. G06F 17/60

(52) U.S. Cl. 705/37

(57) ABSTRACT

A facility that provides information about and enables secondary transfers of restricted interests in issuers.

This application is entitled to and claims the benefit of priority of United States Provisional Patent Applications serial No. 60/437,817 (filed on Jan. 3, 2003) and serial No. 60/438,200, filed Jan. 6, 2003, both of which are incorporated by reference in their entirety.

This application is accompanied by two duplicate compact disks (and paper copies) containing the following four files representing computer program listing appendices A, B, C, and D referenced in the specification, and incorporated here by reference:

| File name | Date created | Size |
|---|---|---|
| pc_account.txt, | Created Jun. 12, 2003 | 54.1 KB |
| PT-George.txt | Created Jun. 12, 2003 | 107.2 KB |
| pt_accounts.txt | Created Jun. 12, 2003 | 52.3 KB |
| PC-George.txt | Created Jun. 12, 2003 | 93.3 KB |

### BACKGROUND

This description relates to transfers of restricted interests, including secondary transfers.

Unlike securities that are listed for public trading on exchanges, interests in private companies, partnerships, and other ventures are typically not easily transferred from a seller to a buyer. The transfers may be restricted by governments (for example, through federal and state securities laws and regulations) or by the issuers of the interests (for example, through contract or the administrative control of the board of directors or a general partner). We intend the phrase “restricted interests” to be construed broadly to refer to stocks, bonds, securities, and all types of investment interests in, for example, companies, partnerships, or other ventures, in a context in which there are more restrictive limitations on transferring the interests than would be the case for a publicly-traded security. A limited partnership interest or a limited liability company interest (which together we sometimes refer to as private partnerships) is one specific example. Restricted shares of stock in an unlisted company are another. Ventures issuing restricted securities could include private equity funds, leveraged buyout funds, mezzanine funds, real estate funds, oil and gas funds, and hedge funds, for example. Restricted interests can include interests in issuers that are not listed on a stock exchange (such as the New York Stock Exchange, the American Stock Exchange, or NASDAQ in the United States or the London Stock Exchange, Tokyo Stock Exchange, and other exchanges outside the United States). Restricted interests also include interests in non-United States partnerships and private companies. The issuers may be ones that report to the SEC and that have securities trading in the over the counter market or by pink sheets.

The values of restricted interests tend to be lower than they might otherwise be if traded on a public exchange, because the market for them is limited and the mechanisms for transfer are restricted. In addition, information about the performance, plans, and operations of the issuer is normally disseminated only to, for example, the partners of a partnership or the shareholders of a private company. The information is considered confidential and its dissemination is carefully controlled, for example, by the general partner of a limited partnership or the company issuer of private company interests. The lack of publicly available information tends to reduce the transfer values of restricted securities.

### SUMMARY

In general, in one aspect, the invention features a method that includes receiving from users, buy or sell orders, each of the buy or sell orders being for an amount of an identified restricted interest to be subjected to a secondary transfer at a proposed value, and displaying the buy and sell orders for review by online or offline users.

Implementations of the invention may include one or more of the following features. The restricted interests comprise interests in limited partnerships. The restricted interests comprise interests in private companies. Information is displayed about an issuer of the restricted interest. Permission of the issuer of the restricted interest is obtained to display the information about the issuer. The proposed value is expressed relative to an asset value associated with the interest. The proposed value is expressed as a percentage of the net asset value of the interest. The proposed value takes account of characteristics of the issuer of the interest. The proposed value takes account of historic information associated with the issuer or the interest. The proposed value takes account of market conditions. The amount of the identified restricted interest represents a funded commitment and an unfunded commitment. The online users comprise potential buyers and sellers of restricted interests. The online users comprise an issuer of the restricted interest.

The restricted interest is identified by a symbol that includes an abbreviation representing the issuer of the interest uniquely as among other interests of a same type and by an identifier of the type of the interest. There is a separator character between the abbreviation and the type. The symbol is of the form XXXXX.YYY_Z where XXXXX is an alphabetic string abbreviation of at least two characters, YYY is an alphabetic string identifier of a type, and Z is a sequential character. For example, Everlast Associates Limited Partnership may be an issuer of interests in a ninth fund in a series. Then the symbol for that interest could be EA.LP 9. For a private partnership, the type could be LP, while for a private company, the type could be PP. For a private company, the sequential character could designate the class. For example, TECHIE XT class C could have the symbol “TEC.PP C”. The buy and sell orders are displayed only to online users who have demonstrated their compliance with regulatory or policy conditions to their being exposed to the orders. The symbols may be issued by a single market facilitator in order to provide a consistent set of globally unique symbols that would be recognized internationally.

In general, in another aspect, the invention features a method that includes receiving information related to the values of restricted interest in respective issuers, estimating values of the restricted interests based on the received information, and making the values accessible online to users. The estimated values could be, for example, fair market values determined by a valuation algorithm.

Implementations of the invention may include one or more of the following features. At least some of the information is received from the issuers. At least some of the information is received from the users. At least some of the information is received from public sources. At least some of the information is received from private sources. The information includes data indicative of the reputations of the issuers. The information estimating is based on at least one of an historical record of generating superior returns versus comparable firms, noteworthy successful investments, and an assessment of institutional investor secondary market demand for the interests. The values are expressed relative to an asset value associated with the interest. The proposed value is expressed as a percentage of the net asset value of the interest.

In general, in another aspect, the invention features a method that includes maintaining digital data (in some implementations, fair market value estimates, or historical actual transfer prices, or current offering prices) representing valuations of previously issued restricted interests of respective issuers, and providing the digital data for presentation to users.

Implementations of the invention may include one or more of the following features. The digital data is maintained on a server. The valuations are expressed relative to asset values associated with the interests. The valuations are expressed as percentages of the net asset values of the interests. The digital data is provided in the form of a stream of digital data conveyed through a communication medium, displaying the digital data to a user. The digital data is displayed as a ticker. The ticker is displayed as a scrolling ticker or may be provided in response to an inquiry to a search engine. The digital data is displayed by a party other than the party that maintains the data. The digital data includes symbols representing issuers and numbers representing valuations. Each of the symbols includes an abbreviation representing the issuer of the interest uniquely as among other interests of a same type and includes an identifier of the type of the interest. The digital data also includes a separator character between each of the abbreviations and the types. Each of the symbols is of the form XXXXX.YYY where XXXXX is an alphabetic string abbreviation of at least characters and YYY is an alphabetic string identifier of a type. The scrolling price ticker shows a fund symbol and a valuation or shows a company symbol and a valuation, e.g., a fair market valuation. A user can create a custom symbol for the purpose of entering non-public information about an interest for use in the value calculator.

In general, in another aspect, the invention features a method that includes maintaining information about progress of steps associated with a secondary transfer of a restricted interest of an issuer, and enabling a user to review the progress electronically. In some implementations, the steps are standardized to permit a paper intensive process among multiple parties to be completely quickly and effectively.

Implementations may include one or more of the following features. Steps associated with the secondary transfer of a particular type of restricted interest are predefined, and information is maintained about progress based on the predefined steps. The predefined steps include steps to be performed by at least two different parties. The different parties include two of the following: a buyer, a seller, an issuer, a transfer agent, and an escrow agent. The steps include steps performed by at least two different parties. The two different parties include two of a buyer, a seller, an issuer, and an escrow agent. The method of claim in which enabling the user to review the progress electronically includes giving the user access to an online service that displays the progress. The steps of the progress are organized by the parties who are to perform the steps or by chronological stages. The progress is displayed in terms of the progress of each of at least two different parties in completing their respective steps. The user is enabled to view documents associated with at least some (or in some implementations all) of the steps. The steps are predefined at least partially by the issuer of the interest. Each party can view the steps completed by other parties. The concept of maintaining progress on the steps is not limited to a transfer of restricted interests but could also apply to other transactions, such as mortgage lending.

In general, in another aspect, the invention features a method that includes receiving from a user of an online service a request for a valuation of an amount of a restricted interest that has been previously issued, and generating the valuation based in part on stored information about an issuer of the restricted interest, and providing the valuation online to the user.

Implementations of the invention may include one or more of the following features. The restricted interest includes a funded commitment and an unfunded commitment. The restricted interest includes an interest in a limited partnership. The restricted interest includes an interest in a private company. The valuation includes information about the value of swapping the interest for another restricted interest. The valuation is based in part on information received from the user about expected future performance of the interest. The valuation is based upon a set of weighted factors. Among other techniques, some of the valuations are done using current data and some are done using separate funded and unfunded valuations. The user is an owner of the interest. The user is an agent acting on behalf of an owner of the interest. A request is received from a user for valuation of a portfolio of restricted interests, the valuation is generated based on valuations of each of the interests, and the portfolio valuation is provided online to the user.

In general, in another aspect, the invention features a method that includes expressing an order to buy or sell a restricted interest that has been previously issued, in a digital format in which the identity of the interest is expressed as a predefined symbol, an amount of the interest is expressed in money (in some implementations as a dollar amount of a commitment to a fund, or a quantity of shares of a company in the case of equities, or a dollar amount of face amount of company's debt related securities, i.e., convertibles), and a price for the interest is expressed in relationship to an asset value of the interest.

Implementations of the invention may include one or more of the following features. The order is expressed in fields of an online form, e.g., an order ticket. The order expresses a funded aspect of the interest and an unfunded aspect of the interest.

In general, in another aspect, the invention features a method that includes receiving from an issuer of restricted interests that have previously been issued, policy information that defines the conditions under which the issuer will permit confidential information about the issuer or the restricted interests to be made available electronically to users, and preventing the users from gaining electronic access to the confidential information except upon compliance with the conditions.

Implementations of the invention may include one or more of the following features. Preventing access includes requiring the user to register. The user is required to request permission to have access to the confidential information. The issuer is requested to approve access to the confidential information by the users based on information provided to the issuer. (Protecting an issuer's non-public information in the offering and transfer processes is important to issuers.)

In general, in another aspect, the invention features a method that includes predefining a set of documents to be made available to a user in connection with a transfer of a restricted interest that has been previously issued, the set of documents being predefined to satisfy applicable regulatory and policy requirements applicable to the transfer, and making the set of documents accessible to the user online in connection with the transfer.

Implementations of the invention may include one or more of the following features. The set is predefined in part by an issuer of the interest. The set includes a prior offering memorandum. The set includes a recent financial statement.

In general, in another aspect, the invention features a method that includes receiving from a user information concerning historical performance of a restricted interest that has been previously issued, and basing a valuation of interest in part on the historical performance information.

Implementations of the invention may include one or more of the following features. The historical performance information is confidential. The user is an owner of the restricted interest. The historical performance information comprises a sequence of return figures for a successive of periods of time.

In general, in another aspect, the invention features a method that includes receiving from a financial institution an online request to facilitate a transfer of a restricted interest that has previously been issued, from a seller to a buyer, and serving the request by making an online market in restricted interests accessible to the seller and the buyer.

Implementations of the invention may include one or more of the following features. The seller is a customer of the financial institution.

In general, in another aspect, the invention features a method that includes receiving information about restricted interests that have previously been issued, the information being useful to buyers or sellers of the interests, and automatically generating research reports on the restricted interests based on the information.

The system can provide flexible offline and scalable online services to a wide range of users. Online implementations can be scaled to handle essentially 100% of the global transfer volume of restricted interests.

Other advantages and features will become apparent from the following description and from the claims.

### DESCRIPTION

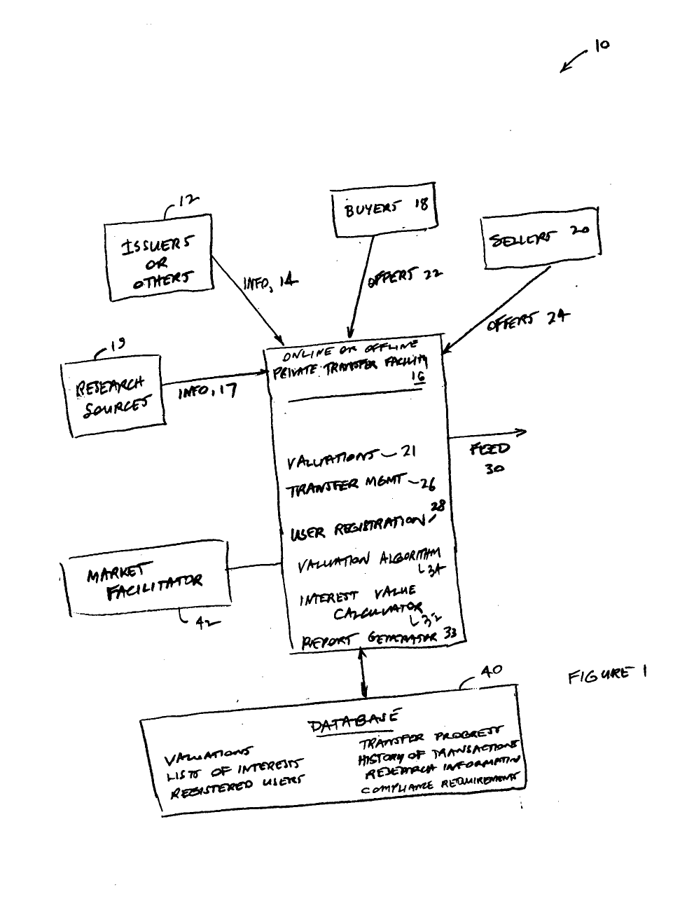

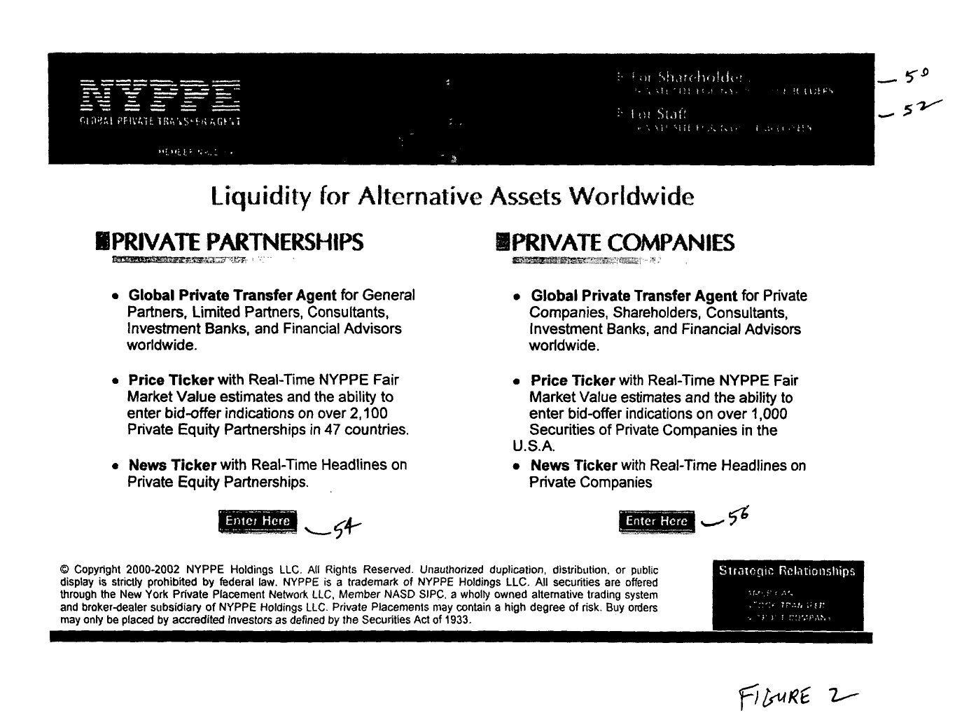

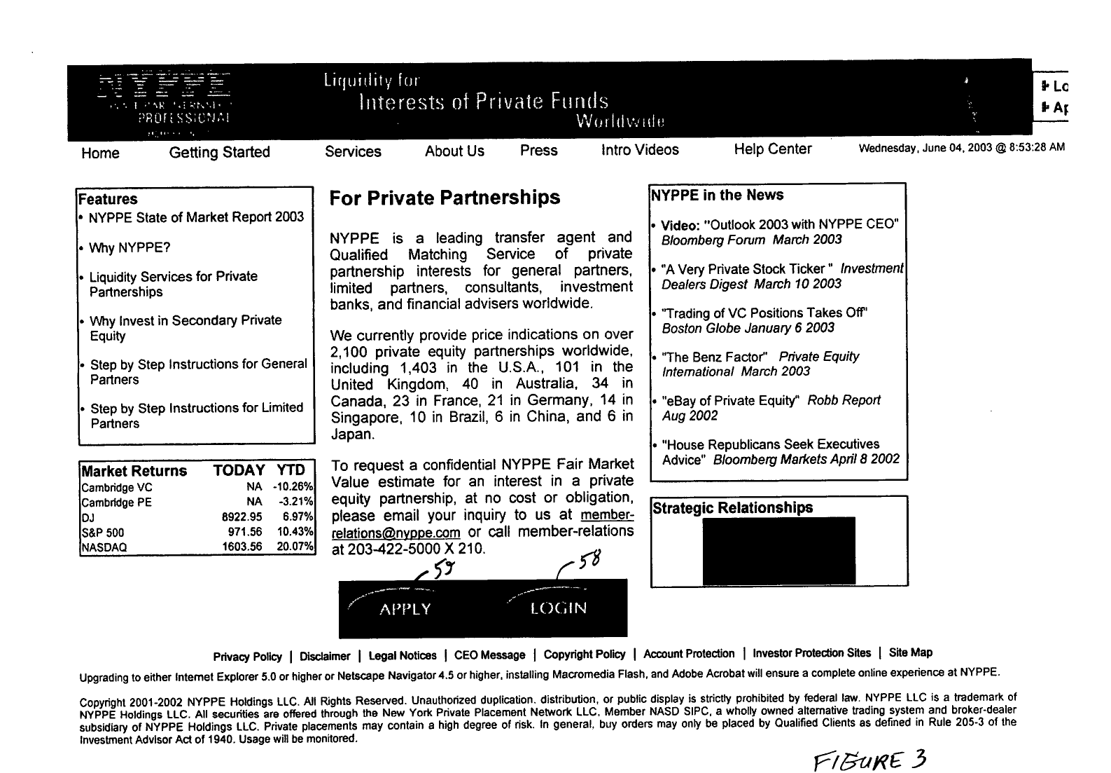

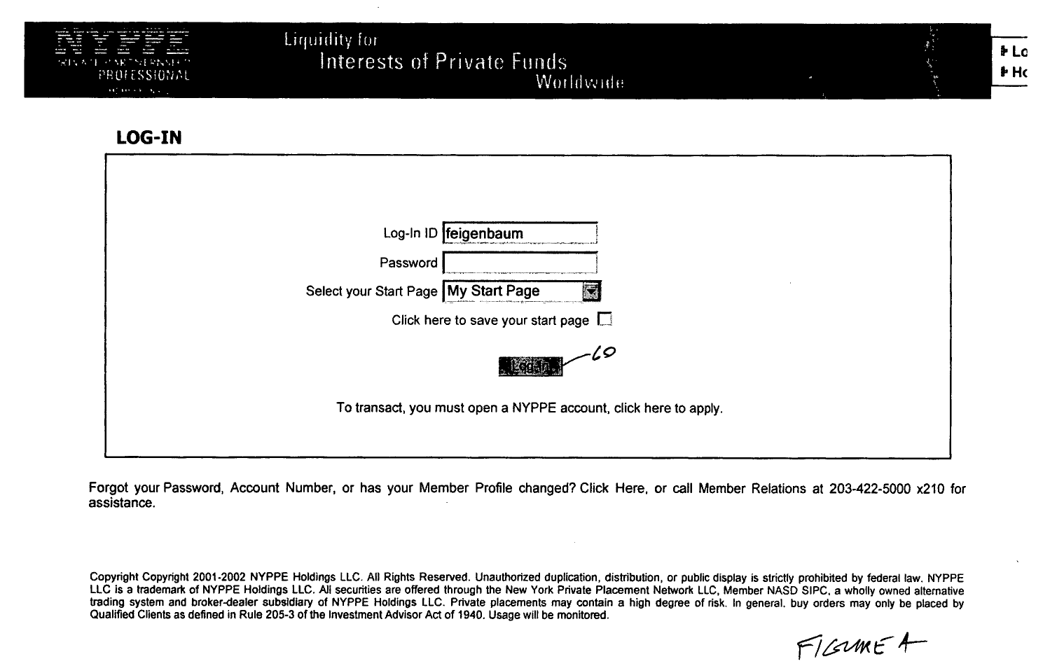

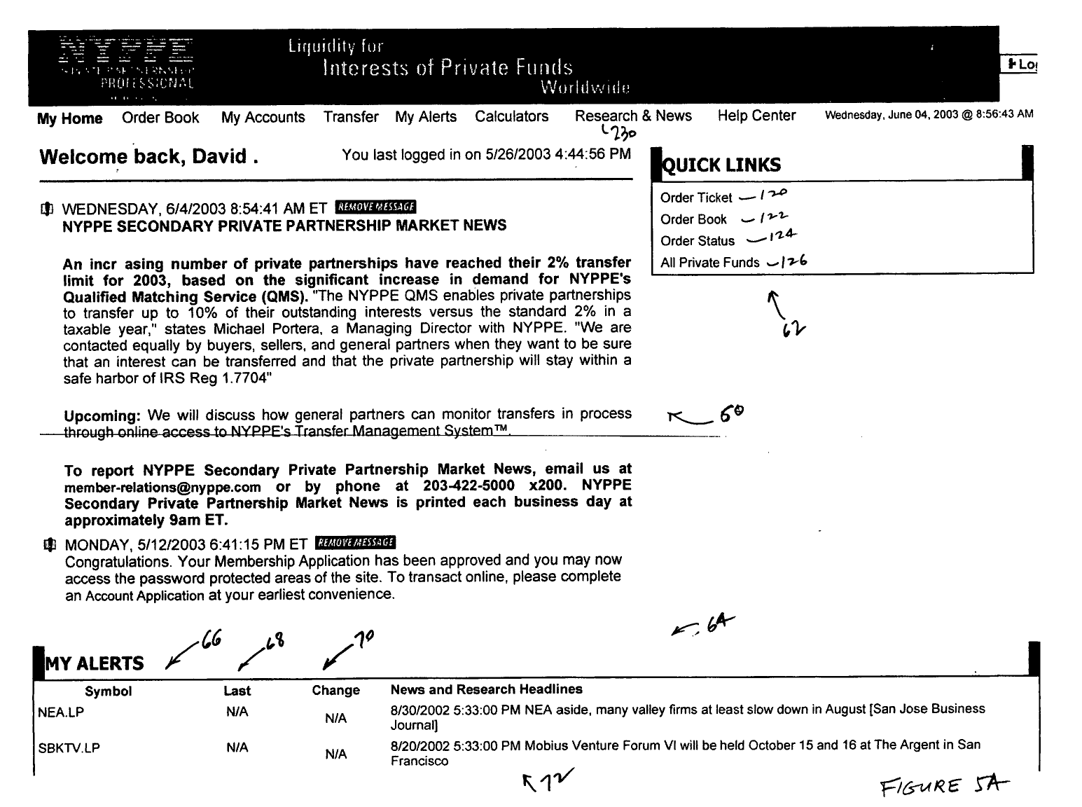

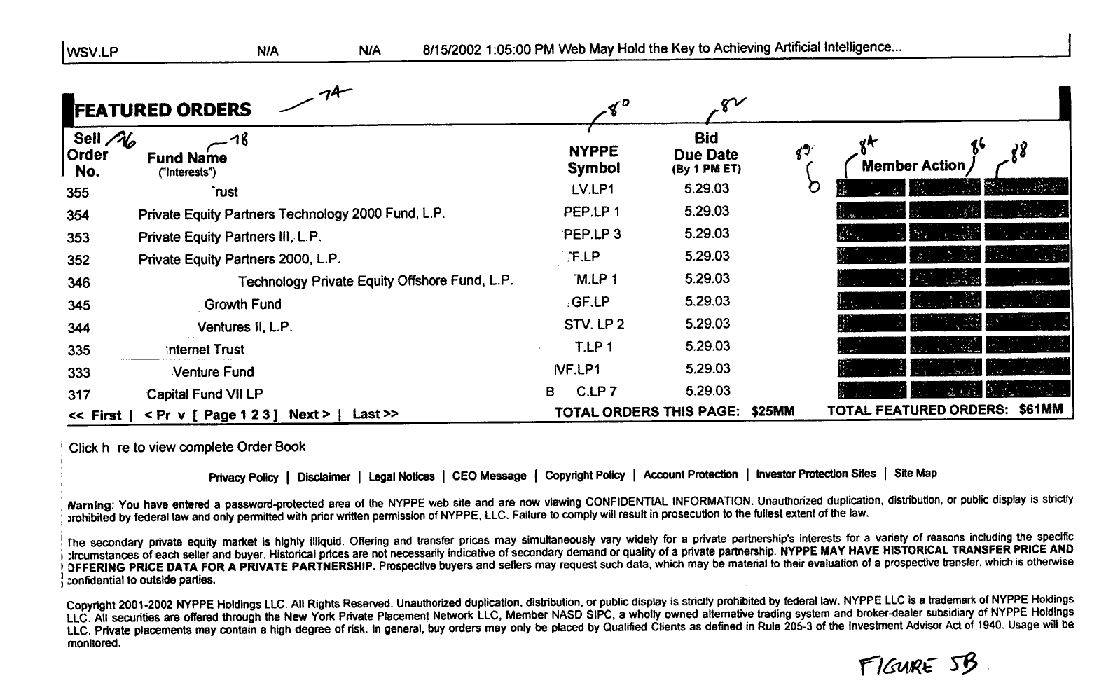

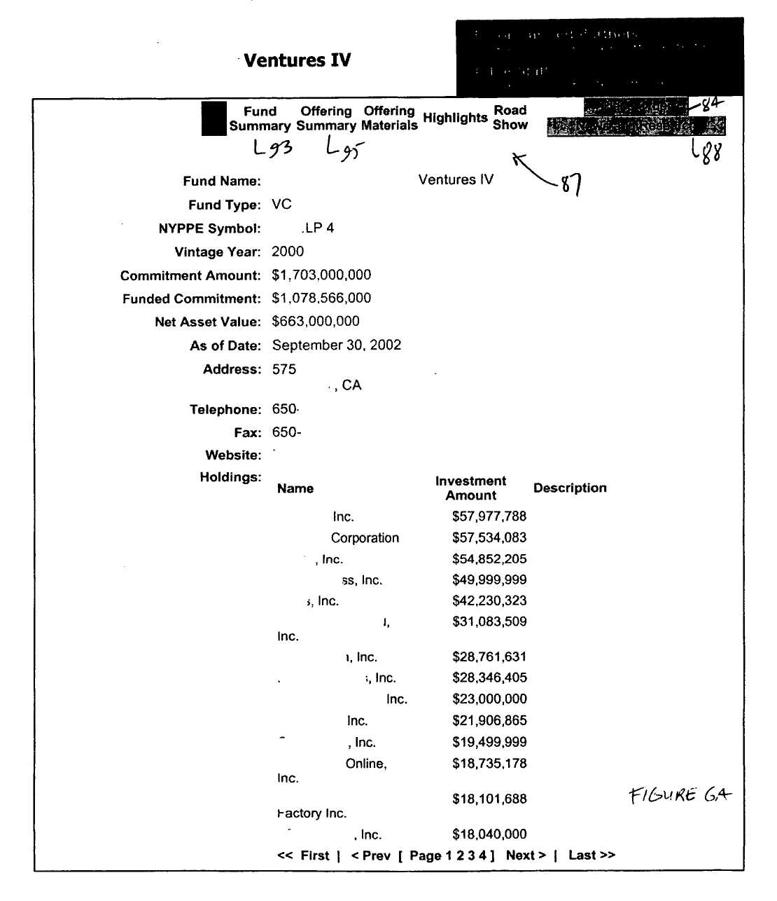

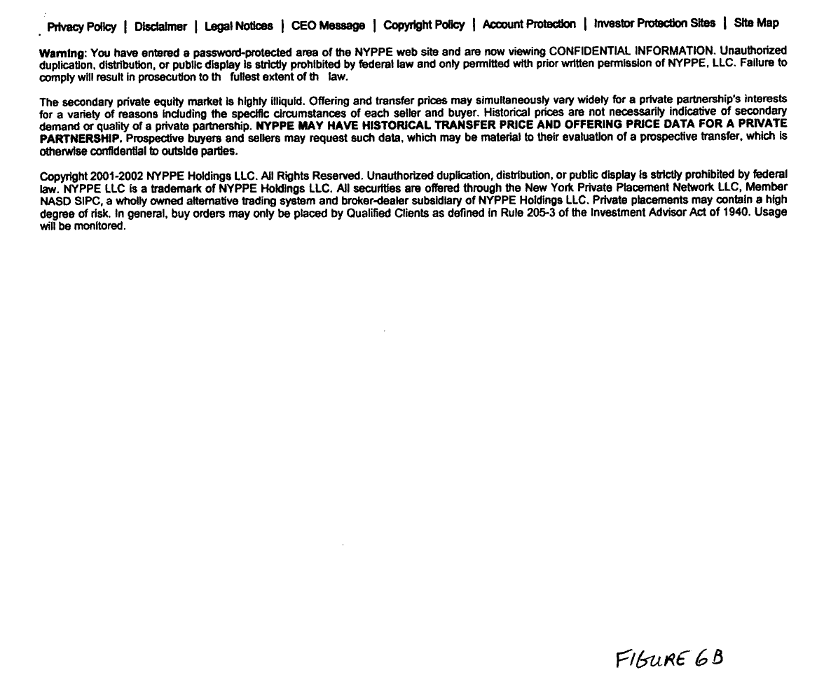

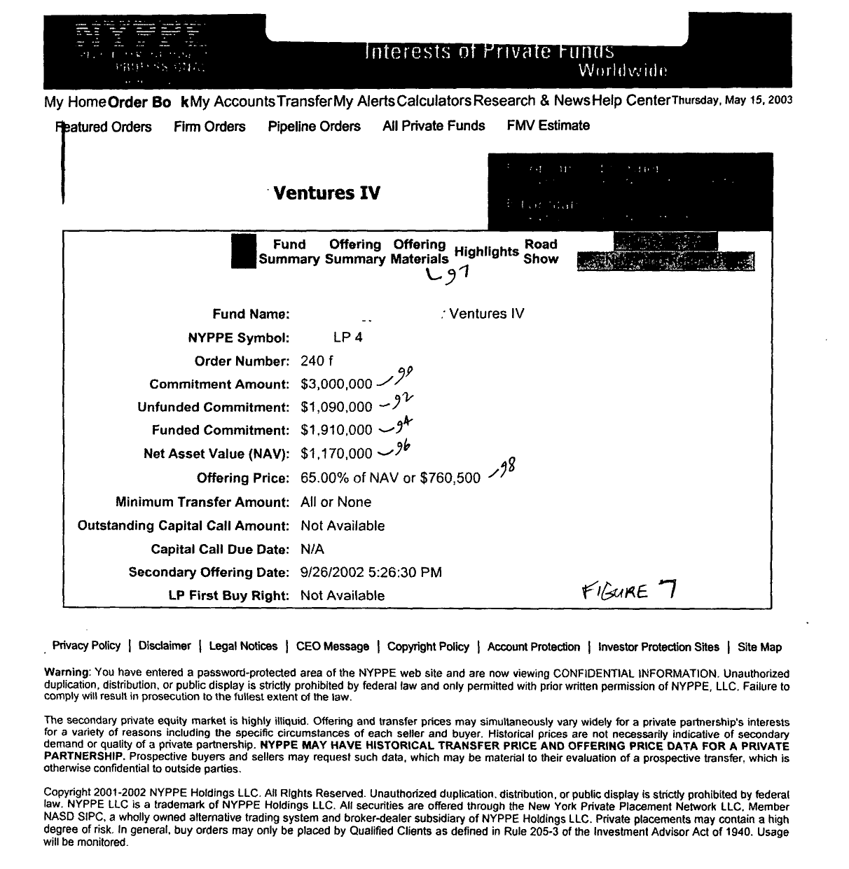

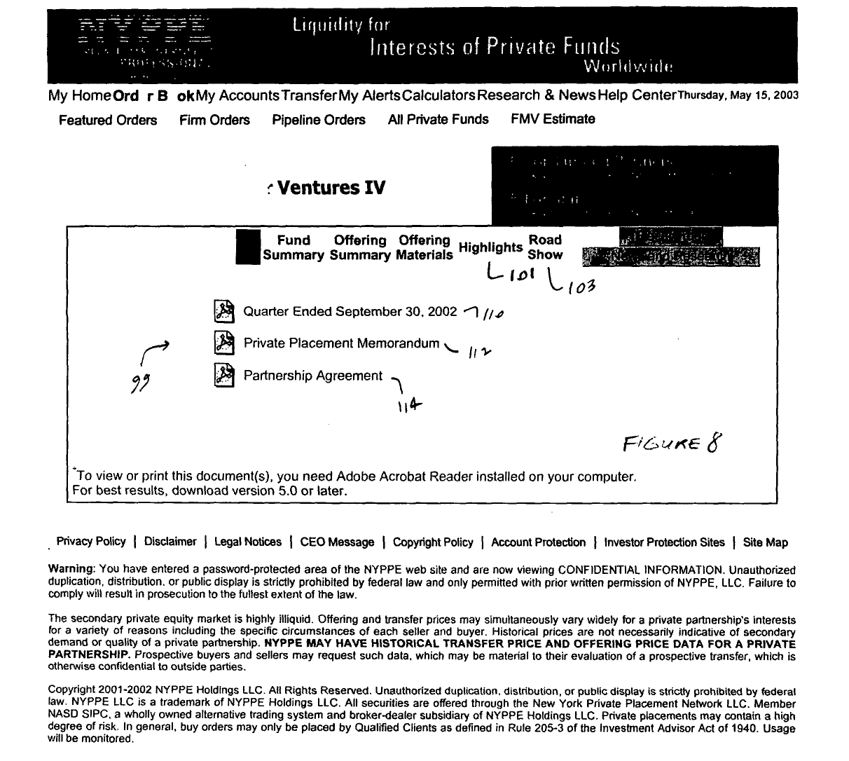

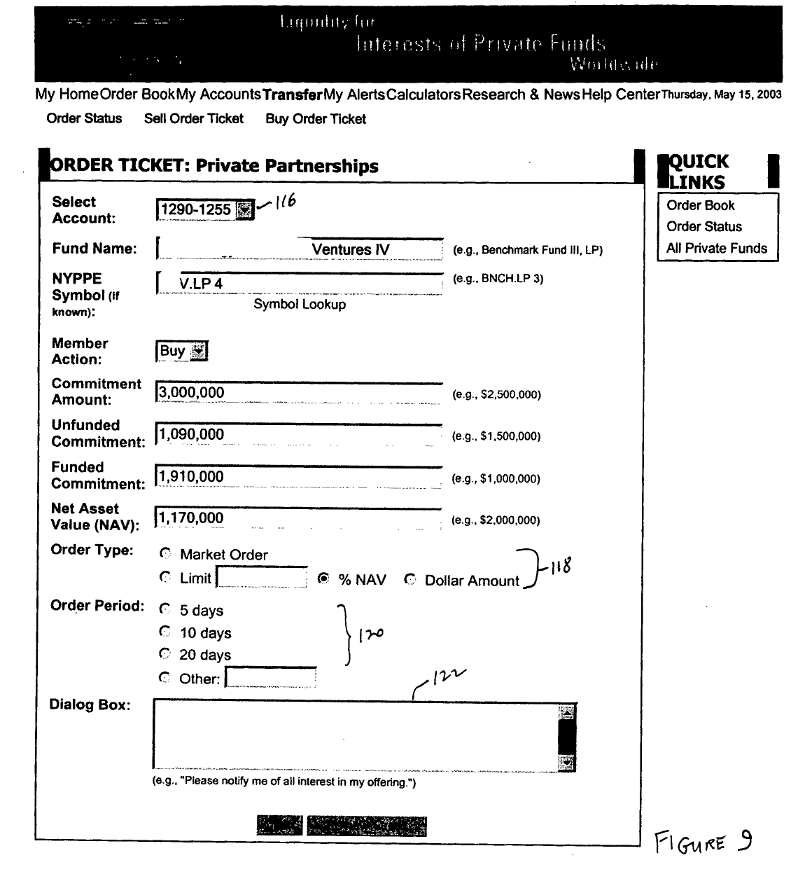

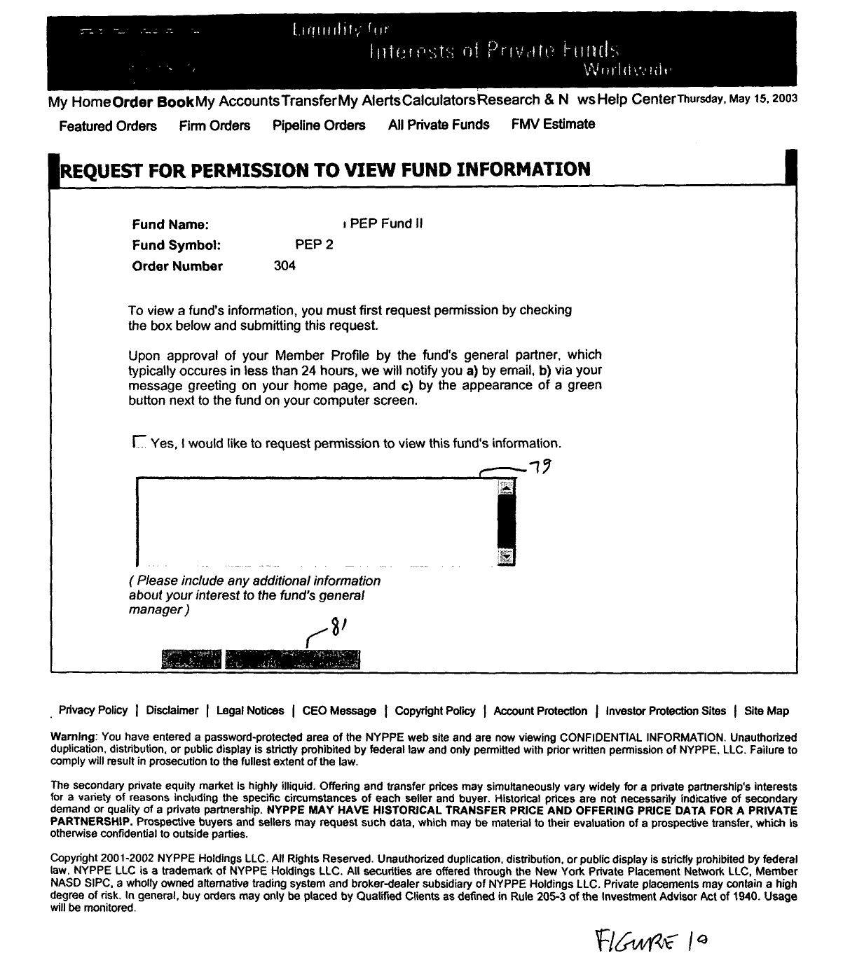

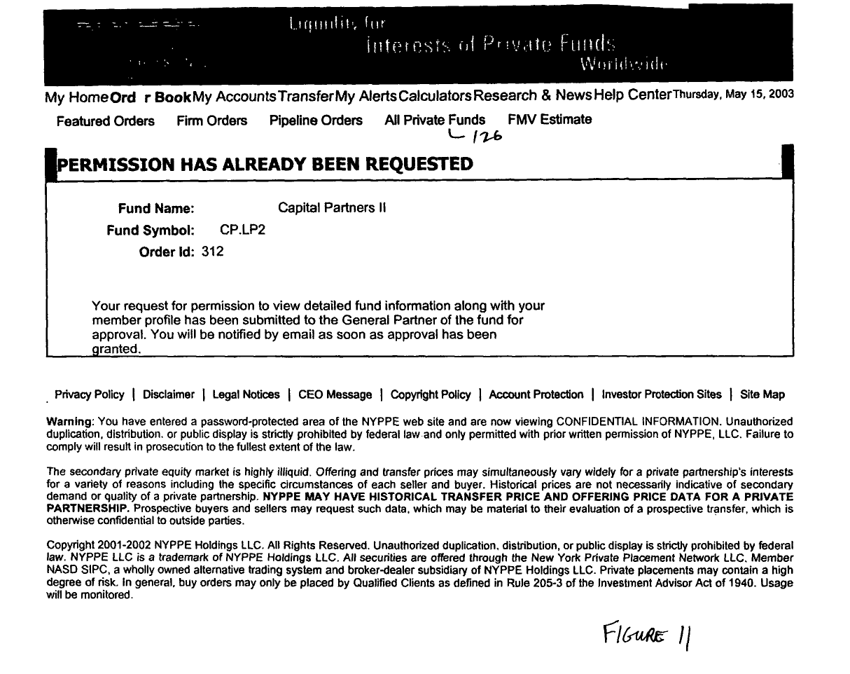

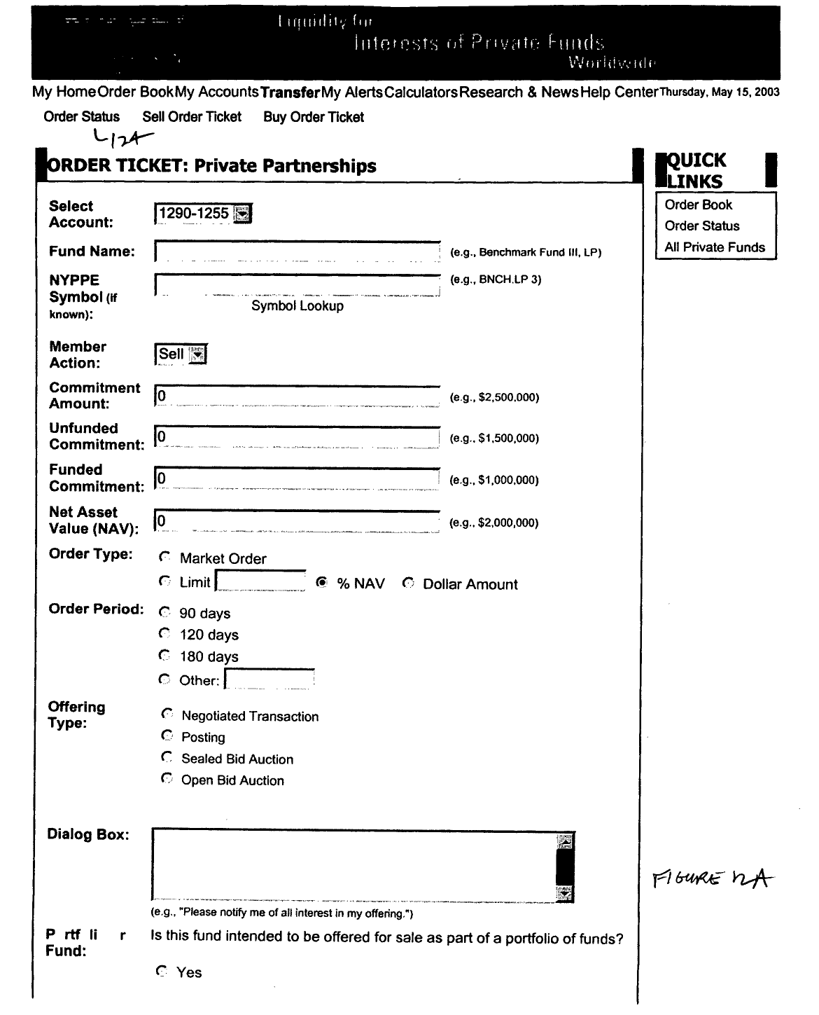

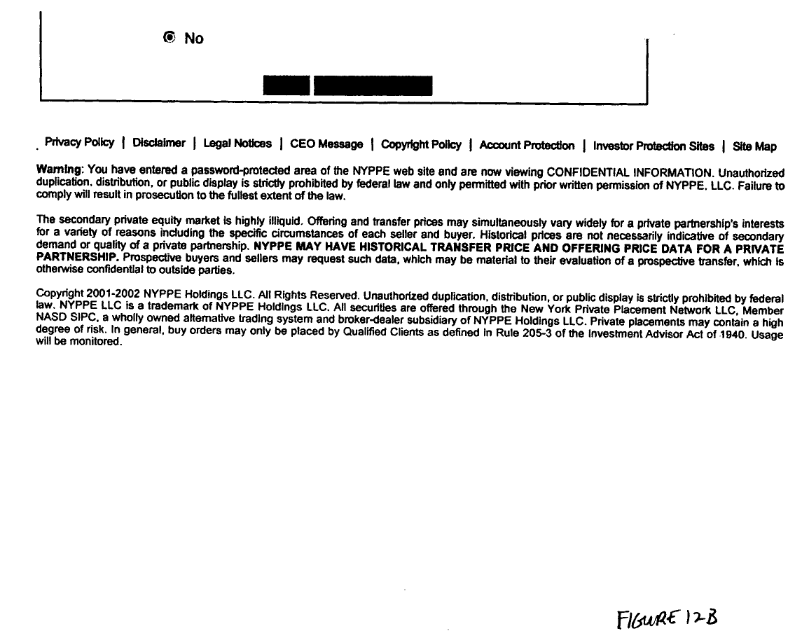

FIG. 1 is a block diagram.

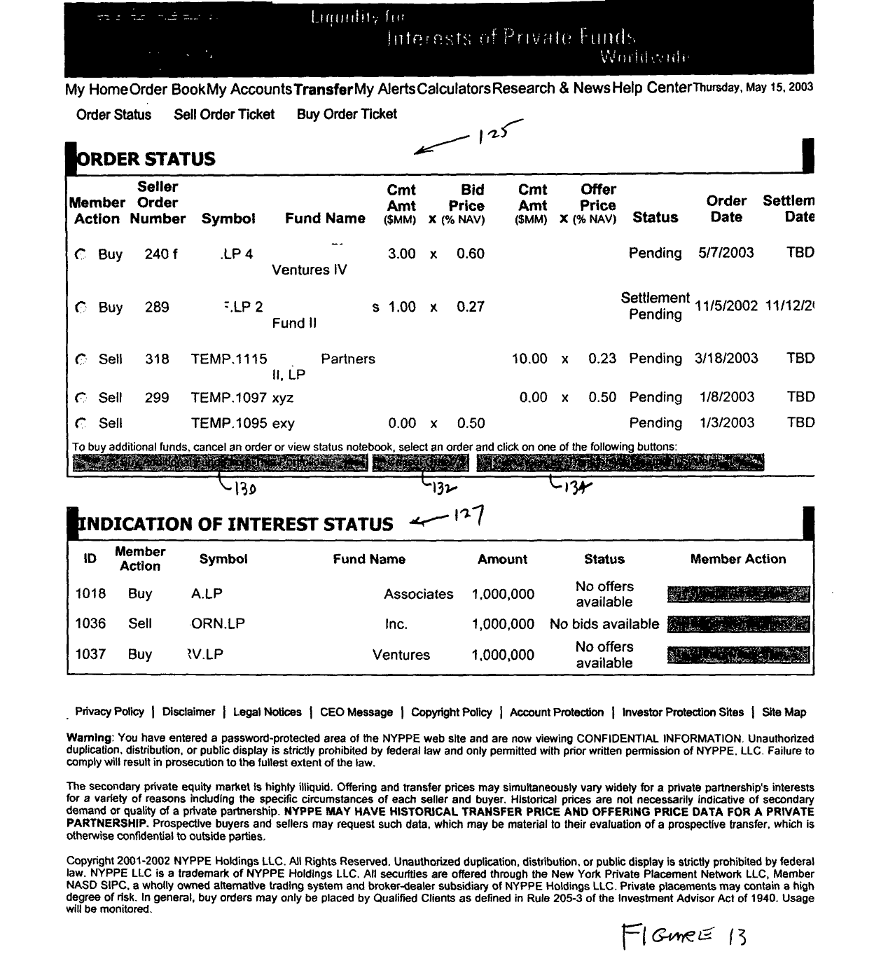

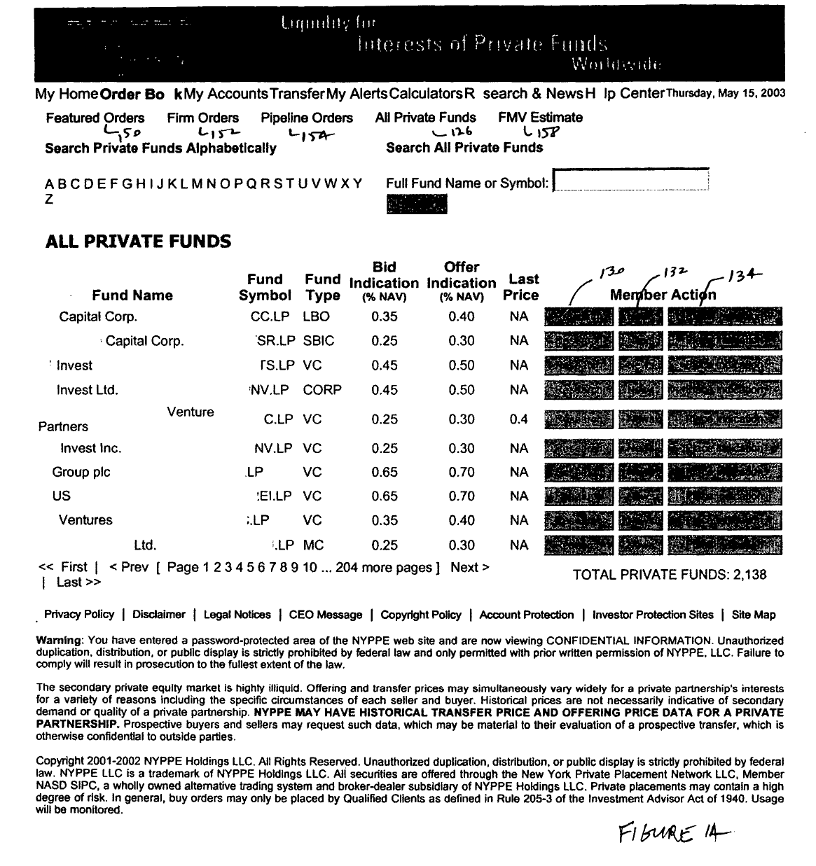

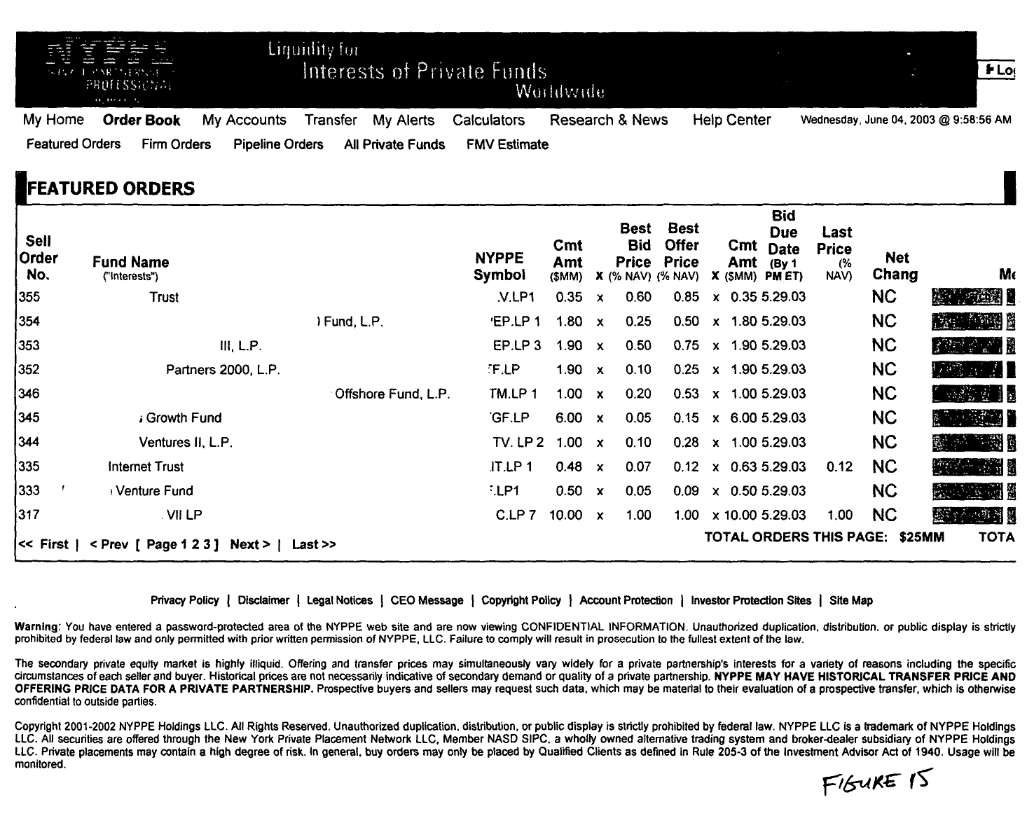

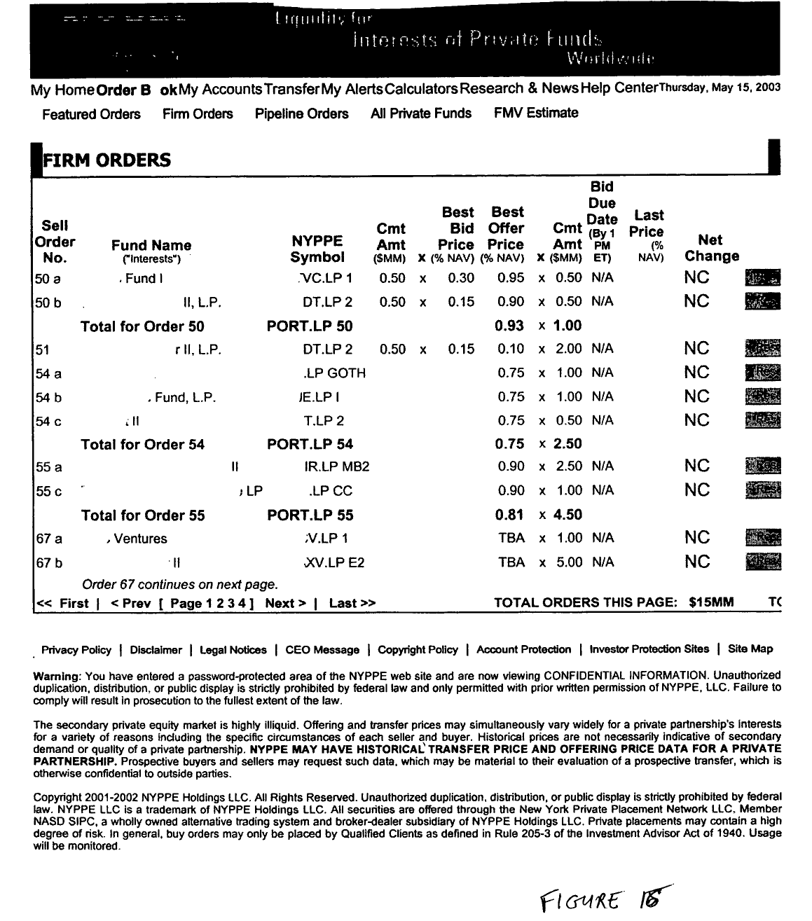

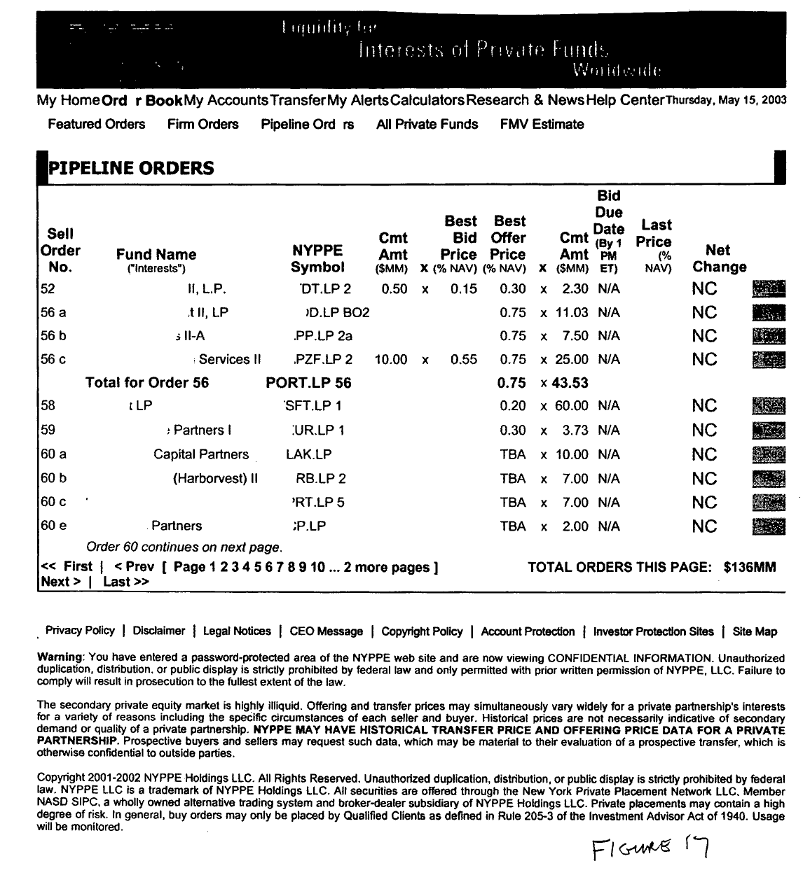

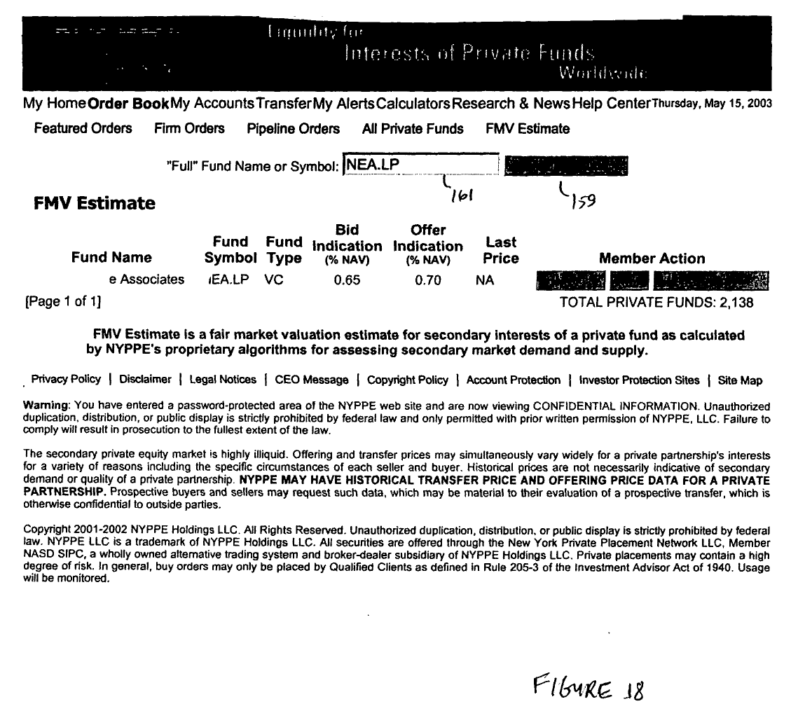

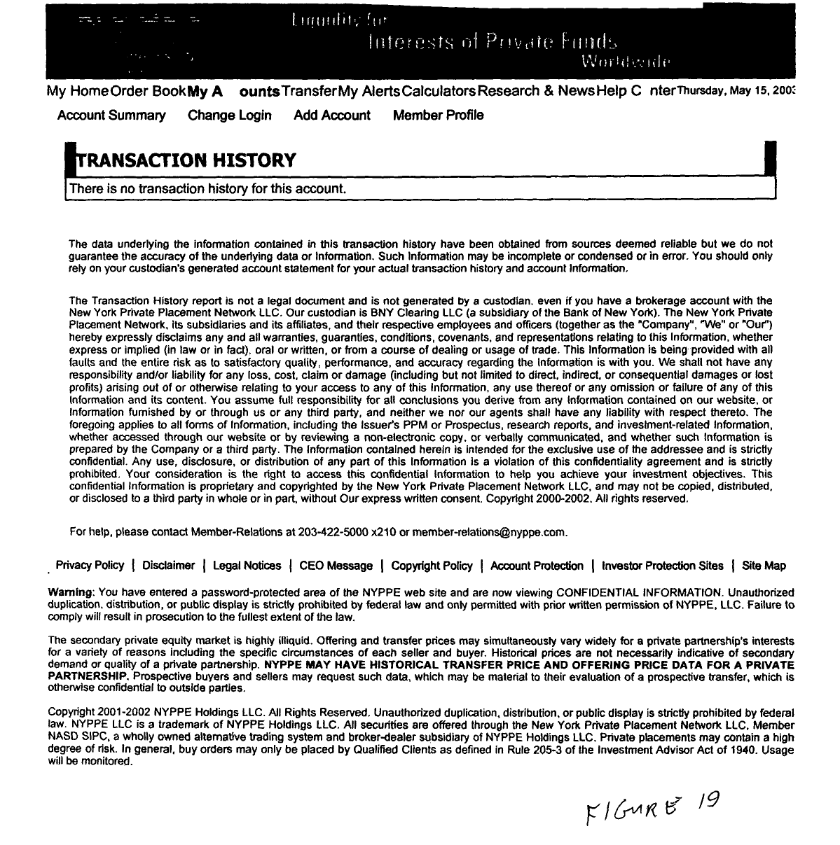

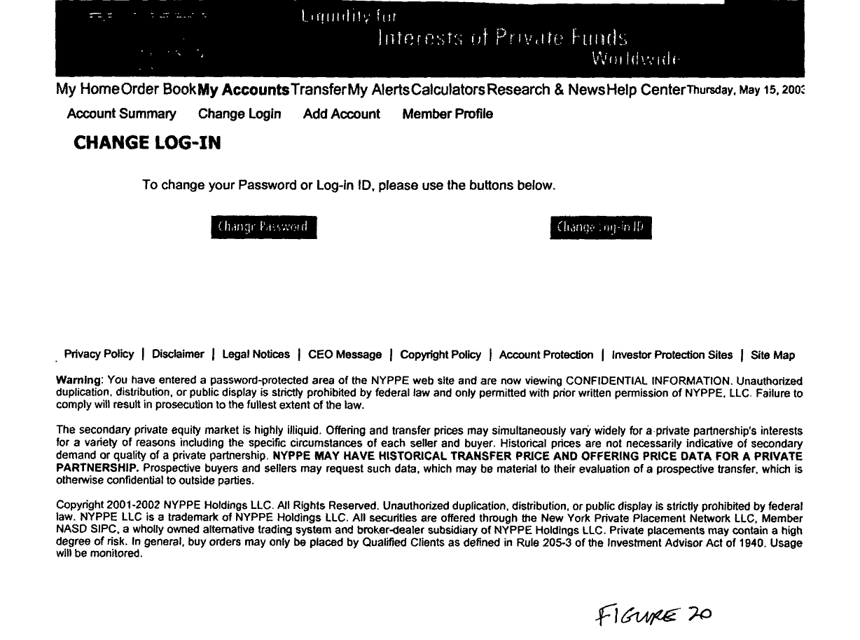

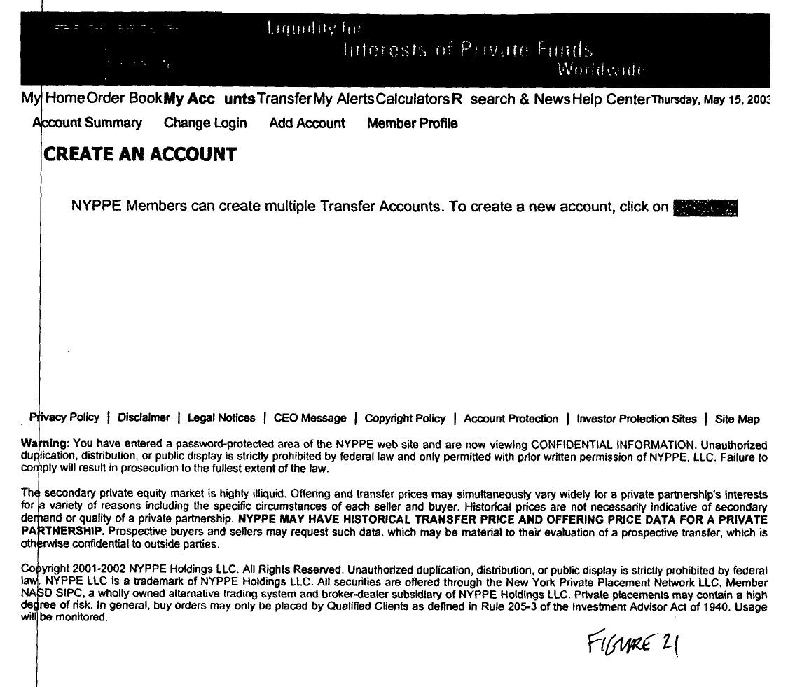

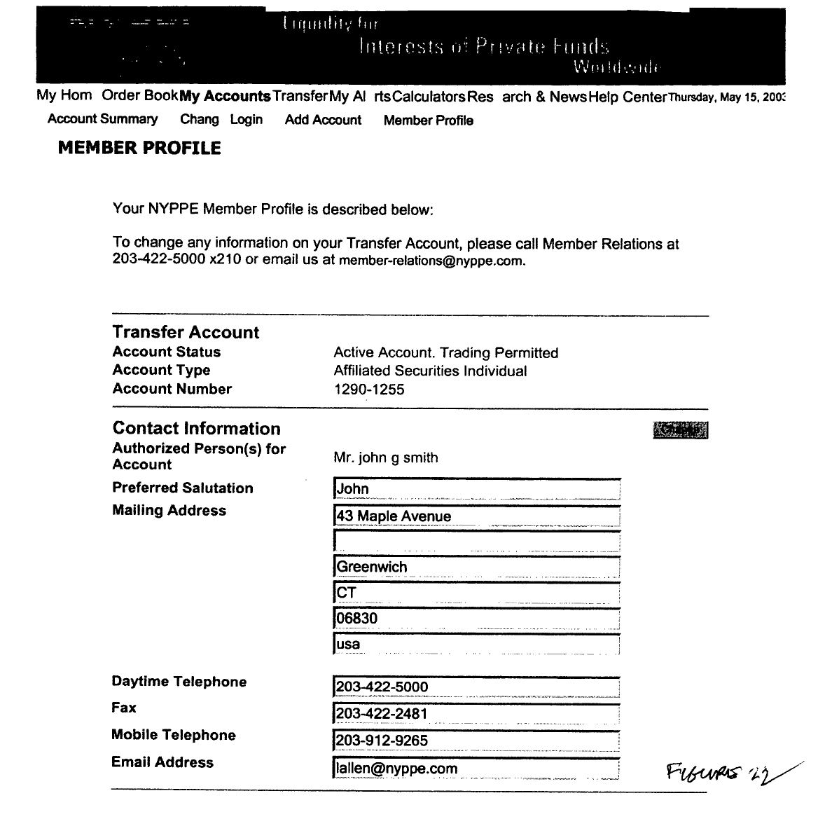

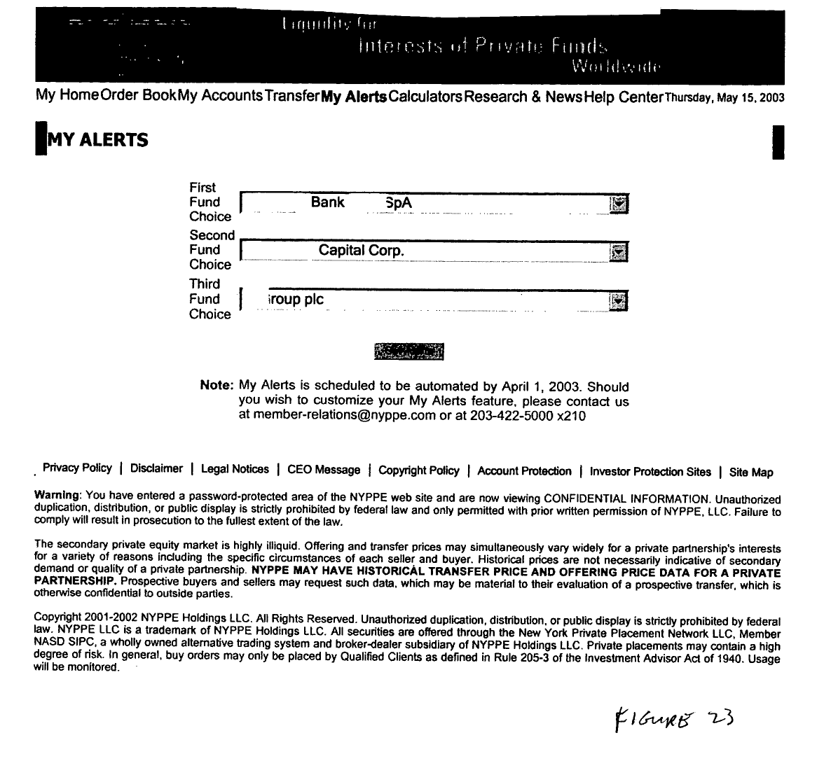

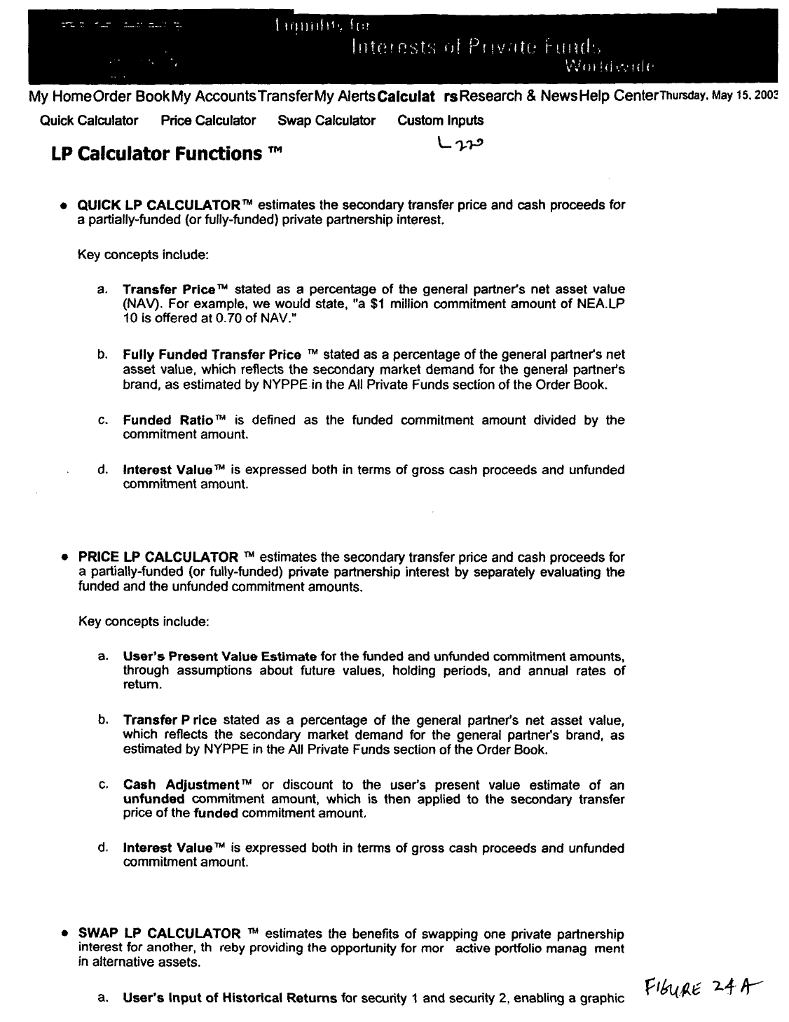

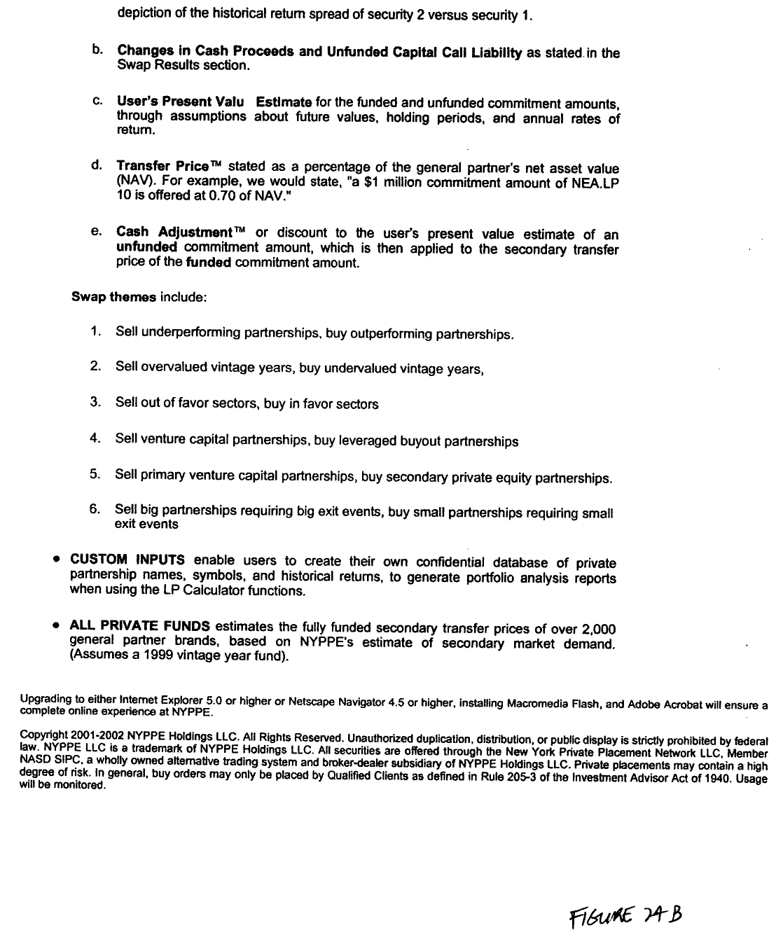

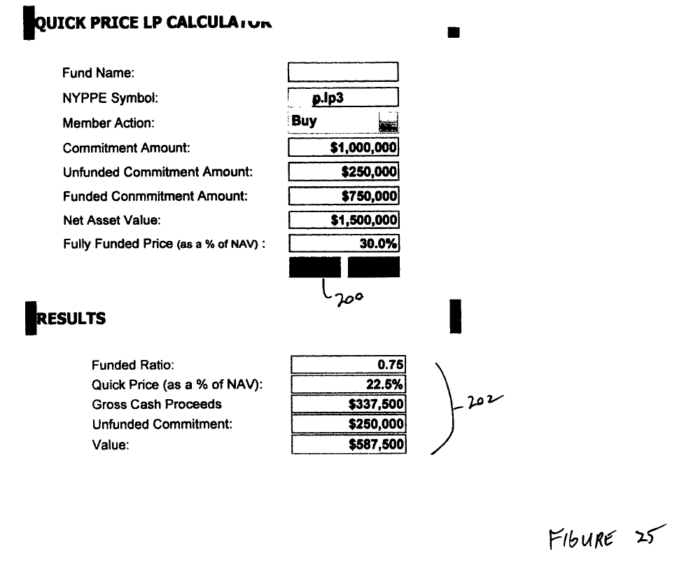

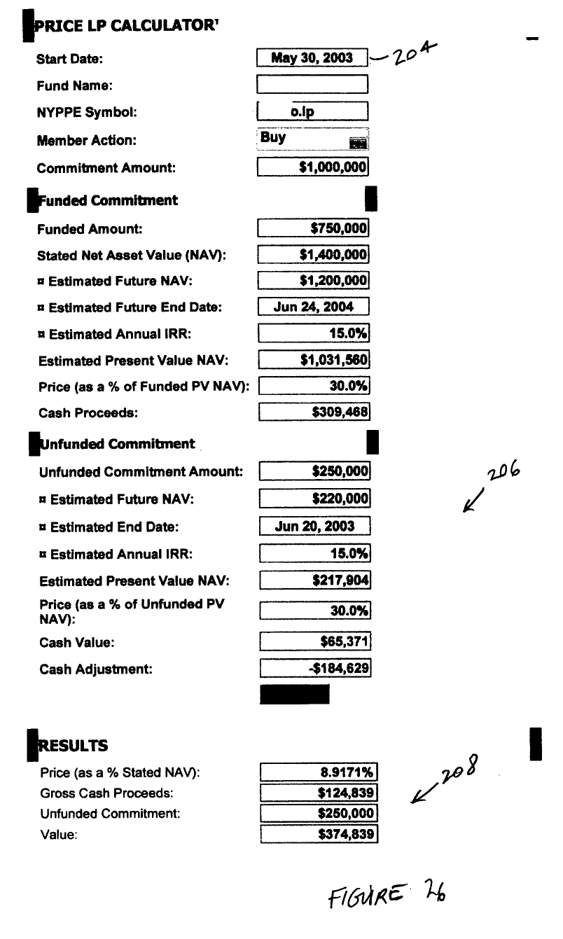

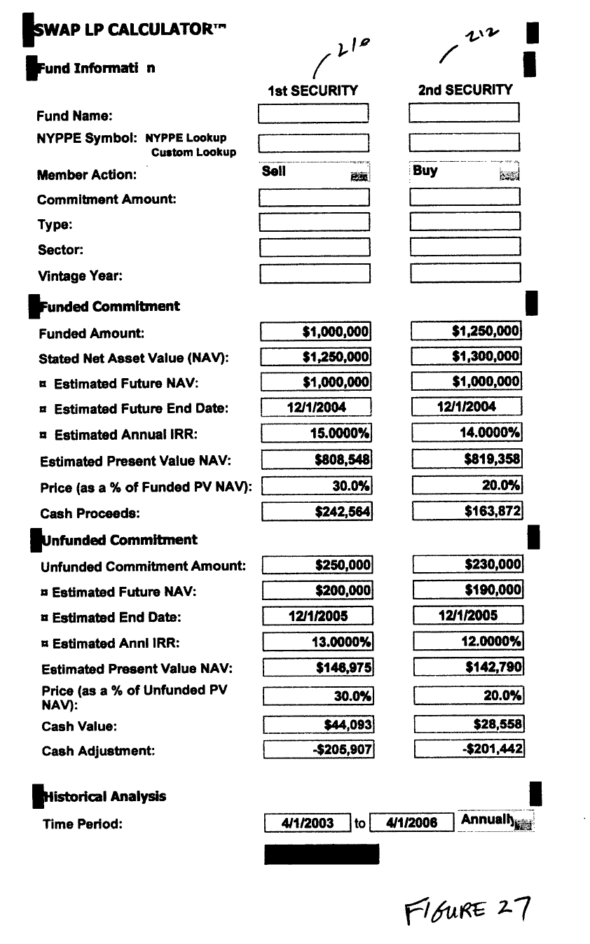

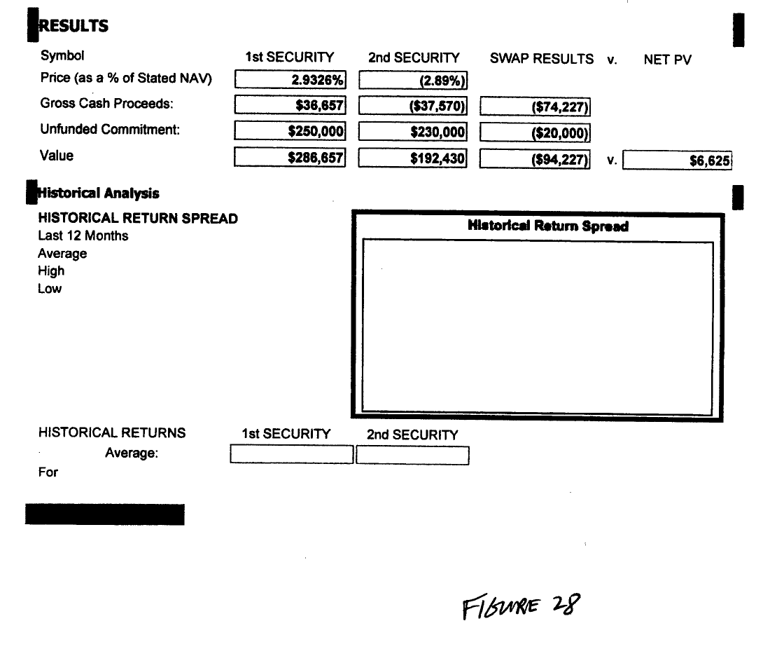

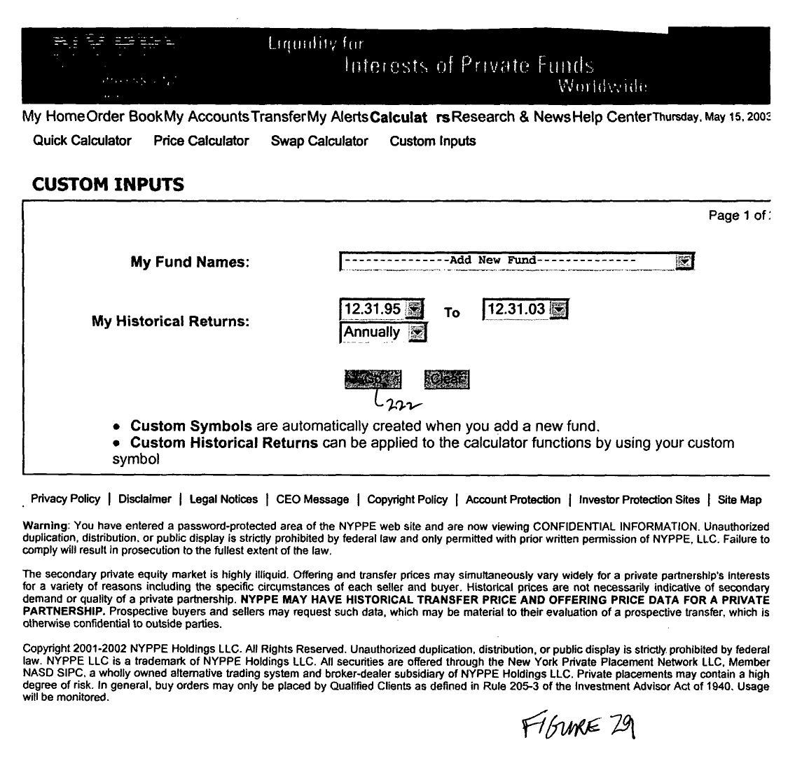

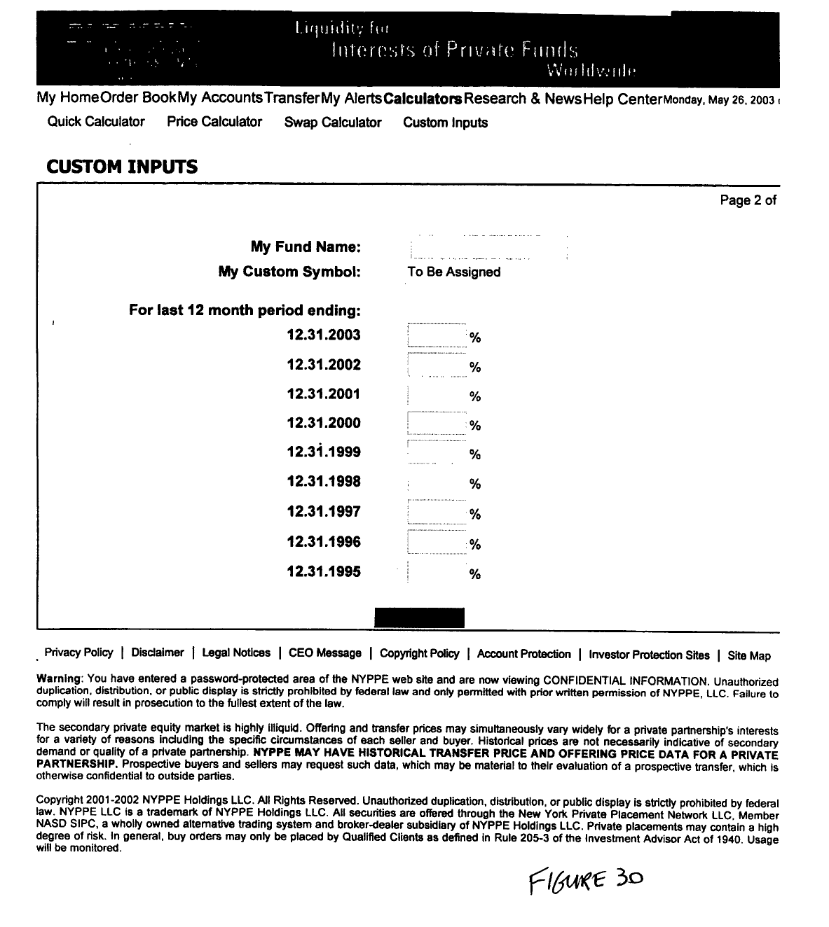

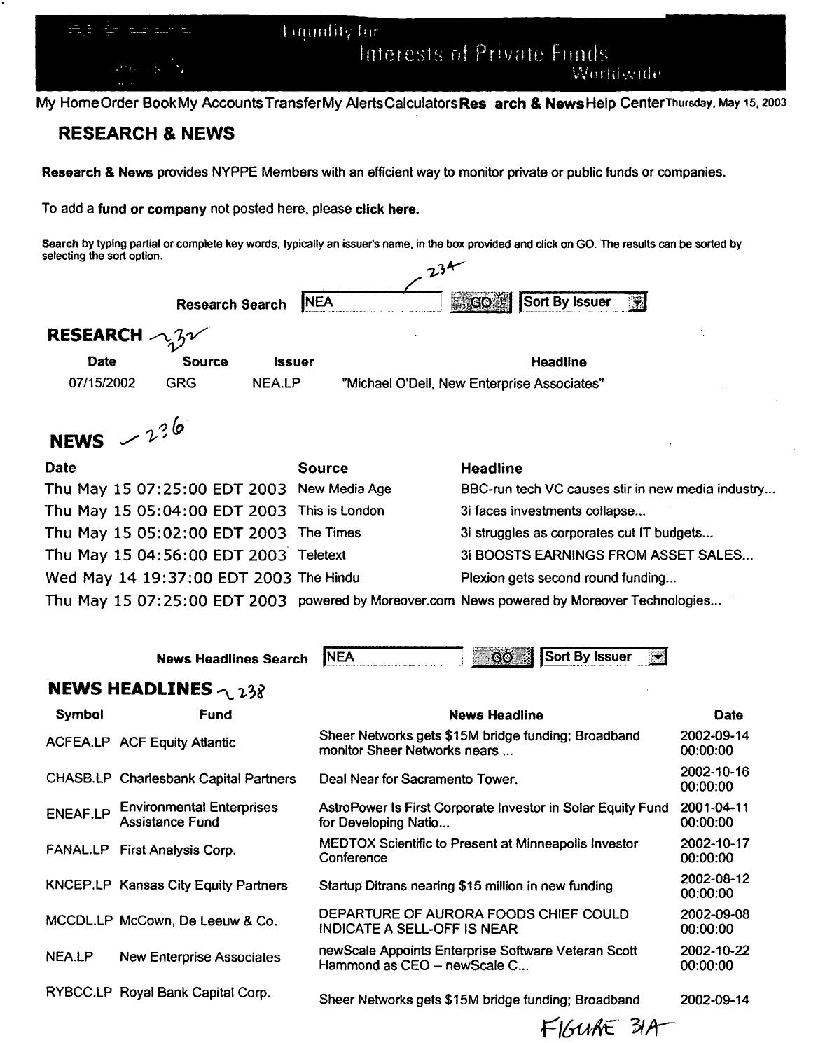

FIGS. 2 through 55 are screen shots of web pages (certain possibly confidential information has been blocked out).

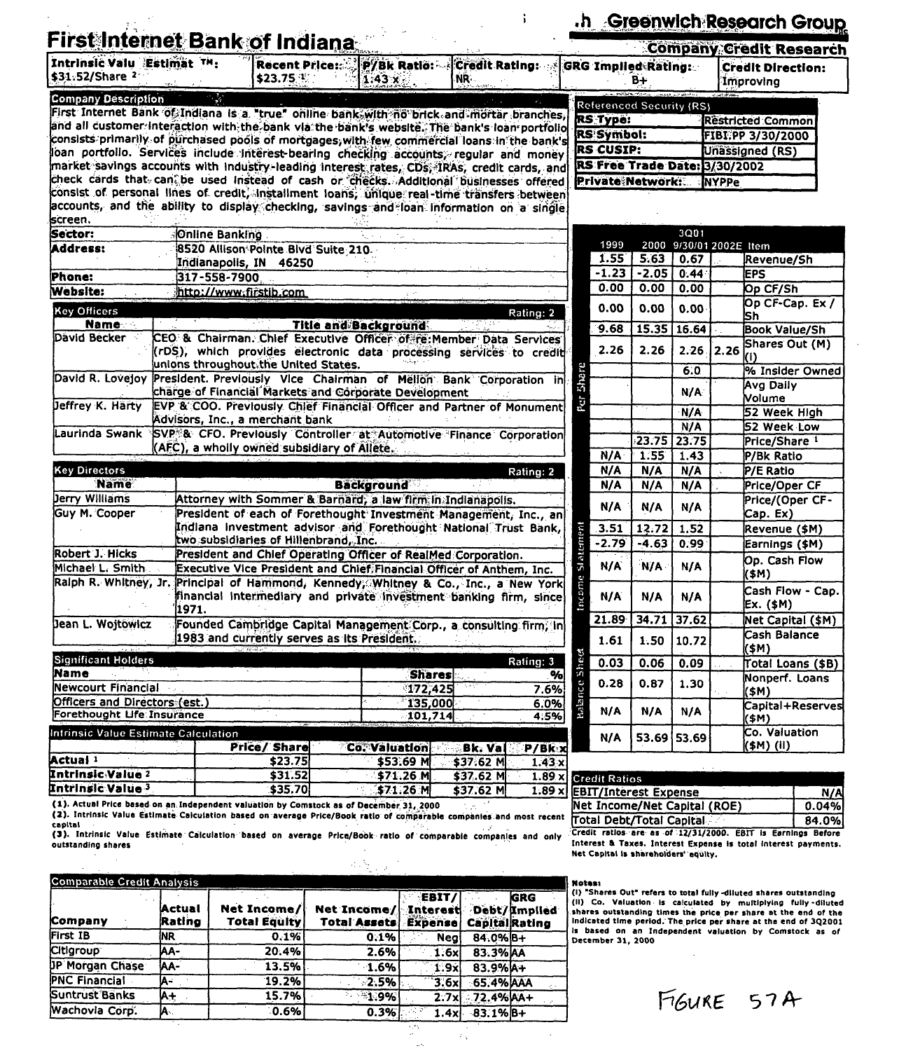

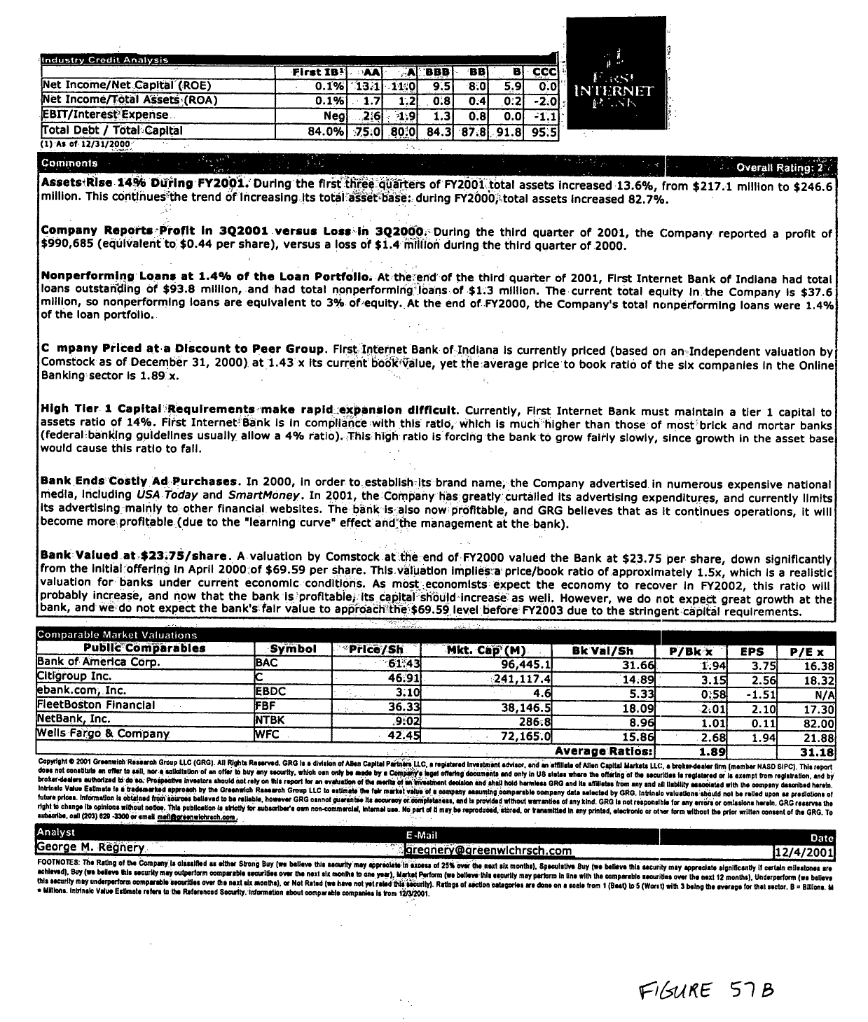

FIGS. 56A and 56B and 57A and 57B are reports.

As shown in FIG. 1, transfers of restricted interests can be made simpler, values of such interests in those transfers can be enhanced, and information can be disseminated more readily by a system 10 in which (a) issuers (or others) 12 can arrange for information 14 about particular restricted interests to be posted (and disseminated in a controlled way) on an online facility (e.g., a secure website) 16, (b) research and other information 17 derived from issuers and other sources 19 about the interests can be posted on the online facility and used to generate automated reports for distribution in a variety of ways, (c) valuations of the interests 21 can be posted using a particular format in a continuous ticker on the online facility, (d) buyers 18 and sellers 20 can view posted information and make offers 22, 24 for transfers of restricted interests on the online facility, (e) completion of transfers can be managed 26 and their progress reviewed on the online facility, (f) users can be registered 28 and their access to the online facility controlled, and (g) a feed of research, valuations, and other information can be provided to third parties for a fee 30. Other features and information related to restricted interests can also be provided on the online facility. For example, the users can have the values of restricted interests calculated 32, and a valuation algorithm 34 can be used to generate the valuations of restricted securities for a variety of purposes. A report generator 33 is capable of automatically generating research reports from available information. The report generator can be used to generate reports on restricted interests and also for listed securities.

The functions of the system are designed to comply with all regulatory rules and issuer policies (with respect to non-public information), including the Securities and Exchange Commission Act of 1933, the National Association of Securities Dealers, state securities laws, IRS regulations 1.7704, and others.

The system described here anticipates the development of and is designed to provide a global private capital or securities market for distributing information about restricted interests and for transferring restricted interests. The system includes all of the functionality needed to implement such a market including, among other things, standards for identifying issuers and restricted interests using symbols, methods for valuing such interests, methods for expressing such values, and methods for transferring such interests in compliance with the law.

The online facility can be associated with a database 40 (or other repository or storage) that contains the tables needed to store, maintain, and deliver information for performing the functions of the online facility. The information could include a list of restricted interests, lists of symbols for the restricted interests, valuations of the interests (current and historical), profiles and account information of registered users, transfer progress data, histories of transactions, research information and reports, and lists of compliance requirements for compliance with government regulations and policies of issuers. The information could also include data required for generating real-time web pages to be served on the site.

The restricted interests handled by the system may include interests in equity and debt funds and securities representing equity and debt of a private company.

Users of the online facility can include buyers, sellers, investors who are not buying or selling, financial advisers, financial analysts, portfolio managers, financial institutions, lenders, and issuers, among others. In a typical implementation, the online facility could be a website controlled by a market facilitator 42 (such as New York Private Placement Exchange of Greenwich, Conn.) and made available publicly. Users could access the site through the browsers and a network using workstations or portable devices, wired connections or wireless links. The users could include employees of law firms and dealers who could subscribe to the service provided by the website.

Some information and functions would be made available to any public user. Other information and functions would be available only to users who had registered and met certain standards (such as standards imposed by governmental regulators or issuers). Trades could be restricted to users who had established accounts with the market facilitator. Available information and functions would also vary according to the user seeking access and possibly other factors. Some users may be referred to the site by entities who use the site and the facilitator as a way to outsource the transfer of restricted interests as a service to their customers.

As shown in FIG. 2, when a user first enters the website, he is given a chance to login as a shareholder 50 or as a staff member of the market facilitator 52. Invoking those links leads the user to a login screen for entering a name and a password. Other users (including unregistered members of the public) can enter the website with respect to either restricted interests in the form of private partnerships 54 or restricted interests in the form of stock of private companies 56. The two forms of interest are handled separately because, although there are many similarities in the kinds of information and the kinds of functions that are offered with respect to each of them, there are also differences. Other types of restricted interests could be handled separately also, and other combinations of interests could be set up.

In addition, the system can handle restricted interests in the form of portfolios of interests. A symbol may be assigned to the entire portfolio, for example, PORT.LP 53.

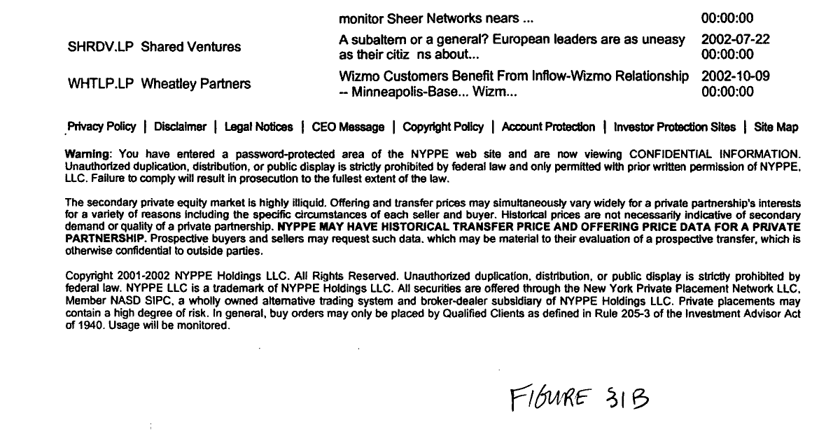

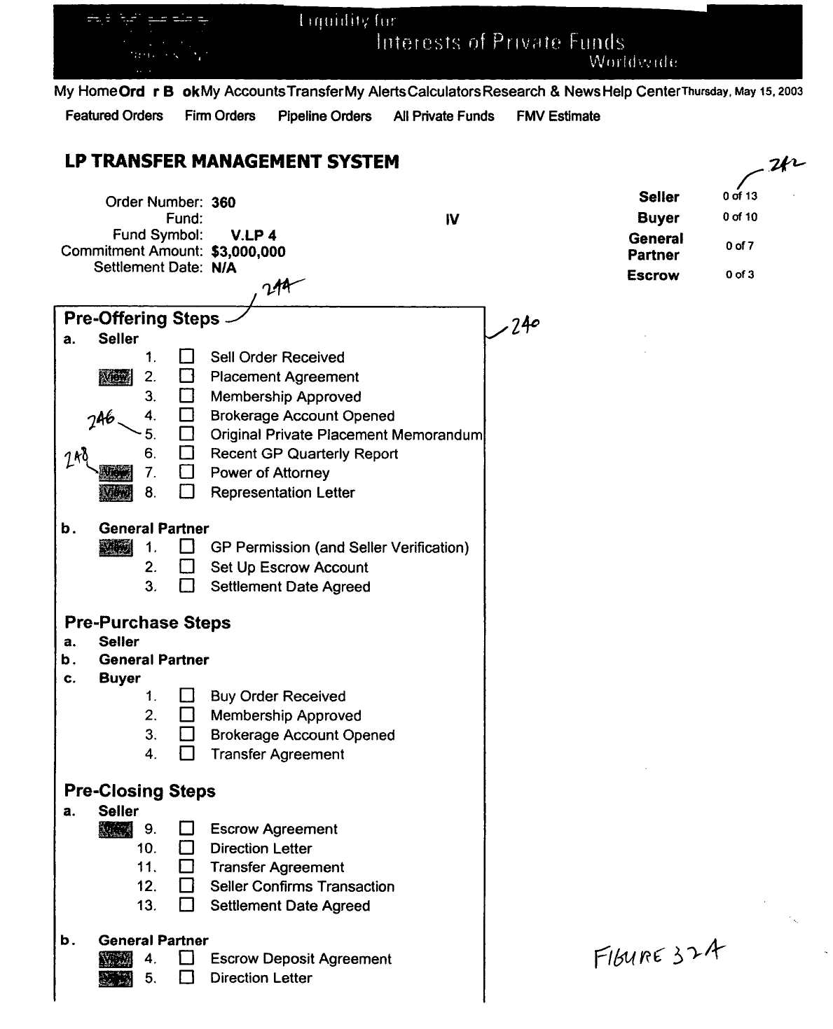

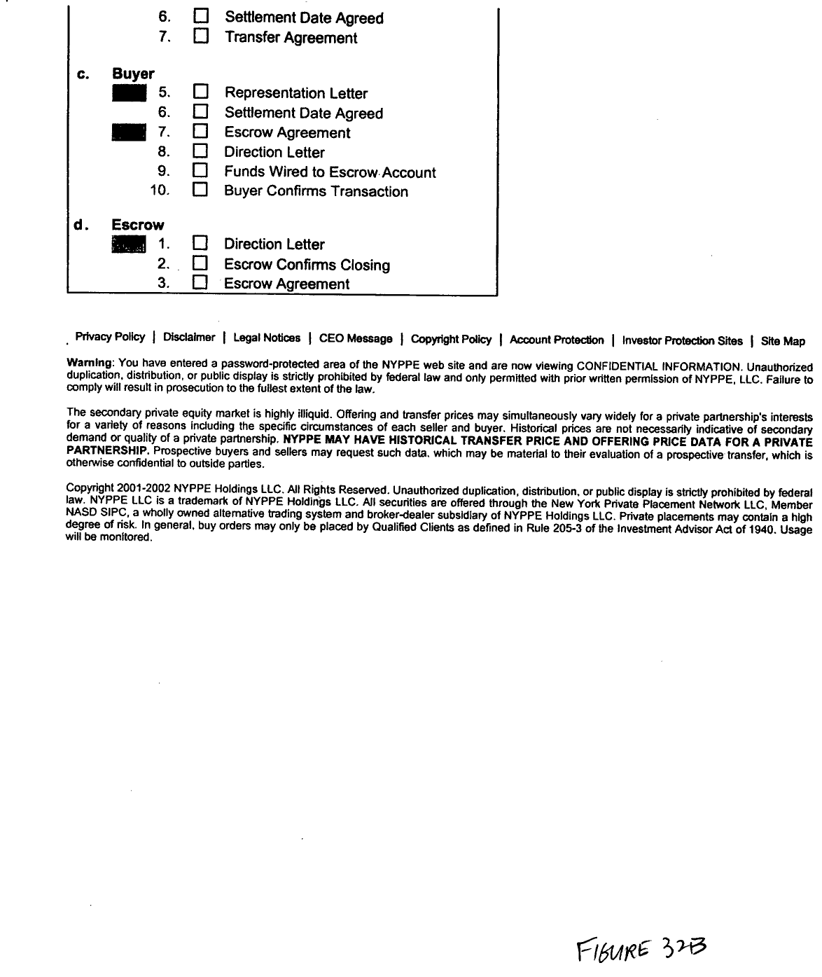

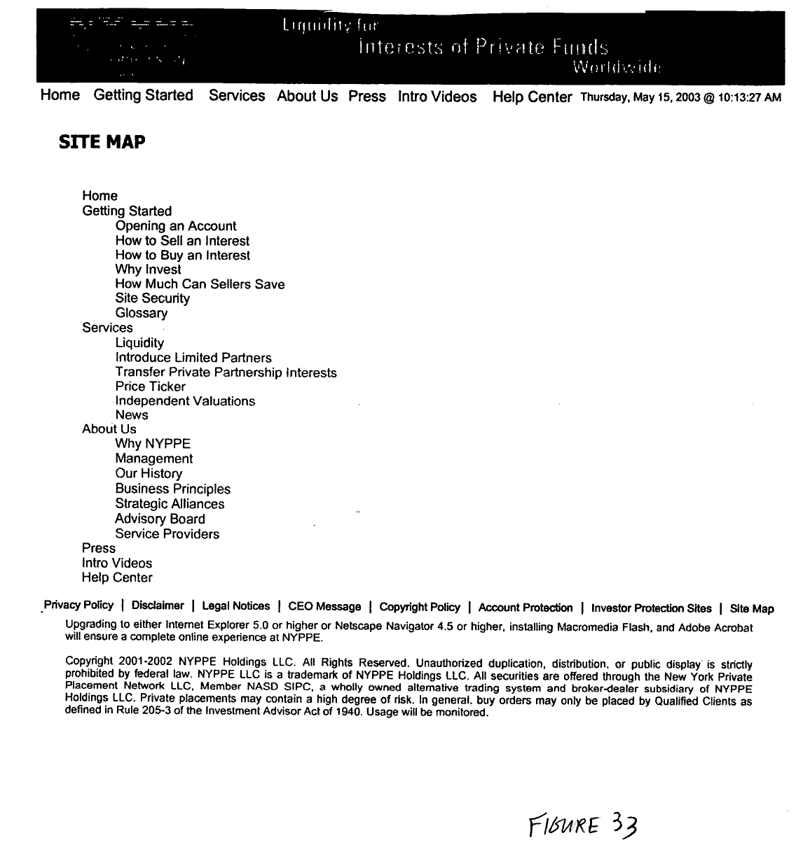

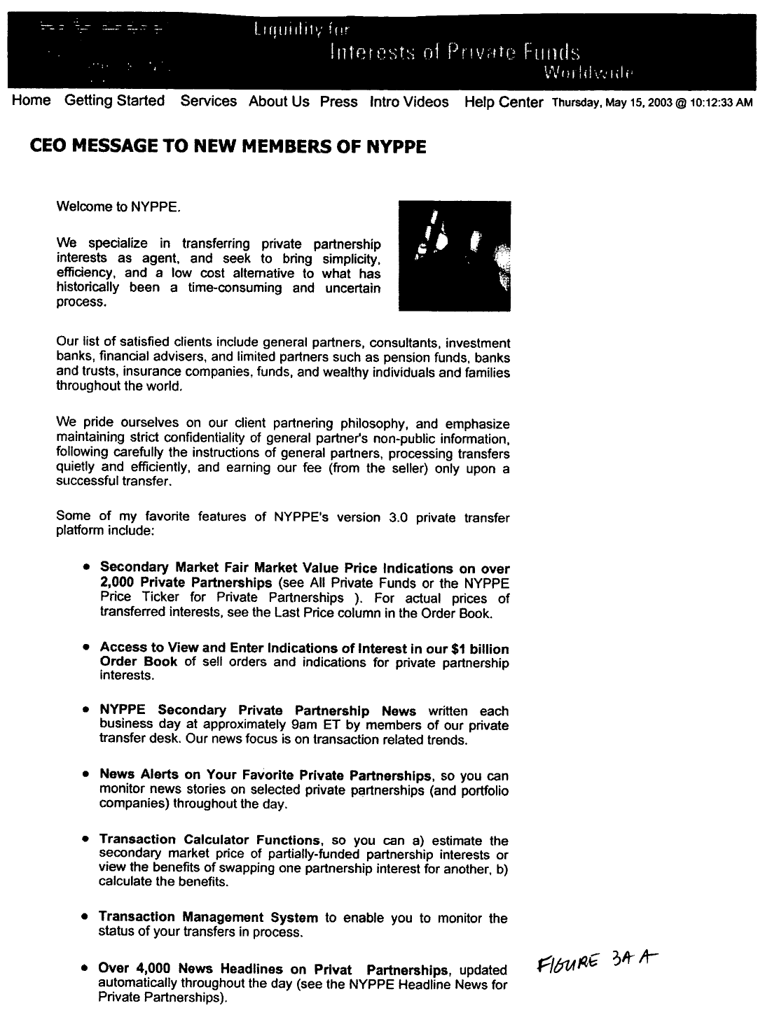

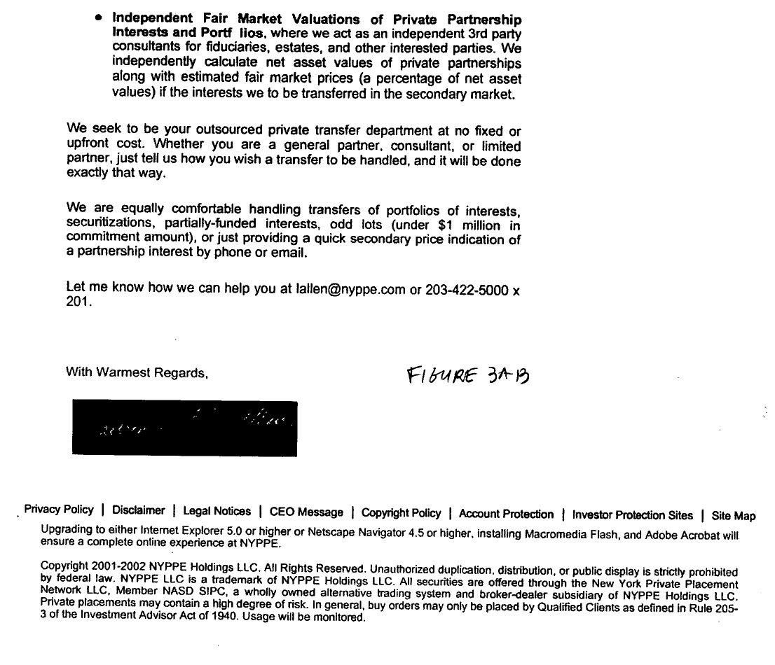

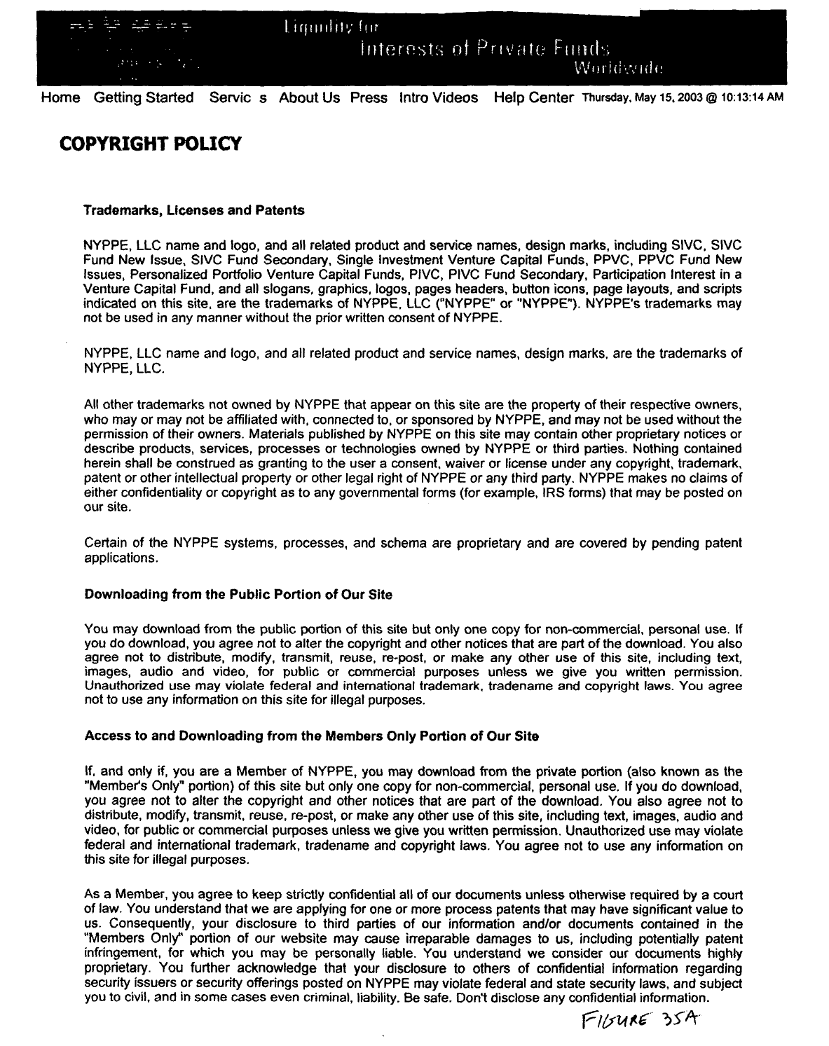

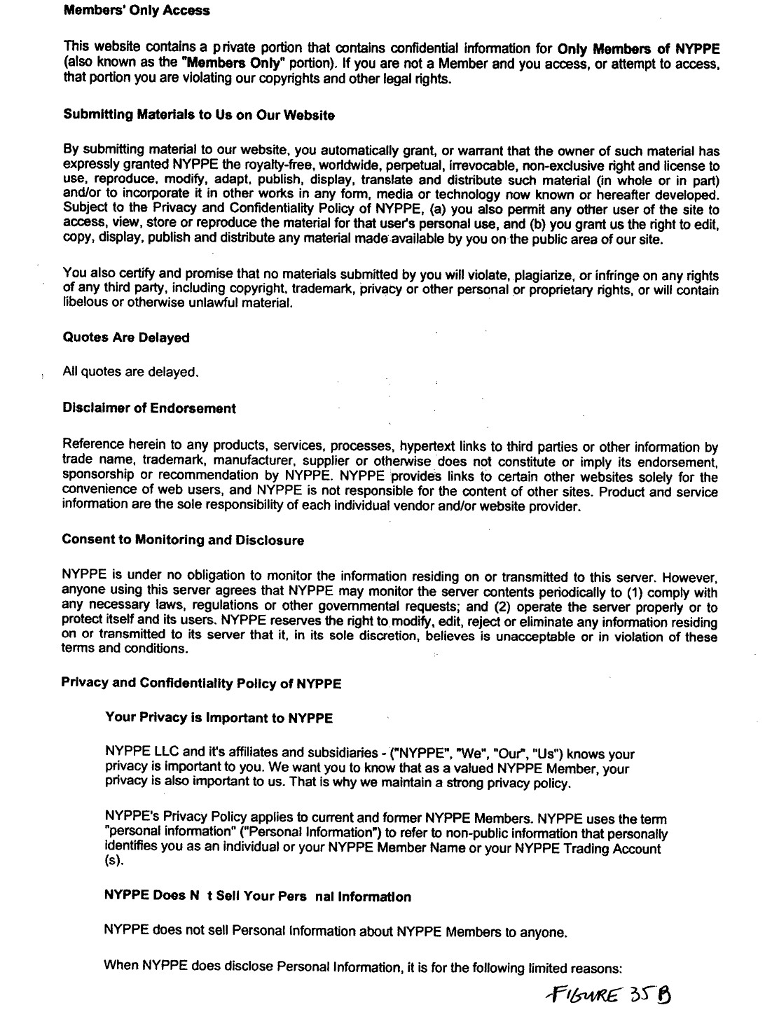

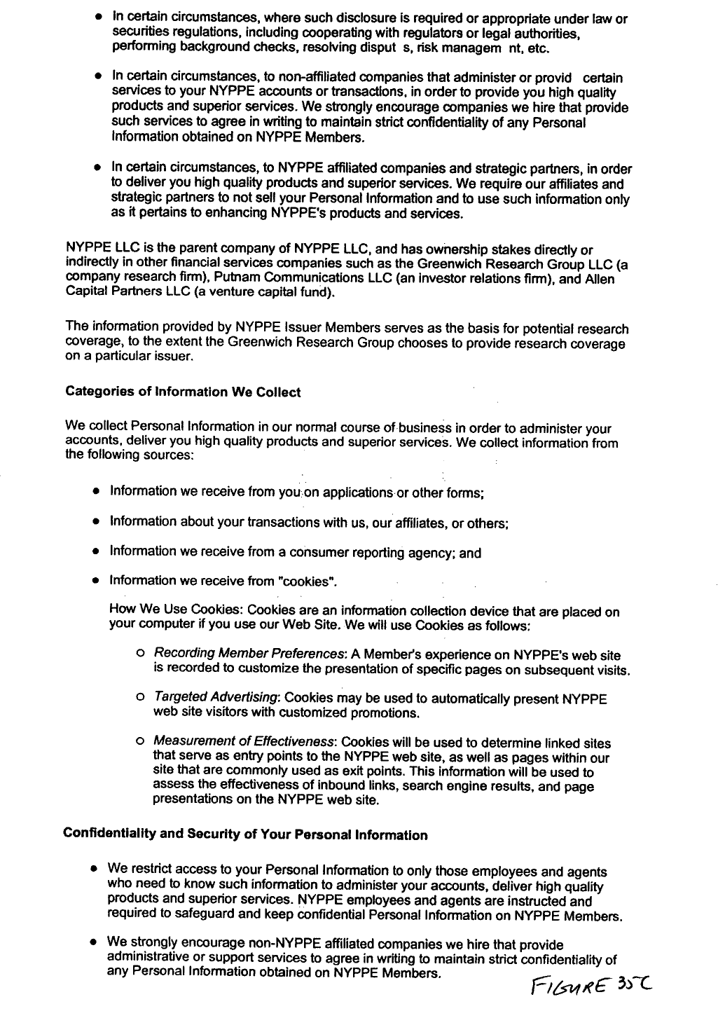

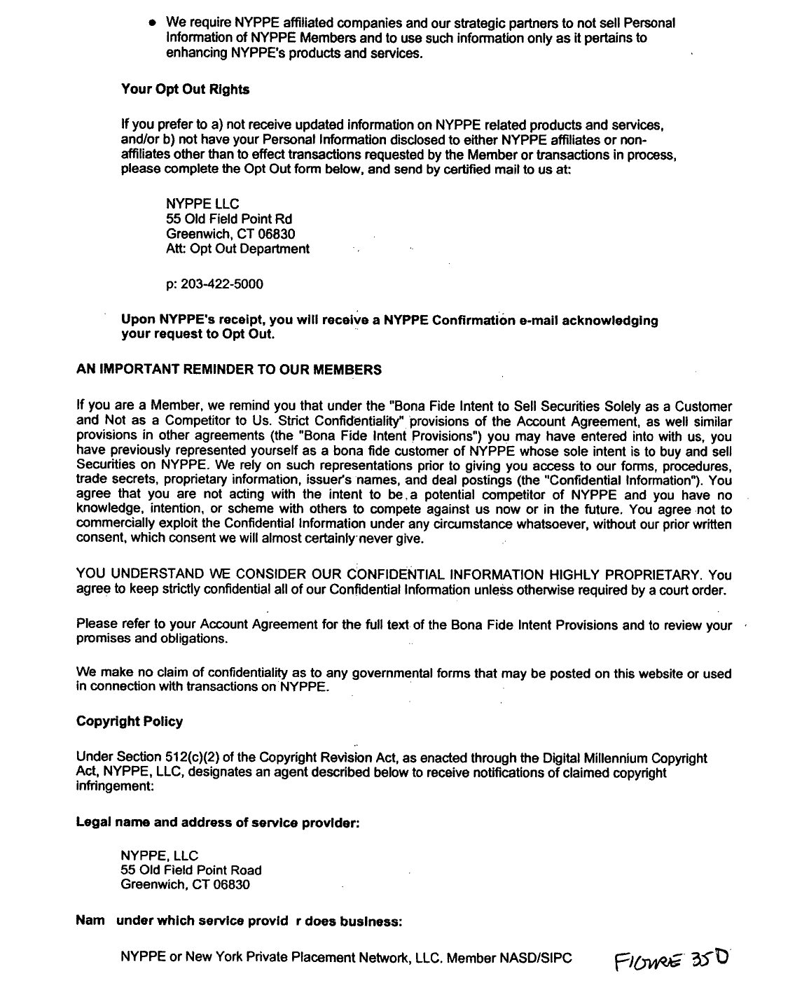

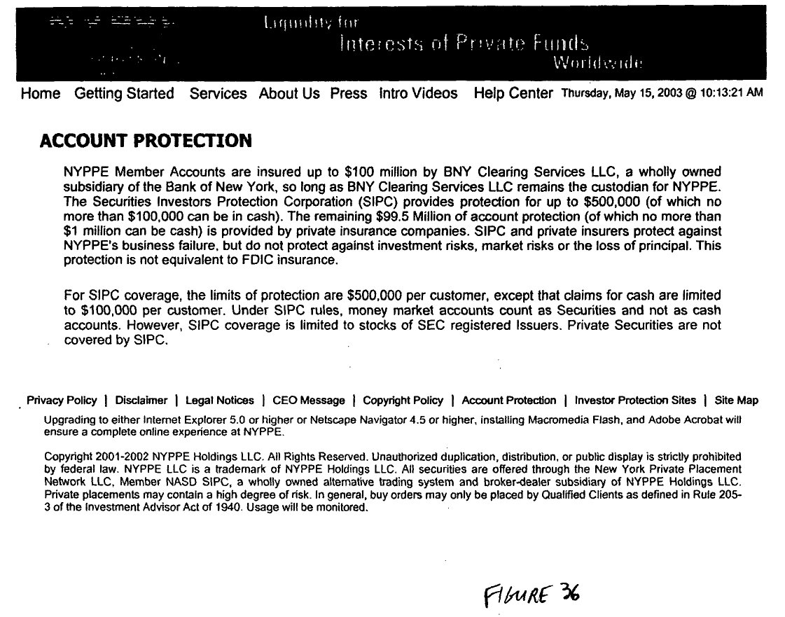

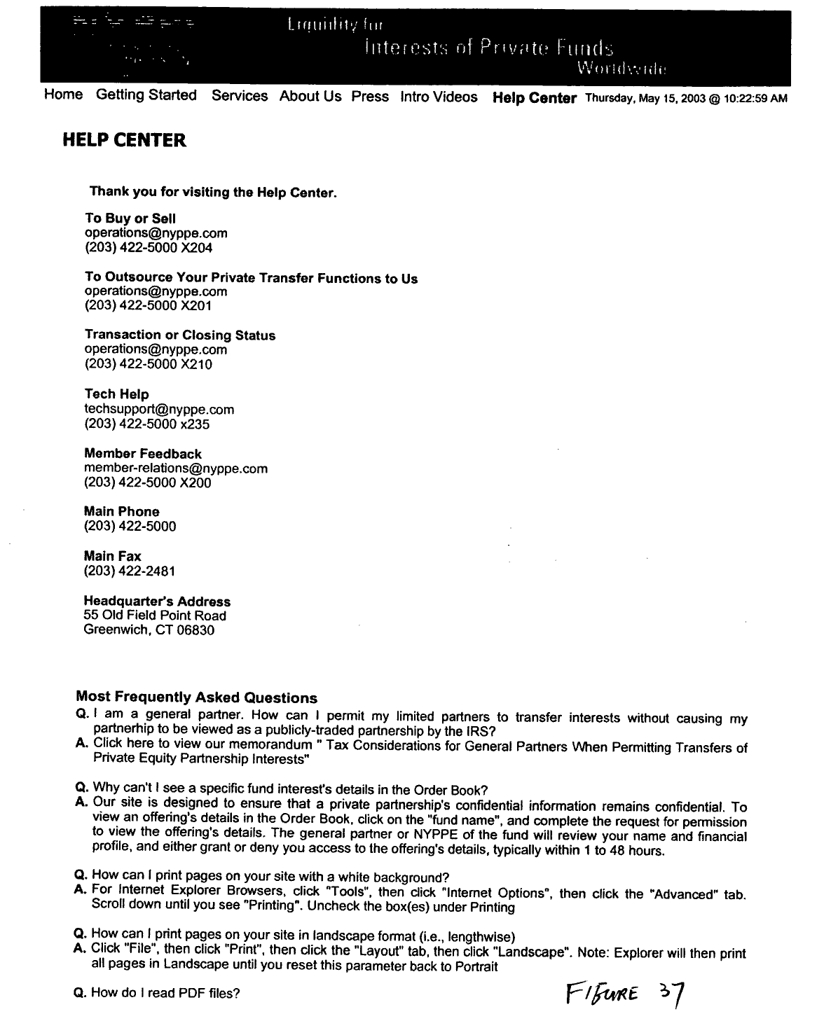

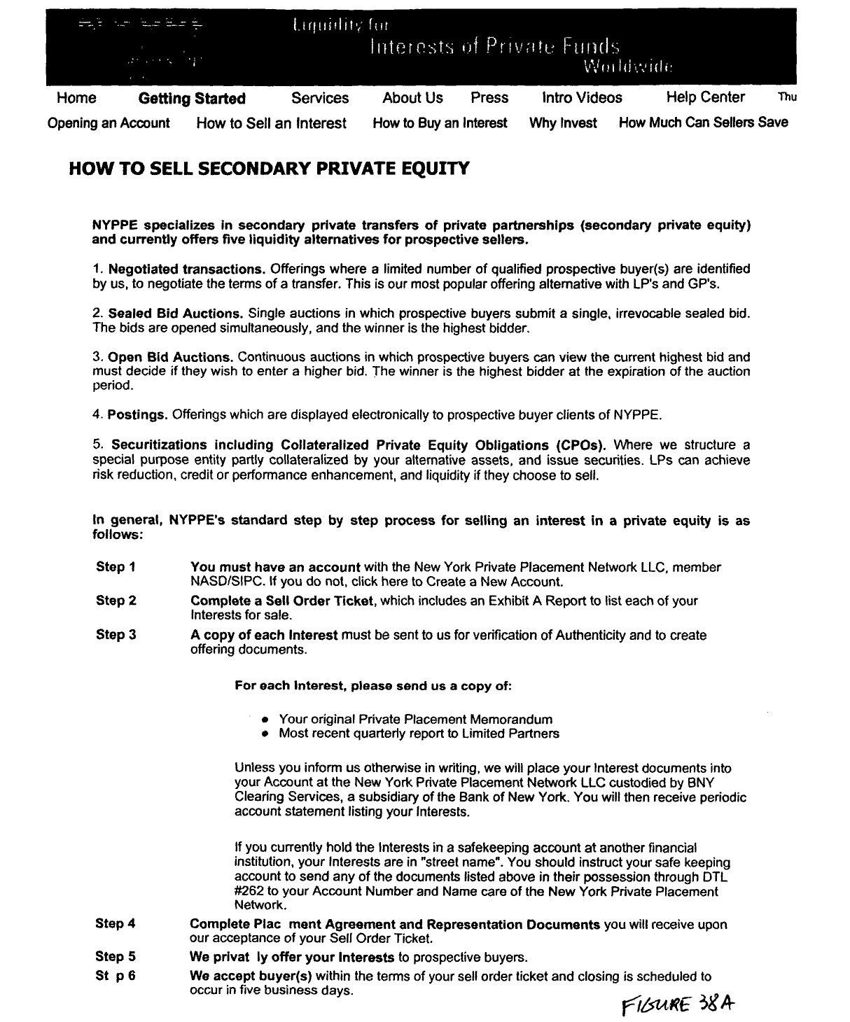

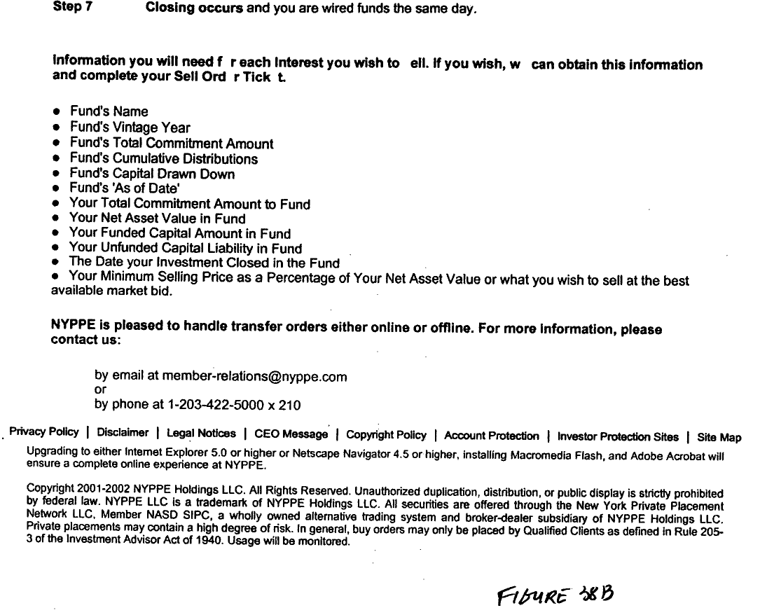

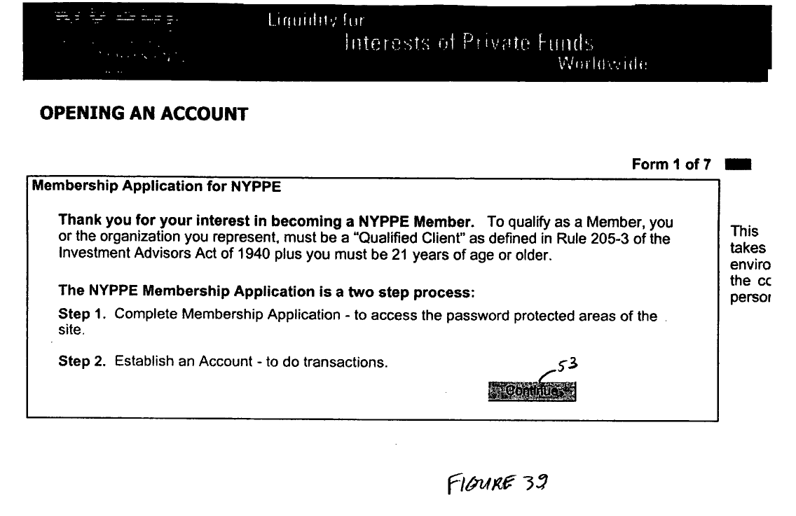

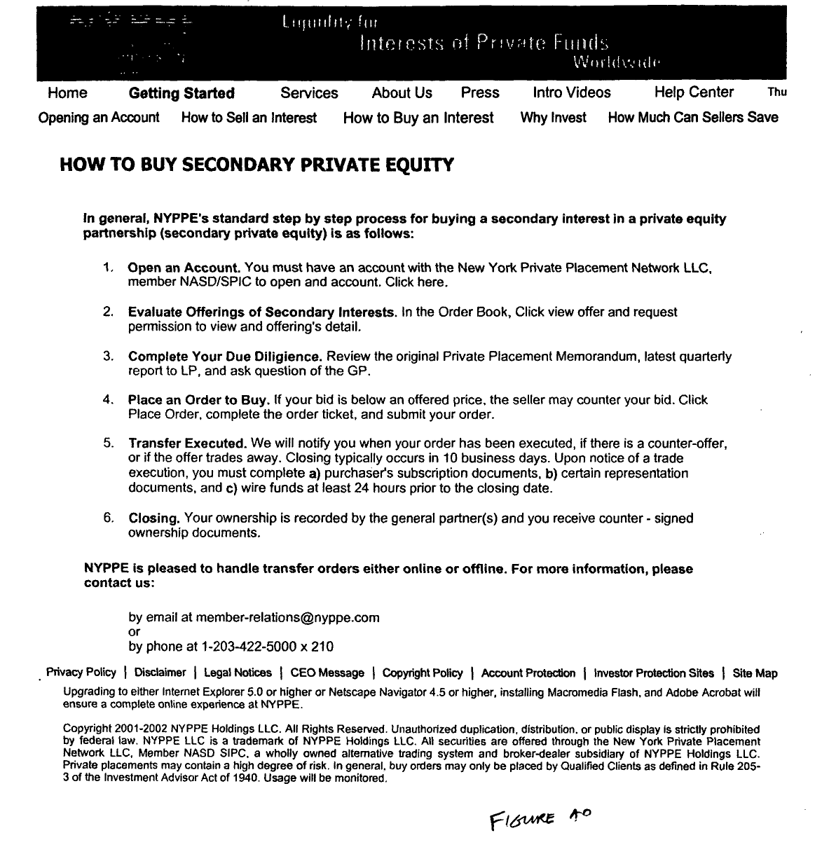

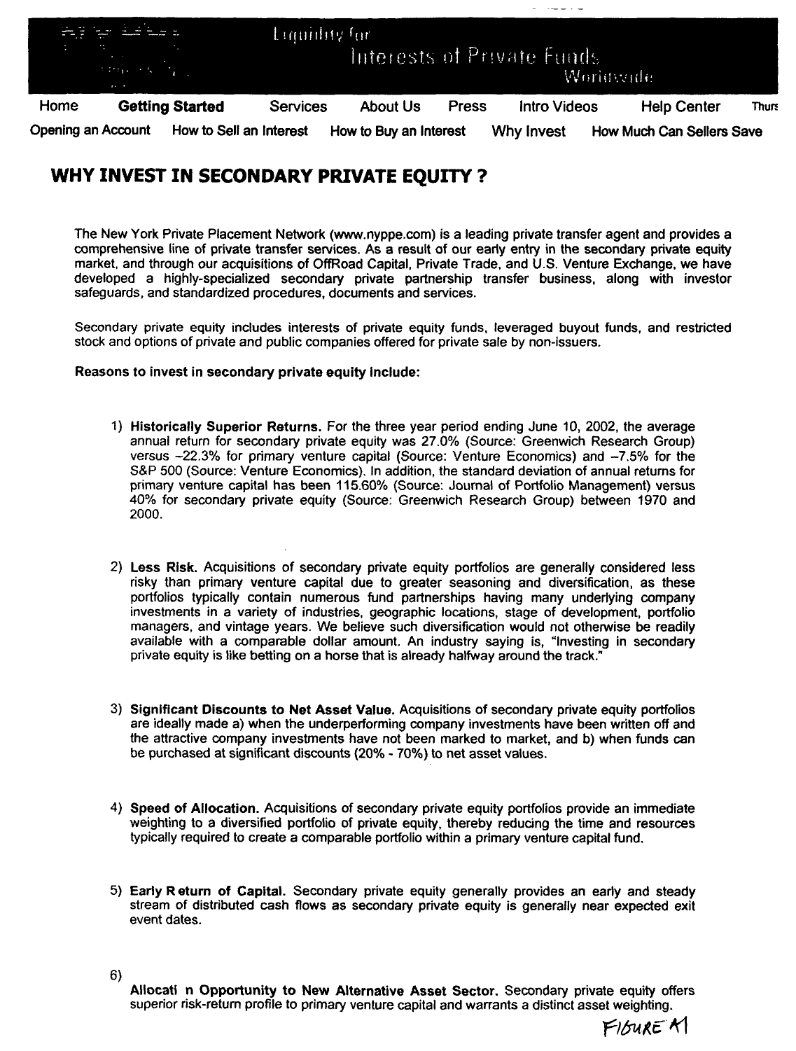

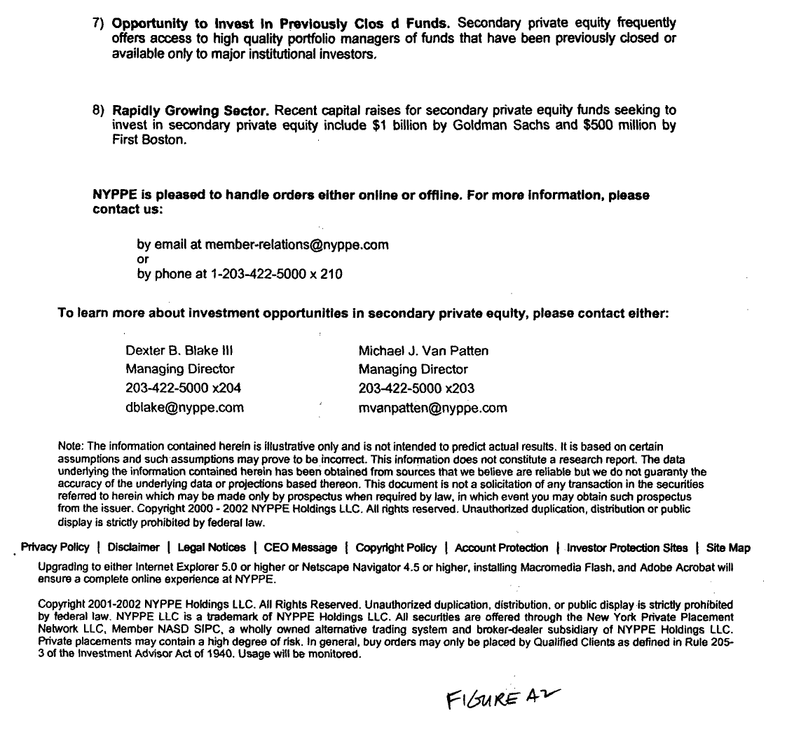

Invoking the enter button 54 for partnerships leads to the page shown in FIG. 3. The login button 58 then leads to a page shown in FIG. 4, in which a user who has previously registered can log into the site by entering his ID and password and selecting a start page. When he clicks the log-in button 60, he is shown his selected start page, for example, the page shown in FIGS. 5A and 5B.

For a user to be able to invoke the enter button 54 and therefore to access non-public portions of the website, he must register to become a member of the site and open an account. To register and open an account, he clicks the apply button 59 which leads to a display shown in FIG. 39. Clicking the continue button 53 on FIG. 39 leads to the forms shown in FIGS. 49 and 50A and 50B, which include fields in which a user enters information to establish himself as a qualified investor, register, and open an account. After the investor is registered, the market facilitator 42 manually reviews the information and then can approve the member and open the account. A fee can be charged for membership.

The main page shown in FIGS. 5A and 5B provides general market information 60, a navigation bar of quick links 62, and two sections of current information.

The section called My Alerts 64 lists particular limited partnership interests 66 and shows the valuations 68 for the most recent transaction, the change 70 represented by each transaction, and current research information 72 about that interest.

The section called Featured Orders 74 features particular offers of restricted interests identified by the sell order number 76, the name of the issuer and one of the interests of which it is the issuer 78 (in the figures, portions of the names and symbols of interests have been redacted for confidentiality reasons), the symbol 80, and the due date for bids 82. For each of the listed interests, buttons 84, 86, 88 enable three different member actions: obtain news and research information on the interest, view pending offers for the interest, and place order for the interest.

Until the user has been approved by the issuer of the interest to have access to the information that is available through buttons 84, 86, 88, the names of those buttons are shown in gray and cannot be invoked. If the user has been approved, the names are shown in black and the user can invoke them. A small green indicator 89 to the left of the three buttons for a given interest is displayed (and shown hypothetically in FIG. 5B) if the investor has been approved.

Approval to invoke the buttons for a particular interest must be given by or under the authority of the issuer of the interest. In the case of a limited partnership, for example, the general partner may have set rules and policies under which it will approve an investor to be able to invoke the buttons. The rules and policies could relate to the characteristics of the investor and to other factors. The general partner can provide the rules and policies to the market facilitator 42, which then applies them in order to give the investor permission. Or the general partner may give the market facilitator a list of information to be obtained from the investor and then passed to the general partner, who then makes the decision and communicates it back to the website. Or the market facilitator can obtain a list of standard information from the investor and pass it along to the general partner for approval. Typically, the information passed to the general partner could simply be the information obtained from the user at the time he applied for an account.

The site uses the concept of permission under which the user must express an indication of interest in order to see non-public information as a way to protect an the information of an issuer of a restricted interest (such as a general partner).

The issuer of the restricted interest, in advance, instructs the market facilitator how to approve or not approve each indication of interest and under what circumstances non-public information can be released. For example, the issuer could indicate the characteristics of the buyers who may have permission, and might exclude, for example, municipalities.

Also, a transfer manager is designated for each transfer party—the seller, the buyer, and the issuer—as the person who can use a transfer password, to see what documents are required to be signed by each party and if each party has signed each document as indicated by a check next to the document name. Different names of documents and numbers of documents are assigned for each transfer.

The system also provides for the ability to designate a custom symbol for a restricted interest that enables a party to enter confidential data about a fund, for example, annual returns, such that only that party can access that symbol in the future and see his data. This enables the use of the calculators that generate return spread information and help the issuer or portfolio managers understand performance of their funds relative to others.

To get permission to invoke the buttons of FIG. 5B, the user can click on the name of the issuer 78, which leads to a window in which the user provides information needed to establish him as a qualified investor. FIG. 10 is shown to the user when he invokes the name of the issuer 78. A dialog box 79 enables the user to provide a message to the issuer in connection with the request for permission.

After the user clicks the “get permission” button 81 on FIG. 10, he is shown the confirmation screen of FIG. 11.

When the user invokes the view offer button 86 of FIG. 5A, the fund summary page of FIGS. 6A and 6B is displayed. At the top of the page are five buttons 87 that enable navigation within the portion of the site that provides information about the particular interest that has been selected by the user. Each of the pages of that portion of the site includes the same five navigation buttons. (Each of those pages also includes two buttons 84 and 88 that have the same functions as the same numbered buttons on FIG. 5A.) The fund summary button 93 always leads to the page of FIGS. 6A and 6B.

The offering summary button 95 always leads to the page shown in FIG. 7. That page contains the details of the offered interest. In the case of a limited partnership, the details include the commitment amount 90 of the offered interest, the amount of the commitment that has not yet been drawn down or funded 92 and the amount of the commitment that has been funded 94. The net asset value 96 represents the proportion of the total commitment amount of the underlying portfolio that is associated with the interest that is being offered. For example, a commitment of $1 million may comprise a funded portion of $800,000 and an unfunded portion of $200,000, the net asset value could be $600,000 and the valuation could be 30% of the net asset value. The offering price is expressed as a percentage of the net asset value 98. The percentage may be determined in a valuation process described later.

The offering materials button 97 invokes the page shown in FIG. 8. The listed offering materials 99 have been selected to represent exactly the set of materials that have been determined to be required for presentation to a potential buyer to permit him, under relevant regulations and policies, to place an order. Thus, the exact list of offering materials that are presented depends on the type of interest being offered and in some cases on the identity and characteristics of the user. In the example shown, the offering materials for an interest in a particular limited partnership include a quarterly report 110, a private placement memorandum 112, and the partnership agreement 114. The list of required documents can be determined by the market facilitator or another party based on a specific sell order ticket, on prior similar transfers, and on direct inquiry to the issuer of the interest. The documents do not necessarily include a new private placement memorandum (PPM). Rather, existing financial reports and memoranda can serve the purpose. Thus, because the cost of having to create a new PPM can be avoided in many cases, the restricted interests become more liquid. In addition, it becomes feasible for the market facilitator to profitably handle relatively small transfers, e.g. less than $ 1,000,000. Previously issued documents are supplemented by recent documents such as financial statements (for companies) or quarterly reports (for funds) so that the investor can evaluate the interest and the current information about the issuer.

The highlights button 101 leads to a page (not shown) that can include high-level or special information about the issuer or the interest, and the road show button 103 leads to a streaming video presentation by a representative of the issuer, for example, its general partner.

When the research button 86 is clicked, the user is presented with pages (not shown) of detailed available research information about the issuer or the interest. The research information can be derived from a variety of sources and presented in a variety of ways. Independent research providers could be used to generate research information for restricted interests. Additional information about the generation of research reports is set forth later.

When the place order button 88 is invoked, the page shown on FIG. 9 is presented. Many of the items of information required by the form have been pre-filled based on the interest identified in the page (FIG. 8) from which the user arrived at FIG. 9. Box 116 is completed with the user's account number. The user can change any of the pre-filled information, and can also change the type of order 118 to be a market order, a limit order, a dollar amount order, or an order at a specified percentage of net asset value. The user can also set the period 120 during which the order remains in effect and can enter a specific message in dialog box 122.

In addition to the other buttons described above, the page shown on FIGS. 5A and 5B includes four buttons 120, 122, 124, and 126, called quick links.

The order ticket button 120 leads to the general order ticket page shown in FIGS. 12A and 12B. This is similar to the order ticket of FIG. 9 but has not been pre-filled except with the account number. On this page, the user can enter an order having any desired features for consideration. The quick links also appear on the order ticket page. The order ticket can be a buy order ticket for a user of the kind shown in FIG. 9 or can be a sell order ticket that provides information about an interest that is to be offered for sale. When either a buy order ticket or a sell order ticket is created by a user, the user is given a chance to review the order. Once the user has confirmed the terms of the order, it is added to the list of offers, and may be posted on the website along with other offers.

When the order status button 124 is clicked, the page shown in FIG. 13 is presented. The upper part of the page 125 lists all interests that are subject to a buy order ticket or a sell order ticket by that user for an issuer and an interest to be bought or sold. The information includes, for each line, the member action, the seller order number, the interest symbol, the name of the issuer, the commitment amount on the bid side and the bid price (in terms of a percentage of net asset value) or the commitment amount on the offer side and the offer price (as a percentage), the status of the order, the order date, the settlement date, and the steps completed.

At the bottom of that section are buttons that can be invoked for each of the interests when the radio button to the left of that interest is checked (and assuming that the user has been granted permission). Button 130 enables the user to buy additional funds from the portfolio. Button 132 enables the user to cancel the order, and button 134 enables the user to switch to the Limited Partnership Transfer Management System, described below.

In the lower part of the page 127 shown in FIG. 13, the user is shown interests as to which he has previously expressed an interest. An interest is included in this list after the user has indicated an interest on the order book page described below. If the user wishes to withdraw his indication of interest, he can invoke button 136. An indication of interest is not a buy order ticket.

When all private funds button 126 (see, for example, FIG. 11 and other figures) is clicked, the all private funds page shown in FIG. 14 appears. The order book page shows all restricted issuers that are listed on the website. The list can be navigated by previous and next buttons at the bottom of the section, or by alphabetic indicators, or by a search. Each of the items listed shows the name, fund symbol, fund type (e.g., LBO means leveraged buyout), bid indication as a percentage, offer indication, last price, and three member actions that can be invoked by buttons 130, 132, 134. Button 130 invokes research that may be available for the interest or issuer. The news button 132 provides news about the interest or issuer. The place indication button 134 enables the user to place an indication of interest in the item. If the words on a button 130 or 134 are grayed there is no research or news available.

When the place indication button is clicked, the user is presented with an Indication of Interest Ticket that enables him to indicate an interest in buying or selling an amount that he specifies for an issue that he identifies. He can also enter comments in a dialog box. The Ticket is pre-filled, but the user can override the pre-filled text as desired to indicate any kind of interest. The indication of interest feature enables sellers to be put in a queue to sell interests. Regulations may require a 2% limit on the amount of transfers that may be effected each year for a fund. Thus, it is useful for a prospective seller of a restricted interest to post an indication of interest as early as possible. On the buyer side, the indication of interest alerts the market facilitator of a wish by the user to buy a certain interest. Because the number of buyers to whom an offer can be made may be limited by the issuer, it is useful for the buyers to be able to indicate their interests in advance.

When the order book button 124 is invoked, the featured orders page shown in FIG. 15 is presented. The featured orders page shows, for each interest available for sale, the sell order number, the fund name, the symbol, the commitment amount and best bid price or the commitment amount and the best offer price, the bid due date, the last price, and the net change represented by the last price. Each item provides the same three buttons (research, view offer, place order) as appeared in FIG. 5 (only the research button is shown, the other two buttons are obscured).

Navigation buttons 150, 152, 154, 126, and 158 at the tops of FIGS. 14, 15, and other figures described below, enable navigation among pages for featured orders (FIG. 15), firm orders (FIG. 16), pipeline orders (FIG. 17), all private funds (FIG. 14), and FMV estimate (FIG. 51).

The firm orders page is shown in FIG. 16. For each firm sell order number (e.g., Order 54), all of the items included in the order are listed line by line.

The pipeline orders page is shown in FIG. 17. Pipeline orders are pending sell orders that have not been matched yet. Buyers are able to express an indication of interest in a pipeline order. However, for regulatory reasons, an issuer may need to limit the number of buyers to whom an interest is offered at a given time. The system enables an offer to not be posted and for buyers to be invited by phone call or email to be permitted to view the offering.

The system also assists the market facilitator to act as a qualified matching service (QMS) under IRS regulation 1.7704. Acting as a QMS enables the completion of transfers up to 10% of outstanding interests of a fund in a taxable year, rather than a standard 2%, if the issuer designates the transferred interests as falling within the safe harbor of the IRS regulation.

Invoking the FMV estimate button 158 leads to the page shown in FIG. 51, which is like FIG. 18 but does not include the data under the heading FMV Estimate. The user can enter the name or symbol of an interest in box 161, and by clicking on the FMV Estimate button 159 be provided with the page shown in FIG. 18 that includes the bid and offer indications and last price.

A section of the website in which the user can manage his account is called My Accounts and can be invoked from the top level menu on the home page and other pages.

When the My Accounts menu button is clicked, the transaction history page of FIG. 19 appears. Although none appear in the example shown, the page would list the transactions of the user that are pending or completed.

The user's account could also be linked to custodial accounts so that the user of such custodial accounts can see an account statement showing balances. Of example, the user could have a checking account that provides a monthly statement showing cash balances and also showing balances of restricted interests. As interests are bought and sold, the monthly statements would reflect the transactions and the resulting balances. The system includes the provision of a pricing service to enable users to transfer their portfolios of restricted interests to other parties, such as a custodian bank with the valuations of the interests being determined by the valuations made using the algorithms described here. In other words, because accepted current valuations can be generated and updated frequently for restricted interests, owners of those interests can transfer them, pledge them, and deal with them in ways that have not before been possible.

The pages shown in FIGS. 20, 21, and 22 can be used to change the user's password and log-in ID and to update the member's profile.

The alerts section 64 of FIG. 5A lists information about interests as to which the user has indicated that he wishes to be kept updated on news. The user chooses which interests for which he is to be alerted on the page shown in FIG. 23.

The website provides calculators for a user to determine the values of engaging in certain proposed transactions in restricted interests, thus enabling the user to make decisions about the proposed transactions. The calculator functions can be invoked from the main menu item called “calculators.” The functions of the calculator are performed by underlying algorithms discussed later. The algorithms can be invoked by a user for specific calculations and are also used to generate valuations for all restricted interests or for specific ones that are to be displayed to the user on various pages of the website.

When the calculators menu item is invoked, the explanatory pages shown in FIGS. 24A and 24B are displayed. As shown, among the calculator functions that can be invoked are a quick calculator, a price calculator, and a swap calculator. Custom inputs to the calculator functions can also be entered, which takes advantage of the fact that much of the information about a fund is not public and only known to the fund or its investors.

The quick calculator estimates the secondary transfer price and cash proceeds for a partially-funded or fully-funded restricted interest. The price calculator estimates the secondary transfer price and cash proceeds for a partially-funded (or fully-funded) restricted interest by separately evaluating the funded and unfunded commitment amounts. The swap calculator estimates the benefits of swapping one restricted interest for another.

The information required by the quick price calculator is entered on the page shown in FIG. 25 and includes the fund name, the symbol, whether the interest is to be bought or sold, the commitment amount, the unfunded commitment amount, the funded commitment amount, the net asset value, and the fully funded price. When the information has been entered, the go button 200 is clicked and the results section 202 then appears. The results section shows the funded ratio (the ratio of the funded commitment amount and the commitment amount), the quick price (which is the value of the funded commitment amount expressed as a percentage, calculated by multiplying the fully funded price times the funded ratio), the gross cash proceeds (which is the net asset value times the quick price), and the value, which is the sum of the gross cash proceeds plus the unfunded commitment.

The information required by the price LP calculator appears in FIG. 26. Because the calculation is based in part on estimates of values over time, the page requires the user to enter a start date 204. The fund name or symbol, whether the transaction is a buy or sell transaction and the commitment amount of the interest are entered next. The remainder of the form takes account of the funded commitment and the unfunded commitment in separate sections.

In the funded commitment section, the user can enter the funded amount of the interest, the stated net asset value of the interest, and estimates of the future net asset value on a certain date and the annual internal rate of return percentage. The calculator uses the values, interest rate, and dates to do a conventional present value calculation to obtain the estimated present net asset value. The calculator multiplies the price entered by the user times the estimated present value to get the cash proceeds (in the case of a buy order, the price to be paid) for the funded portion of the interest.

In the unfunded commitment section 206, the user enters the unfunded commitment amount and the estimated future value at a certain date with an estimated internal rate of return (IRR). The calculator then generates the estimated present net asset value using conventional discounting computations. Using a price percentage entered by the user and the estimated present value, the calculator also determines the cash value of the unfunded commitment. In the example, the cash value is less than the unfunded commitment of $250,000, so the purchase price must be corrected downward by a cash adjustment of $184,629.

In the results section 208, the website shows the gross cash proceeds of $124,839 (in this case the cash purchase price of the interest), the unfunded commitment, and the total of the two, representing the value of the interest. The gross cash proceeds is the cash proceeds for the funded commitment minus the cash adjustment attributed to the unfunded commitment. The price is the percentage (8.9171% in the example) of the stated net asset value represented by the gross cash proceeds.

FIG. 27 shows the page that is presented when the Swap LP Calculator is invoked. The question to be answered by the analysis is the economic impact of a possible decision to swap a first restricted interest with a second restricted interest (represented by the two columns 210, 212). The sections of the form titled funded commitment and unfunded commitment have text boxes that are similar to the ones shown on FIG. 26. The information provided at the top in the section titled fund information includes a type, a sector, and a vintage year, which are entered by the user for reference purposes but do not affect the computation. At the bottom, the user enters the period over which the calculation should be done.

The results are provided on the page shown in FIG. 28. The entries in the first two columns are similar to the ones shown in FIG. 26. The third column indicates the net result of a swap and the fourth column indicates the present value of the first restricted interest for comparison with the net swap results.

The section titled historical analysis is empty in this example, but would contain information about the historical return spread. A spread is the difference between a fund's return and usually a benchmark fund's return. Say Bain Capital 7 generated a 50% gross IRR in 2002 and the LBO index (of all LBO funds in the United States) generated a 28% gross IRR. The spread would be +22% for Bain to LBO index. The spread information is useful, for example, when years of return data are made available to a portfolio manager who wants to actively manage his private equity portfolios. For example, if the time period start date is Dec. 31, 1990 and the end date is Dec. 31, 2002, and if the fund to be sold is Baker Telecom II and the fund to be bought is Bain Capital 7, the result shown on FIG. 28 would be a graph and return data for each year showing, say, that Baker's average annual IRR was 90% while Bain's was 25% for a historical spread of 65% per year. However, upon further analysis, Bain averaged, say, 25% for the period 2000-2002 while Baker lost 30% on average for a spread of −55% (Bain vs Baker) (25% less minus 30% or minus 55%).

A portfolio manager may conclude that the market period 2000-2002 will be similar to what he projects for 2002-2005, and therefore may conclude that he should now sell his holdings in Baker and buy more of Bain. The swap calculator will generate a report showing detail of the above and be kept by the portfolio manager so that in the future if his swap did not work out, he can demonstrate his logical basis for rebalancing his portfolio in this way. The calculator report could also be used by a portfolio manager, say, to present to his investment committee the reasoning for making a swap. The committee's decision may be largely a function of the trend that the report illustrates, in this hypothetical case, that Baker's Telecom venture capital funds are falling out of favor in the market and that LBO funds like Bain are coming more into favor, so a pension fund, for example, should seek to own more Bain LBO funds.

Historical return data is typically difficult to obtain, non-public information. But large pension funds, for example, often store the return data internally, for example, on Baker and Bain in the hypothetical case. Yet they do not have the road map that the swap calculator software provides. The swap calculator enables their raw return data to be transformed into a useful portfolio management tool based on their own return data inputs into our software. Thus, the system enables the marketplace for restricted securities to use non-public information that they may possess for decision making regarding transfers of restricted securities,

The information, once loaded, may be used by the market facilitator or the investor in performing tier ranking for a fund. The analysis made available by the swap calculator to users should enable more active management and trading of restricted interests.

The website and system described in this specification, when used, for example, by banks, brokerages, and law firms (representing, e.g., general partners, companies, estates) through their employees at workstations, enables them to advise their clients and customers regarding restricted interests and to facilitate transfers through the market facilitator.

When the custom inputs menu item 220 is invoked, the page shown in FIG. 29 is presented. The page enables a user to enter information known to him about the actual returns for a particular restricted interest. For example, if the user is a limited partner in a venture and knows confidential information distributed by the partnership about the annual returns, he may enter it for use by the calculator in making estimates for purposes of valuations of interests or of swaps.

The user can set the period for historical returns to be entered and the frequency of the available information (e.g., annually). By clicking the go button 222 he is taken to the page shown in FIG. 30 on which he can enter the name of the fund and its symbol and the returns for the periods indicated on the prior page.

When the user invokes the research and news menu item 230 (FIG. 5A) of the website, he is taken to the page shown in FIGS. 31A and 31B. The research section 232 of FIG. 31A identifies research that is available with respect to a particular issuer. The user can identify the issuers or other topics for which he is interested in research in the text box 234 above the research section.

The sections of the page provide links to items of research, news, and news headlines as shown.

The pages that have been described above allow a buyer and a seller to enter orders for restricted interests. The negotiation of an agreement to buy, sell, or swap a particular restricted interest may be completed in a variety of ways. An initial concern in the transaction is setting a transfer value in a market in which it is difficult for anyone other than the issuer to have information sufficient to establish a fair market value. A good solution is to express the value as a percentage of the issuer's (e.g., the general partner's) stated net asset value, without knowing what exactly is the net asset value and without having access to the non-public information about the portfolio. Based on various factors (such as the reputation of the general partner or the vintage of the fund) it can be possible to express value as a percentage of the net asset value even without knowing the net asset value. Thus, the transfer price can be understood and evaluated when the value is expressed as such a percentage. The actual percentage at which the deal is struck may be between bid and ask percentages, or could be the exact percentage previously determined in a valuation process.

Terms other than price may also be important to one or the other of the parties to the transfer. Proposals for the other terms can be expressed in dialog box 122 (FIG. 9). For example, a seller could ask that only half of his restricted interest in a limited partnership be sold.

The actual pricing and terms of private secondary transfer may be negotiated by the market facilitator or another party. The market facilitator may observe the postings of buy and sell tickets on the website and undertake to find matching sellers or buyers and then help to negotiate the deals. Alternatively it may be possible to arrange for the deal to be struck automatically or electronically, or for a broker or other party to be involved in arranging the price and other terms for the transaction.

The market facilitator could be construed as representing the seller if he is working from a confirmed sell order ticket or for the buyer if he is working from a confirmed buy order ticket.

Once the market facilitator is able to match a buyer's bid against a seller's ask value, the two parties and the issuer are notified using a transfer confirmation letter that identifies the interest, the price, and a settlement date. A standard settlement would be two weeks hence.

Prior to settlement, the market facilitator arranges for approval of the buyer by the issuer, signature of the appropriate issuer documents by the buyer and the seller, and the setting up of an escrow arrangement. The escrow arrangement permits a simultaneous settlement by assuring that all documents have been completed and signed and cleared funds are in the escrow account prior to settlement.

Once a deal for purchase and sale of a restricted security has been struck, the steps involved in the completing the transfer can be monitored using the LP Transfer Management System page shown in FIGS. 32A and 32B. This page is invoked when, for example, the view LP transfer management button on FIG. 13 is clicked. The website provides a mechanism for tracking the steps and degree of completion of a transfer of an interest between a buyer and a seller. In the case of a partnership interest, the transfer typically involves the seller, the buyer, the issuer (e.g., the general partner), and an escrow agent. Each of the parties typically must go through a sequence of steps to complete the transfer. The number and nature of the steps will vary with the nature of the restricted interest being transferred. The exact set of steps required for each party for a particular interest can be defined in advance and stored for use in operating the Transfer Management System.

Those steps are displayed in the box 240 on FIGS. 32A and 32B for an example transfer of a particular interest. The order number, issuer name, symbol, and commitment amount are shown at the top of the page, as well as the settlement date, if set. On the top right of the page, each of the parties is identified with an indication 242 of the number of required steps that have been completed by that party. In the steps box, the steps are organized according to sequence into pre-offering steps 244, pre-purchase steps, and pre-closing steps. Within each category, the steps are organized by the party performing the steps. For example, the fifth step 246 to be performed by the seller during the pre-offering phase is to be presented with and review the original private placement memorandum. Some of the transaction steps show a view button 248, which enables viewing of the underlying document online. When a step has been completed, the party who is required to take that step is able to enter a mark in the associated box 166.

The system also provides standard documents such as the buy/sell order tickets, transfer documents, and an escrow agreement, and documents to be signed by seller, buyer, and issuer to obtain a price match, to get the issuer's approval of the buyer, and to arrange a simultaneous settlement and closing.

The simultaneous settlement provided in the escrow agreement uses a commercial bank that does not charge either party, in exchange for meeting the parties for future business. The simultaneous settlement, where no documents are released to other party or the issuer until ALL docs are completed properly and cleared funds are received is the highest settlement standard.

The system uses standard documents and processes for each step of the transfer process, which changes the traditional approach in which highly priced investment bankers or legal counsel customize each document for each transaction. The use of standardized documents and process steps reduces the cost and time for a transfer, makes the transfer more reliable, and improves the confidence level of buyers and sellers in the process, thus improving the liquidity of the market. This now enables small restricted securities transfers to occur (say, under $5 million commitment which is a large part of the market for individual investors and many smaller institutional investors) because the economics of a transfer now can make sense for each party. No upfront retainer is required which enables the market facilitator to charge on a transfer fee only upon a successful transfer.

The issuer's documents and transfer instructions are kept on file by the market facilitator so future sellers and buyers can quickly execute transfers.

The market facilitator will inventory many issuer's non-public information and transfer instructions and documents.

Thus, the system can serve a market need and role for a central global exchange for restricted interests. In addition the system and website and use of the system and website may be licensed to financial institutions, law firms, and others and can be private-labeled with the name and brand of the using organization. The operator of the system and site then provides the functionality, documents, and processes that are offered through the privately branded website to customers and representatives of the organization.

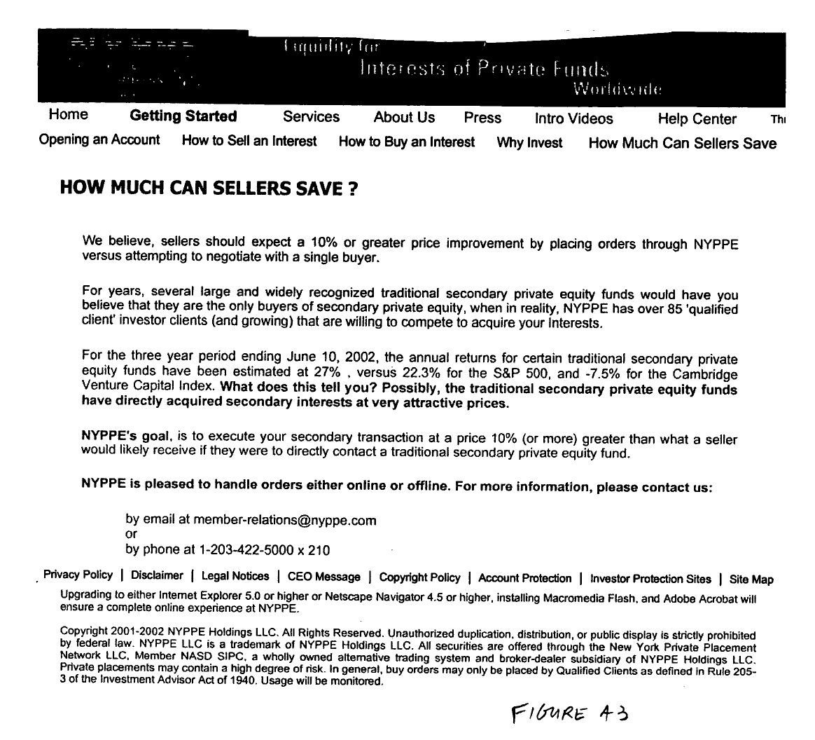

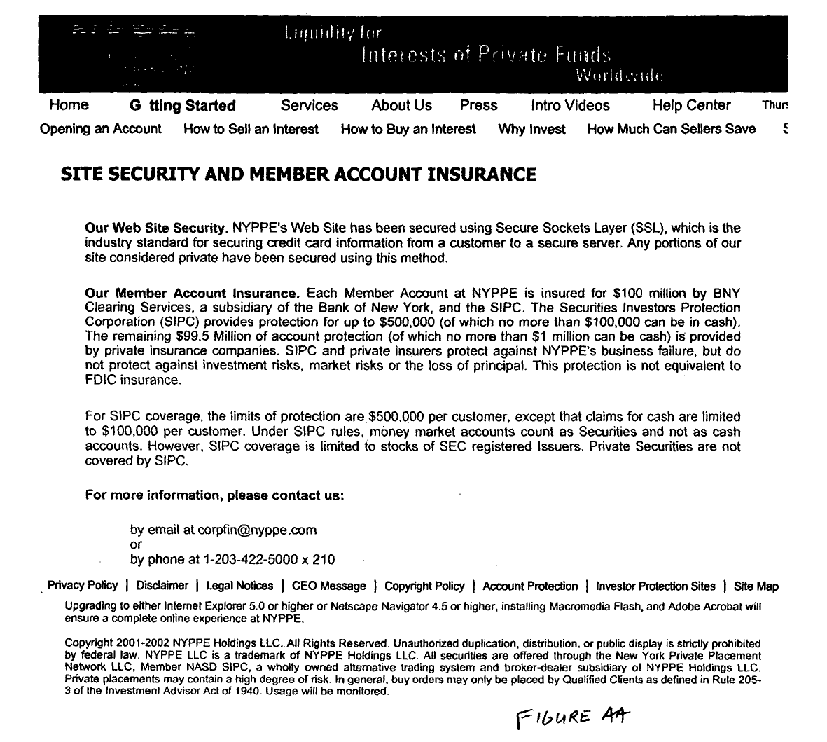

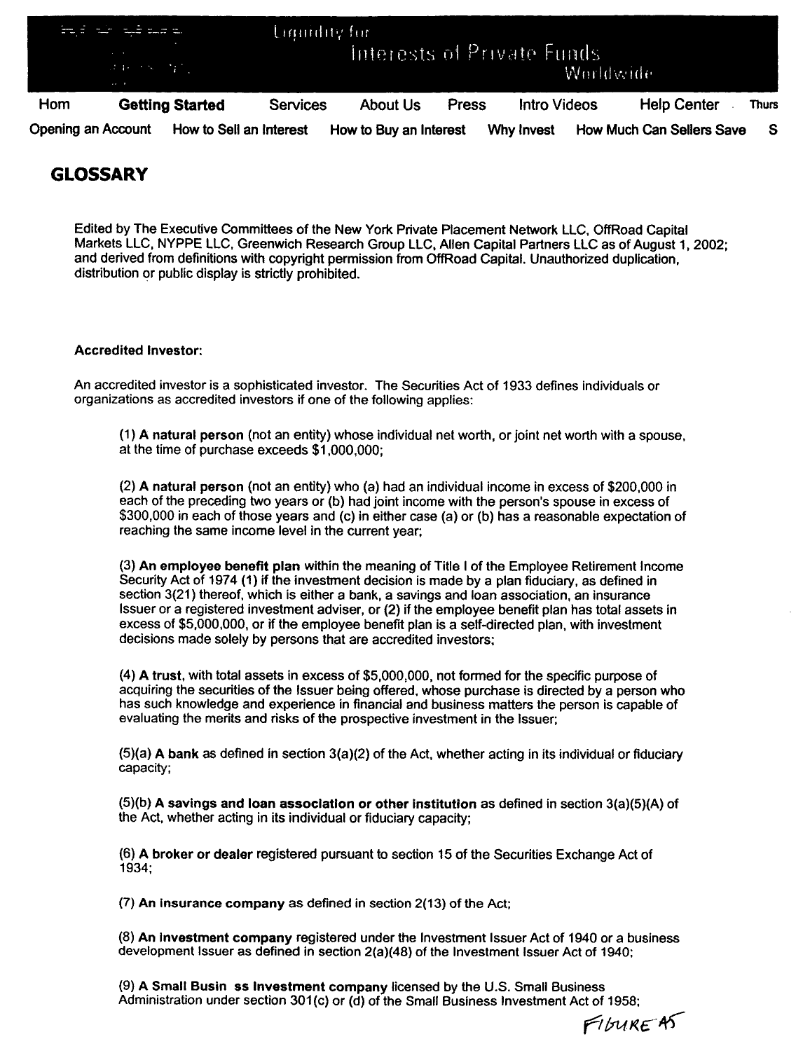

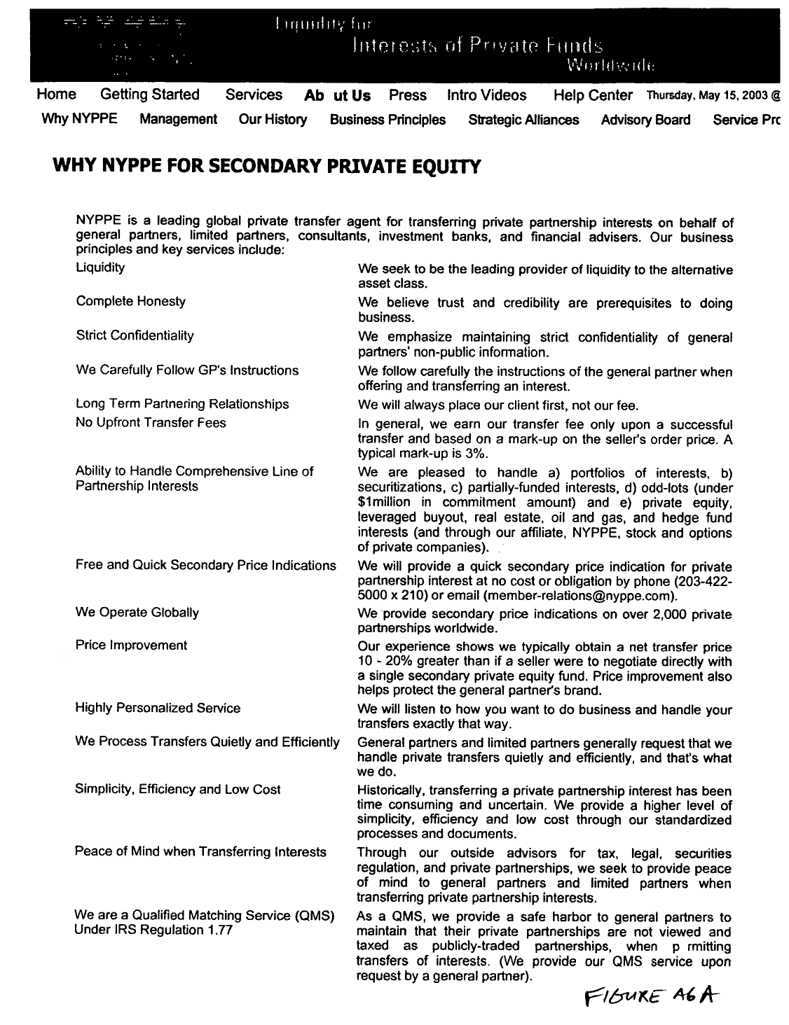

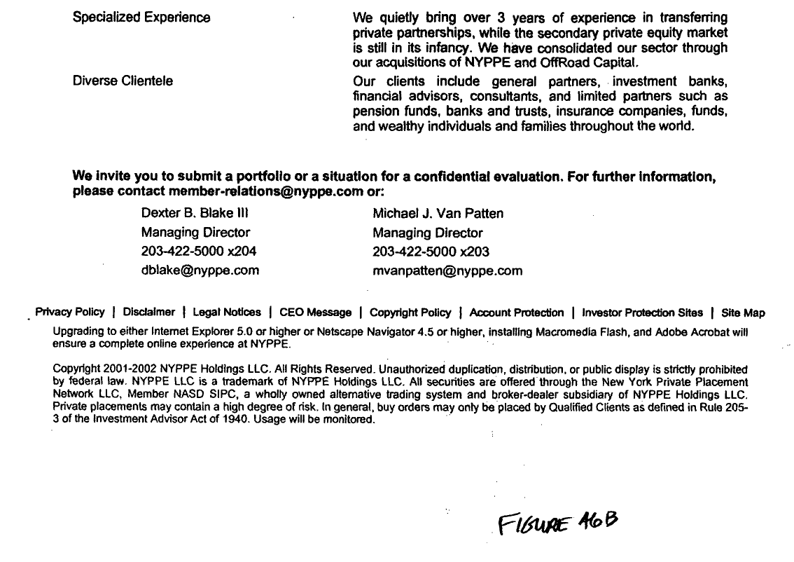

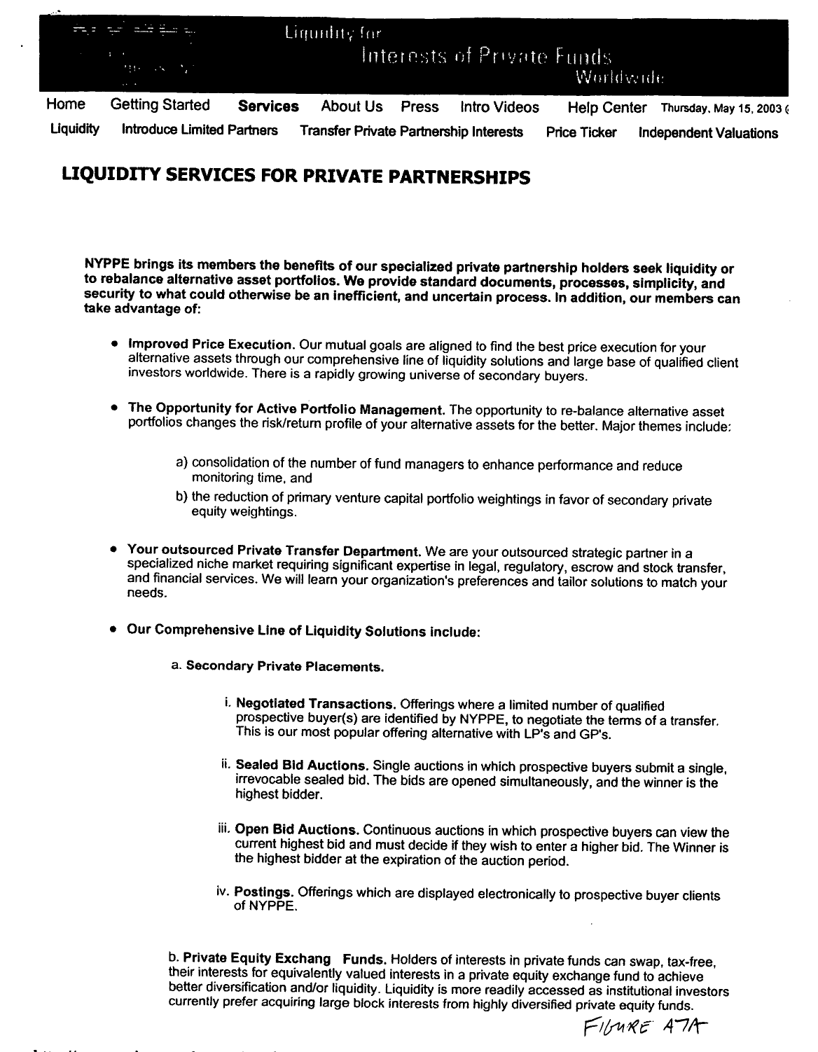

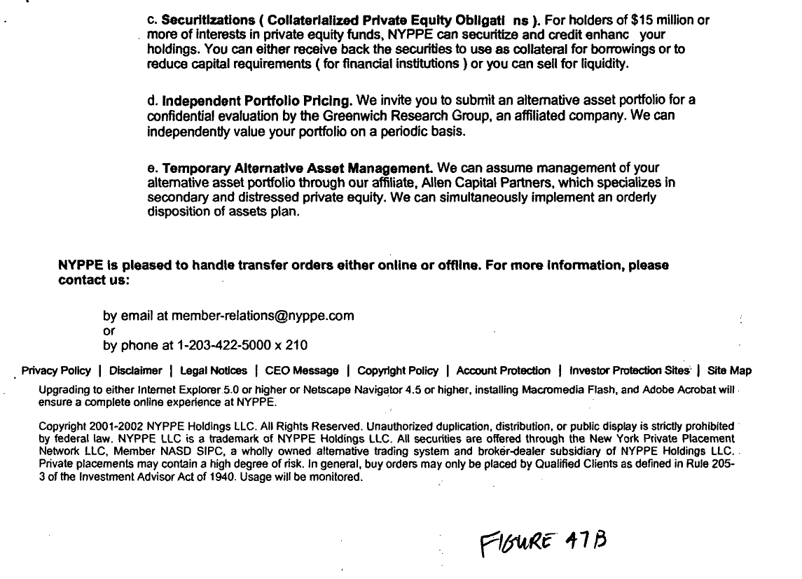

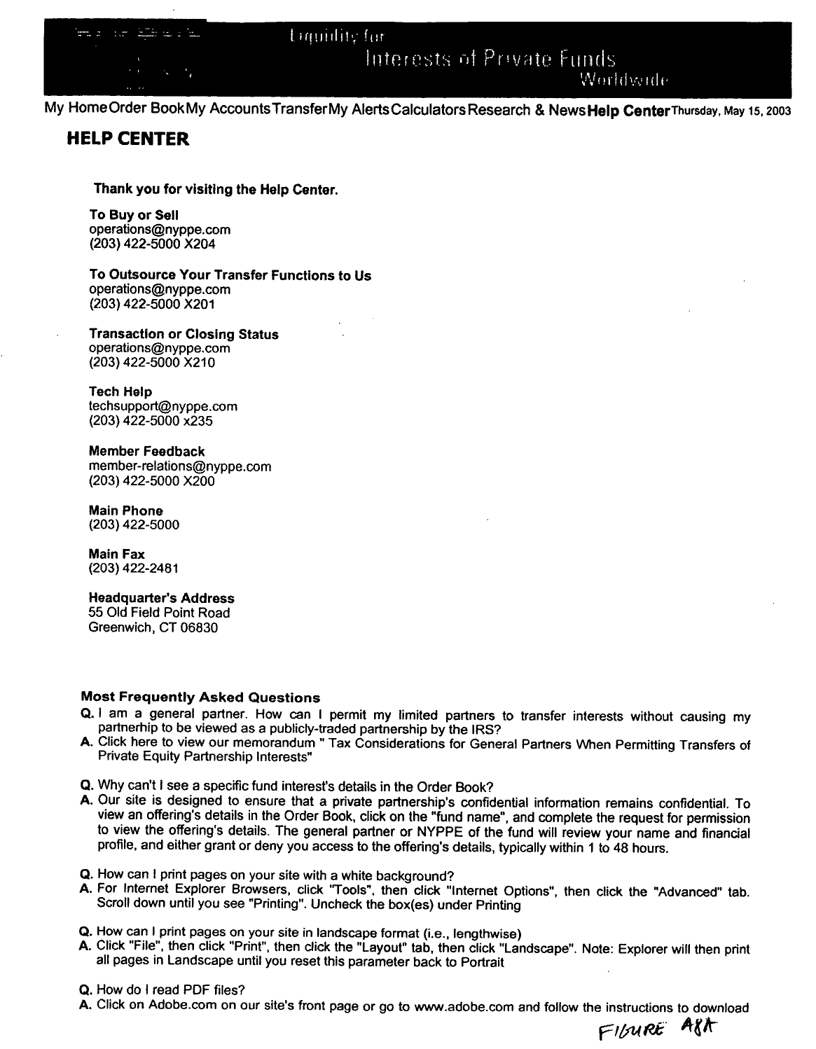

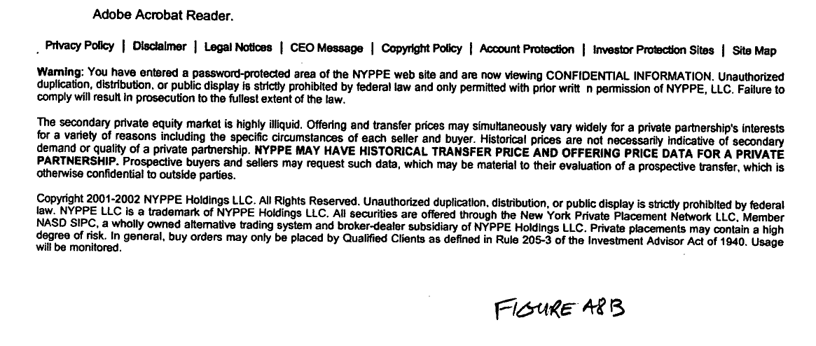

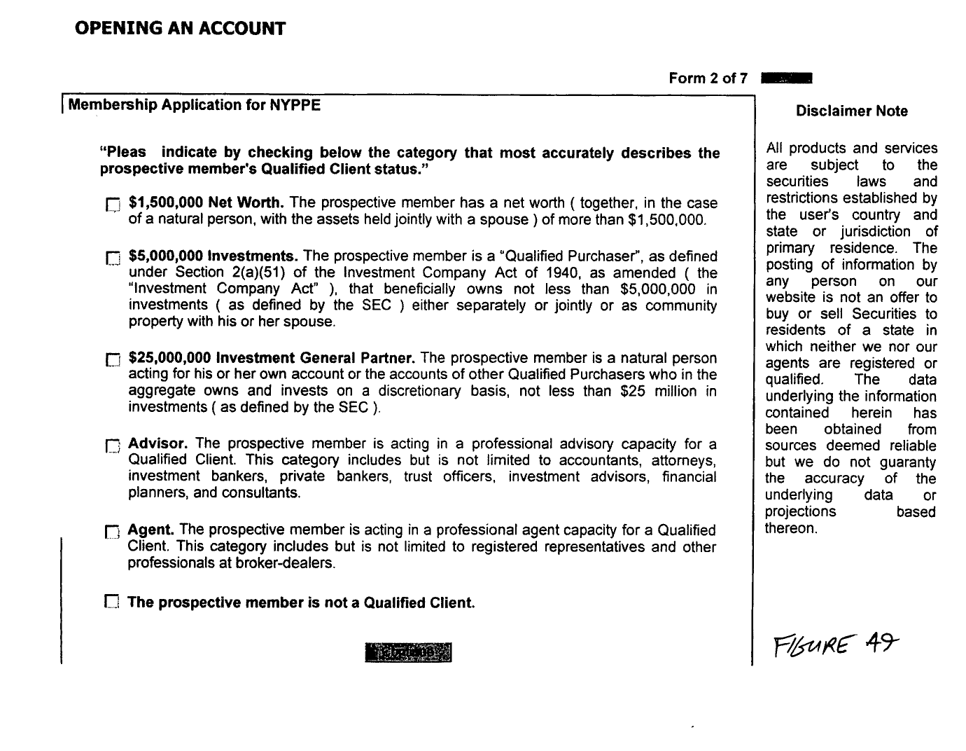

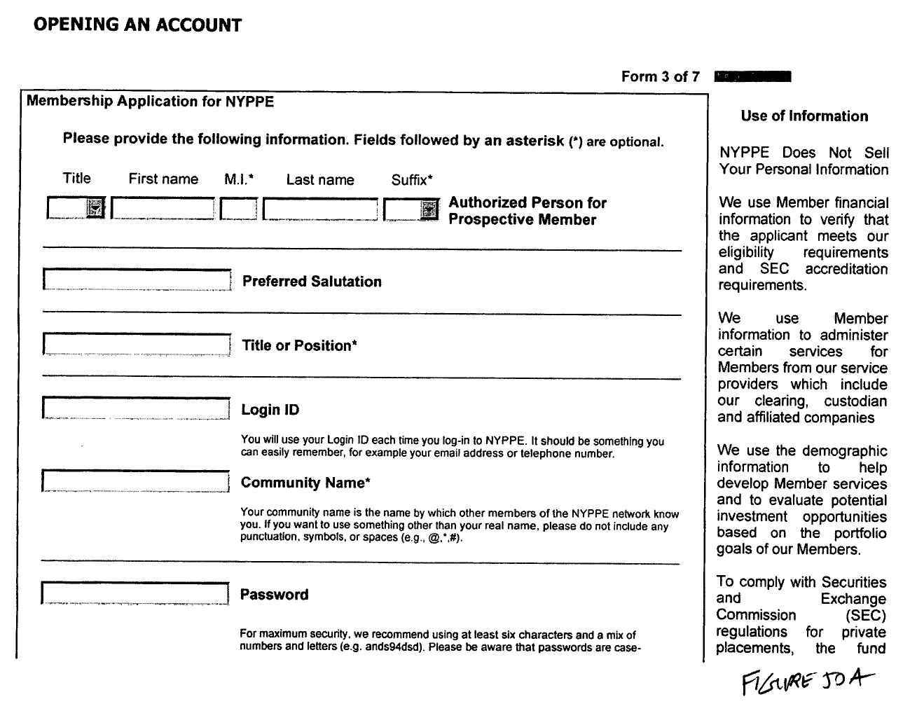

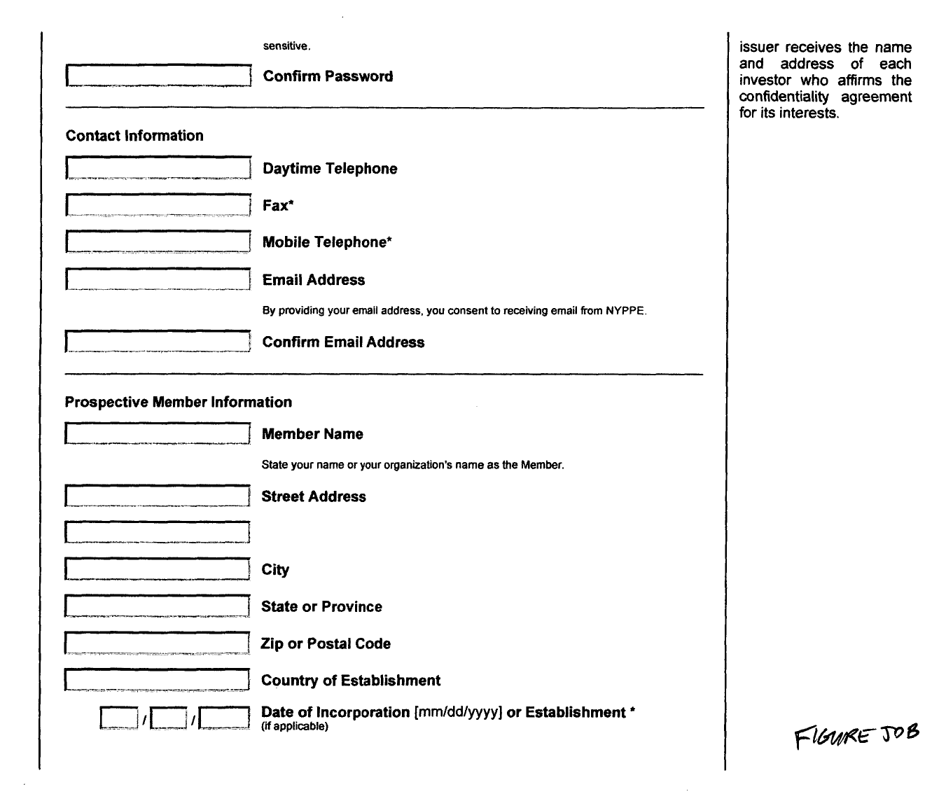

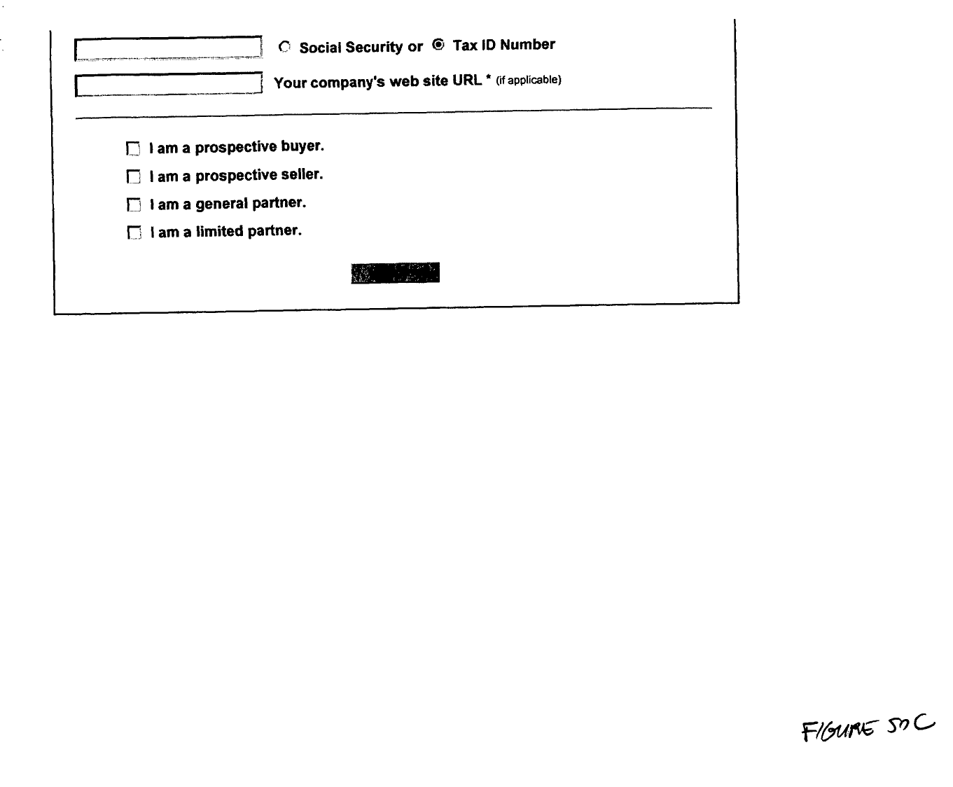

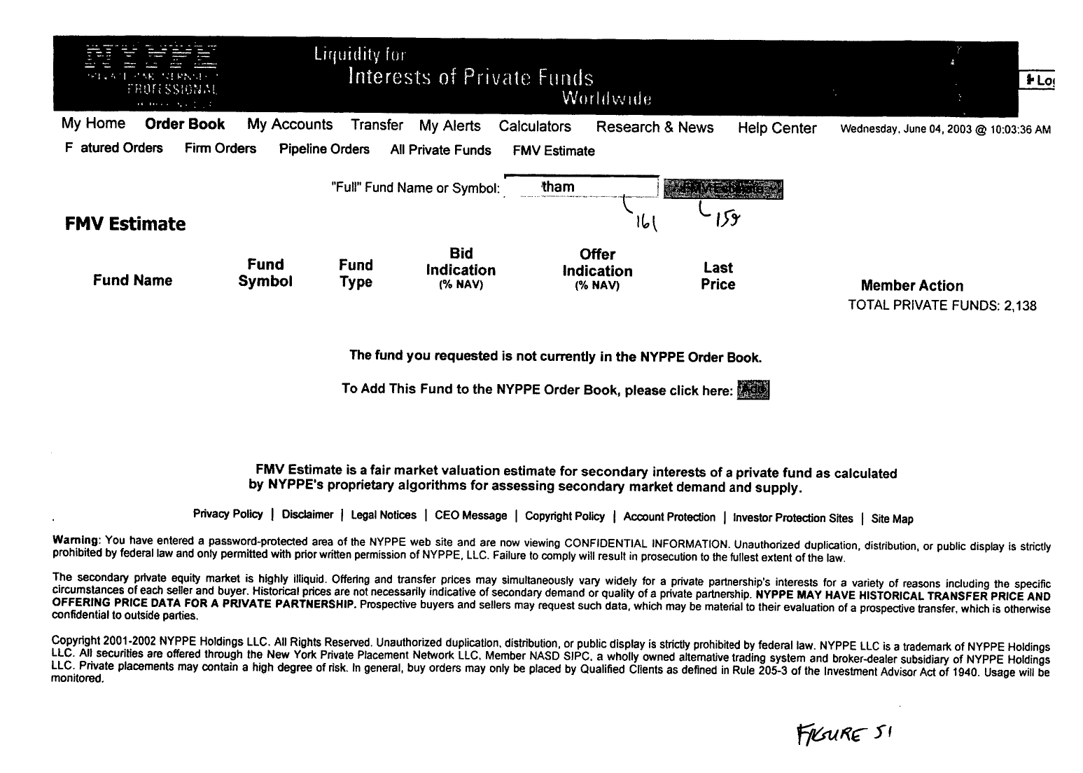

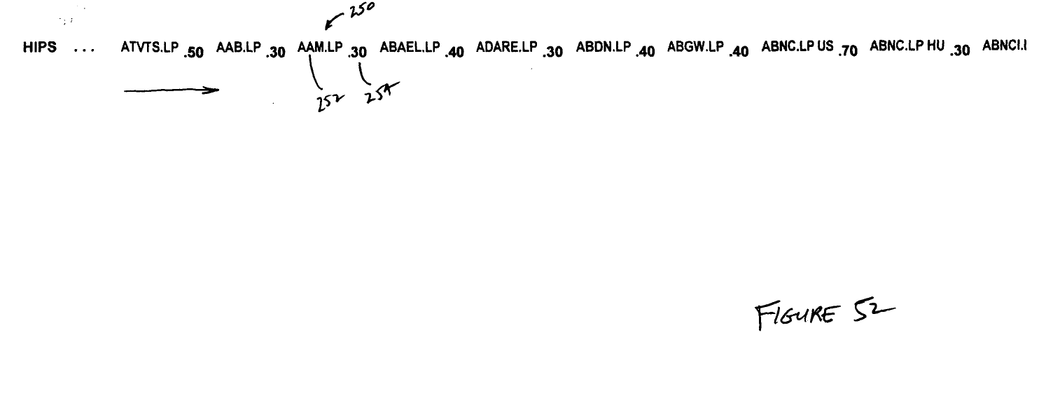

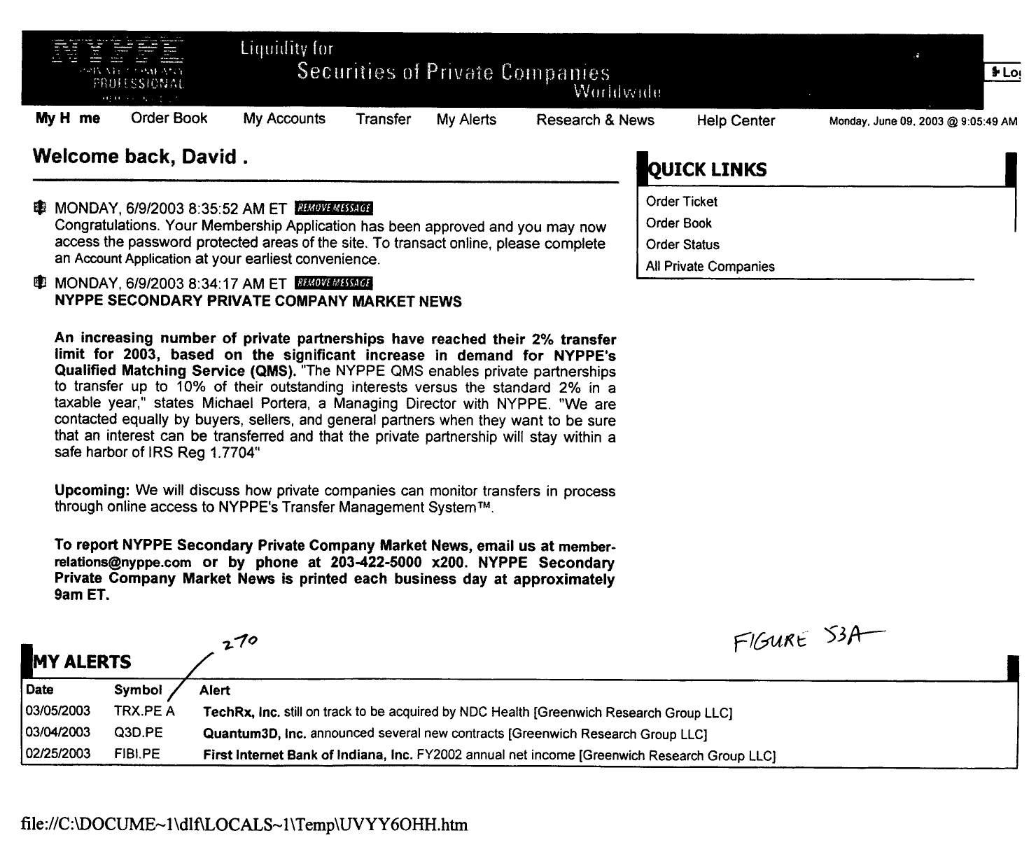

Additional pages available on the website contain information and guidance on the methods and benefits of using the site and are shown in FIGS. 33, 34A, 34B, 35A through 35E, 36, 37, 38A, 38B, 39, 40, 41, 42, 43, 44, 45, 46A, 46B, 47A, 47B, 48A, and 48B.

The website may also include a continuous ticker that moves from left to right across the screen and includes indications of valuations (e.g., current valuations) of respective restricted interests. The ticker could either indicate the most recent individual transactions at specified prices or could indicate estimated valuations not directly associated with particular transactions. In any case, the ticker includes a stream of items 250, each of which includes a symbol 252 and a number 254. The symbol identifies the restricted interest uniquely and the number represents a value stated as a decimal proportion of the net asset value of the interest as represented by the assets on the books of the issuer (e.g., 0.30 means 30% of the net asset value). The number is shown in bold and is slightly lower than the symbol. The symbol can be selected by the market facilitator or by the issuer, provided that each symbol is unique.

The symbol is expressed as a string of characters followed by a decimal separation character followed by a second string. The first string identifies the interest in letters that may abbreviate the full name. The second string identifies the type of interest, for example, LP means limited partnership.

For private partnerships, the ticker values could be fair market value estimates of the market facilitator determined by a valuation algorithm based on the market facilitator's secondary market demand and supply.

For private company interests, the prices are fair market estimates that represent the lowest value among several different approaches: (a) the valuation for the company's most recent capital raising transaction, (b) the intrinsic value of the company based on comparable valuations, or (c) values implied by recent acquisition prices. In the case of intrinsic value, for example, if the valuation metric for banks is price to book value, the average ratio is 3.4×, and a particular bank is an “average” bank, the estimate would be at 3.4 times the book value of the bank. The valuation could then be adjusted for positive or negative factors associated with the particular bank.

A private company often has several classes of securities with different values (prices). The ticker symbol for a private company reflects the values of the different interests. For example, NYPPE.PP-D would represent NYPPE's D class of stock. Using the lowest of the values of different valuation techniques is desirable for investors who want a conservative valuation service for their portfolio investments.

By providing a central, well-respected approach to valuation, and a publicly available website for conveying the information (subject to password protection for non-public information), a market facilitator can become an industry standard for valuations and for establishing commonly used symbols for restricted interests. In this way, the market facilitator may operate as an on-line market for trading of restricted interests much as existing stock markets operate.

A common activity in securities businesses is the generation and delivery of reports about issuers of securities and about the securities themselves. Traditionally the research has been generated manually by analysis of a wide range of publicly available information sources. Custom reports are then generated and circulated to securities brokers and dealers and to customers. Research about issuers of securities (including, but not limited to restricted interests) can be generated quickly and essentially automatically from available sources, especially from the financial statements of the issuer. By generating the reports automatically, the bias of securities analysts and their employers do not form part of the report. The rapid delivery of the research improves the liquidity and fairness of the marketplace. Key features of the report generator include the following:

The research reports are generated automatically by software that searches the financial reports for specific types of information and writes sentences about them automatically.

The text is written automatically using a series of if/then triggers. For instance, the program analyses the electronic versions of the available reports, such as an on-line version of a Form 10Q report, to identify the sales during a recent quarter, compares the sales with the same quarter in the previous year, and writes that the sales were up or down versus that quarter. The program also uses thresholds to trigger the insertion of adjectives (“up sharply” or “up slightly”, or “practically unchanged”) to describe different levels of revenue increases, for instance. The report generator also can, for example, compare year-to-date (YTD) sales with a previous year's YTD sales, if available. The program locates whatever data is available (because different companies report with different levels of detail), and analyzes that detail.

Among the items that may be analyzed are accounts receivable days, accounts payable days, gross margin, and inventory turns. The program may also compare the figures to other companies in the same sector. If a company's figures are substantially different from the average or median of the comparable companies, the program writes an English language sentence, which is a template based on the condition. Numbers, product line names, quarters, and certain descriptive adjectives are inserted as appropriate. Certain kinds of events may be bolded (e.g., “The Company had a negative gross margin in 4Q02.”)

The program also can reconstruct earnings by subtracting out extraordinary items or computing earnings assuming a normal tax rate (as many companies get tax rebates, etc.). The program also makes other computations and generates an appropriate English sentence if the situation warrants (for example, for low inventory turnover, high burn rate, low cash, aging payables, aging receivables, low stock market volume, low P/E ratio, or low P/Sales ratio).

Reports are generated automatically by software and can have manual modifications. A manual review is useful to make sure the data and logic are correct. A first report can be written in 3 minutes. Future reports can take as little time as 10 seconds (if not much complex input) or up to 3 minutes.

The report is based, for example, on news or data available on the Internet or on financial statements provided by the issuer. Because the reports can be generated within a few minutes, automatically, it is possible to generate reports rapidly in response to specific requests of users. Once a first report for a given issuer has been generated, subsequent reports for the issuer can be generated in seconds.

As news or data changes throughout a trading day and is identified on the Internet by the software, a user (for example, a trader or an active portfolio manager) can request a fresh research report every few seconds if he wishes. The reports contain information that is independent of any policies or positions of any company or institution that generates them or uses them. That independence can be certified to readers. The source of the report can develop a reputation for objectivity in the certified reports.

The research report generator for private companies determines an intrinsic value of a security by comparing the target company to other companies in the same sector and calculating, for example, average, high, and low price-to-earnings multiples. The comparison with other companies in the sector leads to fair valuations. The report generator also automatically determines an appropriate metric to be used in valuation. Thus, in one sector the metric may be price-to-earnings, while in another it may be price-to-book value.

The automatic report generator is helpful for investors who do not want to get overly optimistic projections by a research department, but rather want a current snapshot of a company's historical performance and the market's current valuation multiples for comparable companies to determine the right price for the security.

The reports generated by the automated report generator could be distributed in a variety of ways. The reports could be on paper, sent by email, or posted on a website. The reports could be distributed free or a charge per report could be made. Or a monthly license fee could be charged for an unlimited number of reports.

Because the reports will be easily available, brokerage research analysts would be able to cover much larger numbers of companies instead ofjust the normal 20. The automatically generated reports would cover the core information and the analysts could add other information if desired.

The automated report writer could be configured to write different sentences in different styles for each of many different customers, for example, brokerage firms, and the brokerage firms can put their own names on the research report. An additional licensing fee may be charged for that privilege. The revenue model under which the report is generated could be altered to suit the firm's internal view of the appropriate revenue model.

The report generator takes information from a database that is populated with information about the company in question. For example, one of the tables holds income statement data—sales, cost of goods sold, research and development expense, sales and marketing expense, etc—for the various line items that appear on financial statements. These are drawn automatically from electronic versions of available financial reports. Another table stores balance sheet data, and a third table includes basic company data such as the company's address, its officers, and its line of business.

The database can be populated in a number of ways. For publicly-traded companies and funds, and private companies and funds the program can obtain in real-time information from the Internet. Possible sources include (a) SEC filings, (b) news, (b) subscriptions to services, (c) other third party service providers, (d) a commercial database, (e) manual input using input forms that include an ability for modification to aspects of the program, say, to a revenue projection model, as entered, for example, by a research analyst, or (f) a combination of the above.

When the user of the research report writer selects a company or a fund, the program accesses the database and reads the information about the company or fund. It then analyzes trends in various fields of the data such as an income statement for a company over time (Have sales increased? Has the gross margin improved?) and the balance sheet, which is analyzed for certain items such as accounts receivable days and accounts payable days.

The report generator software automatically prepares a descriptive narrative without human input using English language text, including use of adverbs as appropriate. If financial data has changed drastically or something is out of normal bounds (e.g., over 90 days accounts payable) then the program automatically generates a sentence to report that fact.

For instance, suppose XYZ company is chosen by the user. Suppose that, in the most recent quarter for XYZ, sales were $5.3 million, but in the same quarter a year ago, sales were $4.9 million. The program would compare these two figures, and write a sentence along the lines of: “Sales in the third quarter of 2003 were $5.3 million, an increase of 8.2% versus the third quarter of 2002.” If sales were $15.3, the program would write “a sharp increase of” instead of merely “an increase”.

The program also compares data for the selected issuer to other similar or comparable companies. A text description field can be used to find similar companies. SIC Codes could be used especially for older industries. The program retrieves data about similar companies, and compares their sales growth rates, gross margins, profit margins, R&D expenditures as a % of sales, and so on. The program also stores historical stock prices, and it compares stock performance of the company in question with other publicly traded companies. For private companies, the program computes implied valuations based on comparable public companies.

The English sentences are generated by a series of if/then statements. Certain if/then statements add a single adverb, other if/then statements determine if there's enough data to work with (for instance, if the report was looking at a retailer, the program probably wouldn't compute R&D ratios since retailers don't spend anything on R&D typically).

Examples of reports are shown in FIGS. 56A and B (listed company—stock report), and FIGS. 57A and 57B (listed company—credit report).

The data required to maintain and operate the online facility 16 is stored in one or more tables of one or more databases 40. The data can be organized in a wide variety of ways and include a wide variety of data elements. The schemas of databases used in the system are set forth in Appendices A, B, C, and D.

The data can include information about restricted interests in existence in the marketplace. These would include, but need not be limited to, restricted interests that are subject to pending buy order tickets or sell order tickets, restricted interests that are subject to indications of interest, restricted interests that are included with the cooperation of the issuers of those interests, and other restricted interests that are included without the cooperation of the issuers.

With respect to each restricted interest, the database may include the name of the issuer, the date of issuance of the interest, the type of interest, the class or series of the interest, and a link to valuation information about the interest.

The valuation information for an interest may include a current estimated valuation, historical information about prior valuations of the interest, an identification of an algorithm that was used in making the valuation, data that underlies the valuation, and an identification of other related valuations.

The database schemas can be used to recreate the database tables, table relationships, views of the data, stored procedures and triggers that maintain the relational integrity of the data of the system for the Microsoft SQL Server 2000 running on a Dell workstation having dual processors and running Windows 2000 Advanced Server. The following includes more background information on the schemas:

The database is logically and physically organized into two main types of restricted interests trading and restricted interests trade processing areas: secondary trading of private funds (PT); and secondary trading of private companies (PC). Each of the functionality areas are logically and physically organized into 3 main areas of functionality: login/authentication; account related information including positions and holdings; and trading and transaction related information.

All of the above functionality is contained in the two main databases for each type of restricted interest. For example, PT_Accounts and PC-Accounts are the databases where all client account information is maintained for applicants and members with access to functionality to trade private funds or private companies, respectively. A client can have multiple accounts. Account information also includes the following data: the areas and functionality within the site that the user has access to; the information that the user can see in these areas; the areas where confidential offering information is housed and whether the issuer has permitted the user to see this information; customized messages targeted to all client accounts or specific messages targeted to specific client accounts; client contact information (phone, work, address, fax etc.); client personal and confidential information (ss#, user name, password).

PT-GEORGE and PC-GEORGE are the databases where all trading and trade processing information is maintained for private funds and private securities respectively. The main data areas housed in this database include: sell orders (featured, firm orders and pipeline orders); buy orders associated with each sell order; indications of interest (to buy or sell funds or securities that are currently not being offered); fund Information including details for the fund including: NYPPE symbol, the main holdings, issuer information, fair market value information, bid, offer, trade price, last price, news, news headlines, fund type. Users can also enter and store historical return information that can be used by the calculator functions on the web site; trade processing status notebook which keeps track of the number of steps completed to date in for transfer process; positions by client account; emails (formats and definitions) to be sent upon receipt of orders or indications; and trade which is the match of a buy and sell order.

The calculators described elsewhere retrieve and use historical returns entered by users for the charts. All other information used in the calculators is typed in manually by the user. Results are not stored in the database.

Fair market value is tied to the tier of the fund and is stored in a table called fund returns.

Research and news are also included in fund information and are stored in tables called fund news and fund news headlines.

The valuation algorithm estimates a real-time fair market value of restricted interests in a secondary transfer based on factors that include (1) an assessment of current buyer demand for a fund based on known buy lists of buyers of restricted interests, (2) market knowledge of actual historic transfer prices for specific interests, (3) assessment of a fund's most recent quarterly return performance versus comparable interests in a same or similar sector (a sector could be, for example, early stage biotechnology funds), and (4) a profile of the issuer of the interest.

The profile of the issuer could include (a) its vintage year (e.g., 1999 and 2000 vintage funds may be less attractive because fund investments were likely made at above market company valuations), (b) its geographic location (e.g., South America funds may be less attractive than US funds), (c) its unfunded commitment as a percentage of the total commitment (the larger the unfunded percentage the lower the demand), (d) its sector (e.g., telecom may be less attractive at a particular time), and (e) the size of an offering (less than $1 million commitment amounts may be considered odd lots have less buyer demand).

The factors of the algorithm may be combined in the following way to estimate a fair market value of a fully-funded restricted interest on the secondary market:

Step 1: DETERMINE FUND'S TYPE. The transfer agent (e.g., the market facilitator) determines the type of fund by examining the fund prospectus or a database of private fund data: the categories are those where the transfer agent has fair market value benchmarks categorized by the tier rank of the fund. The types may include leveraged buyout (LBO), venture capital, private debt, mezzanine, real estate, and oil & gas.

Step 2A: DETERMINE MARKET'S NET DEMAND FOR FUND. The transfer agent assesses the secondary market's (a) total buy demand and weighted average bid price for the fund and (b) total sell supply and weighted average offer price for the fund, the difference of which is the market's net demand and price for the fund.

For example, an unranked LBO fund is assessed by the transfer agent as having $1 billion of current buy demand (expressed in dollar commitment amount) at a weighted average bid price of 90% of NAV and $20 million in current sell supply at a weighted average price of 100% of NAV, for net market demand of $980 million at a weighted average price of 90.196% of NAV (i.e. [90%×($1,000,000,000/$1,020,000,000)] less [100%×($20,000,000/$1,020,000,000]).

Step 2B: Rank in Tier

If the net market demand is greater than $100 million, the fund is ranked based on the weighted average price. In the above example, if tier 1 LBO funds are currently in a range of 90+% of NAV and the weighted average price of the fund being analyzed is 90.196%, the LBO fund would be categorized as a tier 1 LBO fund. No further scoring of this fund is required. The premise is that the greatest factor in accurately determining the likely price at which a fund's interest will transfer is the assessment of the secondary market's net demand and weighted average price for the fund, provided that a minimum critical mass of demand and supply is assessed.

Thus, the tier ranking is tier I and the weighting of that rank is 100%. If net market demand is greater than $100 million then, as explained, no further analysis is done in the algorithm.

If the net market demand is less than $100 million, then the other steps explained below are applied and the weighting of the tier ranking in this step 2B would be 30%. For purposes of illustrating how the steps below are considered, we will assume the weighting for step 2B is 30%. The score of 1 for step 2B then must be multiplied by the weighting of 30% for a score in this step of 0.3.

Note: The tier rank was 1 because the weighted average price was 90.196% of NAV, which is, in this example, categorized in the tier 1 LBO range of 90% of NAV or greater. A tier 2 LBO fund range could be one in which the weighted average price is 80% to less than 90% of NAV. A tier 3 LBO fund range would be, in this example, 70% to less than 80% of NAV, and so forth. The actual percentages could be different for different kinds of interests and for other reasons.

Step 3: Assess Historical Transfer Prices of the Fund

The transfer agent assesses the fund's most recent transfers based on (a) net price to seller, (b) dollar amount, and (c) buyer and seller profile.

For example, if an unranked LBO fund has had one transfer in each of the prior 12 months (for a total of twelve transfers) and in each case (a) the price was 50% of NAV, (b) the dollar amount was $1,000,000 in terms of commitment amount, (c) the buyer was a secondary private equity fund (a professional buyer), and (d) the seller was an individual investor that was delinquent in its capital call, then the transfer agent's weightings of each non-price field could, in one example, be: Dollar Amount: $1,000,000 Rank: 4% (As $1,000,000 is considered an odd lot and is assigned a low credibility weight of 4% with the range being 1-10% and 10% being the highest credibility weighting.)

Buyer profile: Rank: 3% (Buyer is a professional, so a low credibility weight is assigned of 3% (with 10% being the highest)

Seller profile: Rank: 3% (Seller is distressed, so a low credibility weight of 3% is applied.)

Thus, the outcome of step 3 is a Tier Rank: 5 with a Weighting: 10% (the sum of the three percentages of the three factors above).

The highest possible weighting for this step is 30% (10% plus 10% plus 10%).

A tier 5 LBO fund range is, in one example, at 50% to less than 60% of NAV.

The score is calculated by the tier 5 ranking times a 10% weighting for a weighted score of 0.5.

Step 4: Assess Historical Relative Returns of the Fund

WEIGHTING: The total weight for Step 2 and Step 3, called the Weight Total (i.e., 30% for step 2 and 10% for step 3) is 40% leaving a weight amount of 60% to be divided between steps 4 and 5 in equal weights. Here that would be 60% divided by 2 or 30% weight for step 4 and 30% for step 5.

If the fund ranked in the top 20% among its peers in the prior twelve months, then it would be placed in tier 1 with a weighting of 30%. If the fund ranked in the second 20% it would be placed in tier 2 with a weighting of 30%, and so on.

If the fund here were placed in tier 1, its score of 1 would be multiplied by the weighting of 30% to get a weighted score for this step of 0.3.

Step 5: Assess Profile of Fund

The final 30% of weight is attributed to a tier level determined on the basis of a variety of factors that include the following:

Vintage year (for the year 1997, for example, the tier could be tier 1)

Dollar amount committed to fund (if $1 billion, for example, the fund is large and might be placed in tier 1.)

Dollar amount committed to the issuer's family of funds (if $5 billion, indicating lots of visibility among investors, the rank might be tier 1.)

The percentage of limited partners that are institutional investors (if 75% or more, the rank could be tier 1.)

Sector: (if the sector is biotech, which is currently favorable, the rank could be tier 1.)

Geographic: (If USA, Europe, Asia, which are currently considered desirable, the rank could be tier 1.)

Each of the factors above is given an appropriate weight, for example, equal weight. Suppose the weights are such that the weighted average of the tier rankings of the factors is 1.0. This score must then be weighted by 30% for a weighted score of 0.3.

Step 6: DETERMINE FUND'S TIER RANK. The transfer agent then determines the overall “tier rank” of the fund, which will result from a weighted average score derived from the steps above. In this example, steps 2B had a score of 0.3, step 3 a score of 0.5, step 4 a score of 0.3, and step 5 a score of 0.3 for a total of 1.4. If the total score is between 1 and 1.5, the score is rounded down to 1.

The algorithm is an assessment of the level of secondary market demand for a particular fund.

For example, a Tier 1 ranked LBO fund may be assigned a current fair market value estimate of 90% of it's stated net asset value (NAV) where (a) the NAV is provided by the issuer of the fund and (b) the interest in that fund is assumed to be fully funded (that is, the amount funded by the fund's investor equals the investor's commitment amount to that fund.)

On the other hand, a Tier 1 ranked Venture Capital fund may be assigned a current fair market value of 70% of NAV, implying that the secondary market is currently paying more for LBO funds than Venture Capital funds.

If an interest to be valued is ‘partially funded’, then the fair market value estimate above is adjusted by multiplying the interest's ‘funded ratio’. For example, a tier 1 LBO fund with a 60% funded ratio (funded ratio equals the investor's amount funded in the fund to date divided by the investor's commitment amount to the fund) which is initially assigned a 90% of NAV fair market value estimate is adjusted by multiplying the 90% by 60% for a revised fair market value of 54% of NAV for an interest in that fund.

Other examples of the use of the system include the following:

### EXAMPLE 1

If a private partnership (issuer) seeks to raise capital for a new fund and wants to know what should be the price and terms of its new issue, the issuer can look up prices posted on the ticker for interests in its other funds as an estimate of an appropriate fair market value for the new issue. The new issue fund price may then be increased by 10-50% versus its secondary fair market prices and terms such as the amount of carry (incentive fee) percentage to the general partners can be altered.

### Example 2

Suppose a prospective investor seeks to make a purchase of a secondary interest or a newly issued interest in an ABC Fund, and wants to know what is a fair purchase price for such an interest. As the investor must make an independent evaluation of the purchase of interest, the investor can use the prices posted for ABC Fund secondary interests on the ticker for an independent estimate of current fair market value of interests in an ABC Fund.

Investors generally must make a written representation that they made an independent evaluation in a purchaser's subscription application in order to purchase restricted interests. However, because the only offering document available to a prospective investor often is a private placement memorandum (PPM) (which is written by the issuer) and then edited by the fund's legal counsel, there is only limited useful information available to prospective investors to make a reasonable evaluation of the fair market value of secondary or newly issued interests of an ABC Fund.

### Example 3

If a limited partner (investor) in an ABC Fund wants to sell and needs to determine at what price to sell his interest, the limited partner can look up the price posted on the ticker for an independent estimate of the current fair market value of such an interest.

### Example 4

If an institutional investor, portfolio manager, investment advisor, or individual holder of interests in ABC Fund wishes to report an historical fair market value of its portfolio's holdings to clients or shareholders, say for annual return performance purposes, it can look up the price posted on the ticker for an independent estimate of the historical and current fair market value of that interest. This would yield fairer and more independent reporting and also protection to portfolio managers.

### Example 5

If the valuation of interests in an estate is sought, due to death, divorce, or taxes, for example, a fair market price is needed, and the trustee can look up the price posted on the ticker for an independent estimate of the current fair market value of the interests.

### Example 6

If an investment advisor wishes to provide a client with a recent price quote of the fair market value of interests in ABC Fund, the portfolio manager use the price posted on the ticker for an independent estimate of the prior and current fair market value of such interests.

### Example 7

If a financial intermediary such as a broker dealer, alternative trading system, or exchange—whether conducted offline or online or in another electronic manner such as wireless—seeks to provide its clients with a price estimate of the fair market value of the interests of ABC Fund, whether to support a recommendation for purchase or to quote a price for market to market purposes, the price can be looked up on the ticker for an independent estimate of the fair market value of such interest. This would help provide consistent standards and pricing in this market.

### Example 8

If a firm seeks to provide its subscribers or readers estimates of the fair market value of interests of ABC Fund, the firm could access the ticker for such fair market values. The price estimates provided by such a firm may include derivative works or similar replications of the fair market values as stated on the ticker. Such firms may include non-broker dealers such as software firms, search engines, database firms, or technology driven firms that may offer various delivery channels to its customers. The channels could include but not be limited to its own price quote system, a search engine, trading software, or private transfer system made available through lease, subscription, or other contract or non-contract to its users. These cases may include situations where the fair market values are derived from the ticker and are offered free of charge to such firm's users in exchange for say leasing its software or for potential views of advertisements on its web site.

### Example 9

If a research analysis or news delivery firm seeks historical and current fair market prices for the interests of ABC Fund to provide its readers or subscribers with a research report or news story about the performance of an investment in the ABC Fund, such firms could look up the price posted on the ticker for an independent estimate of historical and current fair market values. This would help provide consistent standards, pricing, and evaluations regarding interests in ABC Fund in the market.

The maintenance of the pricing database and the distribution of the price information will help businesses grow by providing easier access to fair prices and therefore, private capital investment, all within regulatory guidelines. Enabling and providing liquidity and independent information helps investors to become more comfortable with investing in private assets, yielding significantly higher volumes of transfers. Higher volumes of transfers and a liquid market will, as for other markets, lead to job grown and economic growth.

Turning to the use of the system for interests in private companies, e.g., stock, options, convertibles, and bonds, the existence of the website and the ticker will enable institutional and individual investors to make an independent evaluation of the fair market value of such securities, an important requirement of the NASD before a party can sell or buy such securities, and will enable them to meet their own fair reporting requirements to holders of their portfolios.

The system will also permit a significant dollar amount of transfers of ownership to provide liquidity for sellers and the ability to rebalance portfolios and add value to maximize returns.

The algorithm for estimating fair market value of restricted interests (in the following example, common stock) in the case of private company issuers (say, ABC Company) can include the following steps:

Step 1. Identify comparable companies, either private or public, typically in the same sector as ABC Company.

Step 2. Learn the most recent company valuations of the comparable companies based on the terms of (a) most recent capital raises and/or (b) the terms under which the company was acquired. Valuations of comparable companies that are public are reduced by 25% on average (and depending on sector) as private companies typically have lower valuations than otherwise comparable publicly traded companies because of reduced liquidity of their securities.

Step 3. Assign an appropriate valuation metric to the comparable companies and calculate the average valuation ratio among the comparable companies. For example, for banks, the price-to-book value may be the valuation metric and 2.5× may be the average valuation ratio among the comparables. For manufacturing companies, price-to-last 12 month earnings may be the valuation metric and 12× may be the average valuation ratio among the comparables. For technology companies, price-to-last 12 month revenue may be the valuation metric and 5.3× may be the average valuation ratio among the comparables. For biotechnology companies, price-to-clinical trial phase I, II, III may be the valuation metric and a $100 million company valuation for completing Phase I trials may be the average valuation ratio among the comparables.

Step 4. Apply the average valuation ratio to the profile of the ABC Company for a fair market valuation of ABC.

Step 5. Make adjustments to the fair market value of ABC based on unique characteristics of ABC by adjusting the valuation ratio applied to ABC. For example, negative adjustments would be used if ABC's cash balance is less than its last 12 month negative cash flow plus capital expenditures amount, or depending on an estimated amount and probability of pending legal or other claims against ABC. A positive adjustment could be made for assets not valued at market such as intellectual property.

Step 6. Divide the fair market value of ABC by the number of fully diluted shares outstanding assuming the conversion to common stock of all options, warrants, and convertible securities. The result is the fair market price estimate per share of the common stock of ABC.

Step 7. To create the price per share that is posted on the ticker, which is the fair market value for ABC's common stock, apply the following weighting algorithm:

50% weighting to the most recent price per share of common stock issued by ABC or sold (in an appropriate dollar amount) in an arms length transaction between a current shareholder and a new investor.

25% weighting to buyer demand for ABC Company common stock based on:

(a) Dollar amount and price indications of buyer demand for ABC common stock (a factor that may also be considered for partnership interests in the examples given earlier)

(b) Estimated fair market value for ABC

(c) Projected price per share at exit event and the holding period until exit event

(d) Market leadership position and size of market sector

(e) Scalability of business

(f) Direction of creditworthiness (e.g., a weakening credit because ABC is running out of cash)

(g) Access to raising capital

(h) Geographic region

(i) Average annual growth of revenue and earnings

(j) other factors as appropriate on a case by case basis

25% weighting to seller supply of ABC Company common stock based on dollar amount and price indications of offerings ABC common stock (a factor that can also be used in valuing partnership interests), size per offering (oddlot or round lot), and other factors as appropriate. If no information is available on the most recent price per share issued or sold by ABC company, the other weightings are adjusted as appropriate on a case by case basis. (This adjustment is also possible for valuing partnership interests.)

The prior two factors could be considered as simply a 50% weighting of the net demand (demand minus supply).

The following scenarios illustrate how the valuation made be used (similar scenarios apply to use of valuations of partnership interests, and the scenarios discussed above for partnership interests could also apply to private company interests and at least some of them are not repeated here, for simplicity):

### Example 1

If a private company seeks to raise capital and wants to know what should be the price of the new issue, the company could look up the price posted on the ticker for an estimate of fair market value. This price would then typically be further discounted by 10-30% to make the new issue security attractive to investors who seek to buy at a discount below fair value.

### Example 2

If the management of a private company wishes to discuss the increase or decrease in the company's stock price for the prior year in an annual report to shareholders, the company can use the price posted on the ticker for an independent estimate of the prior and current fair market value. This would help provide for more fair and independent reporting to shareholders and also protection to managers.

The techniques described above can be implemented in software or hardware or combinations of software and hardware using custom or commercial components. The communication among the parties that use the system can be through workstations, servers, handheld devices, or other devices. The communication may occur through the Internet or other publicly accessible network or through dialup lines or in other ways. User interaction may occur through browsers or through other kinds of interfaces.

Although certain implementations have been discussed above, other implementations are also within the scope of the claims.

For example, in the case of restricted interests in private companies, the displayed web pages and the information and features included in them could be somewhat different from the ones discussed earlier with respect to partnership interests.

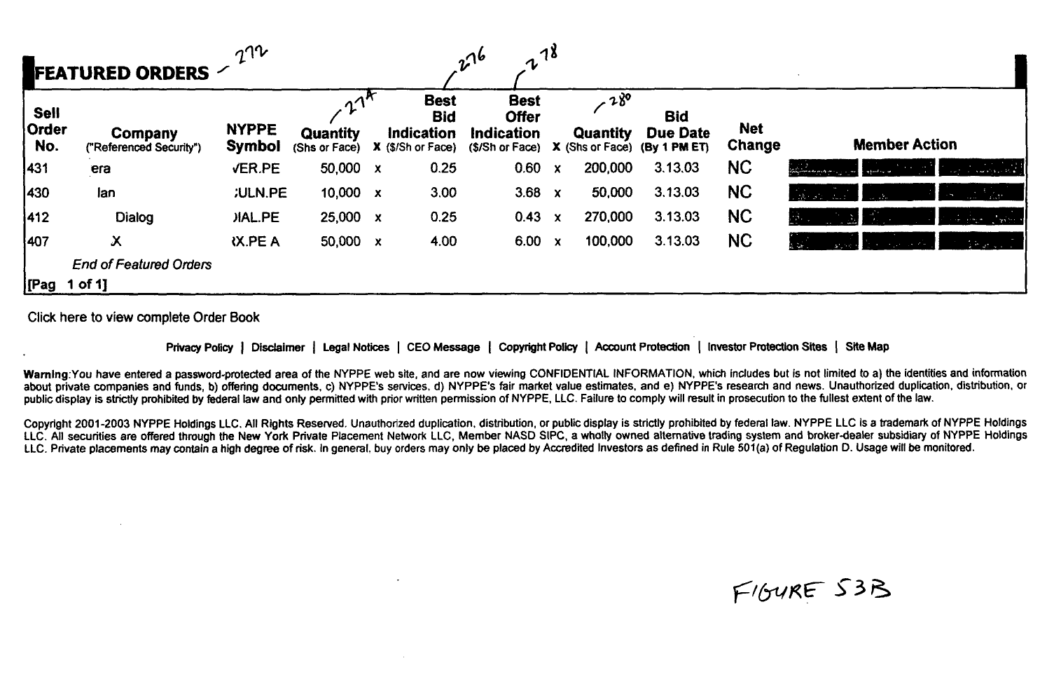

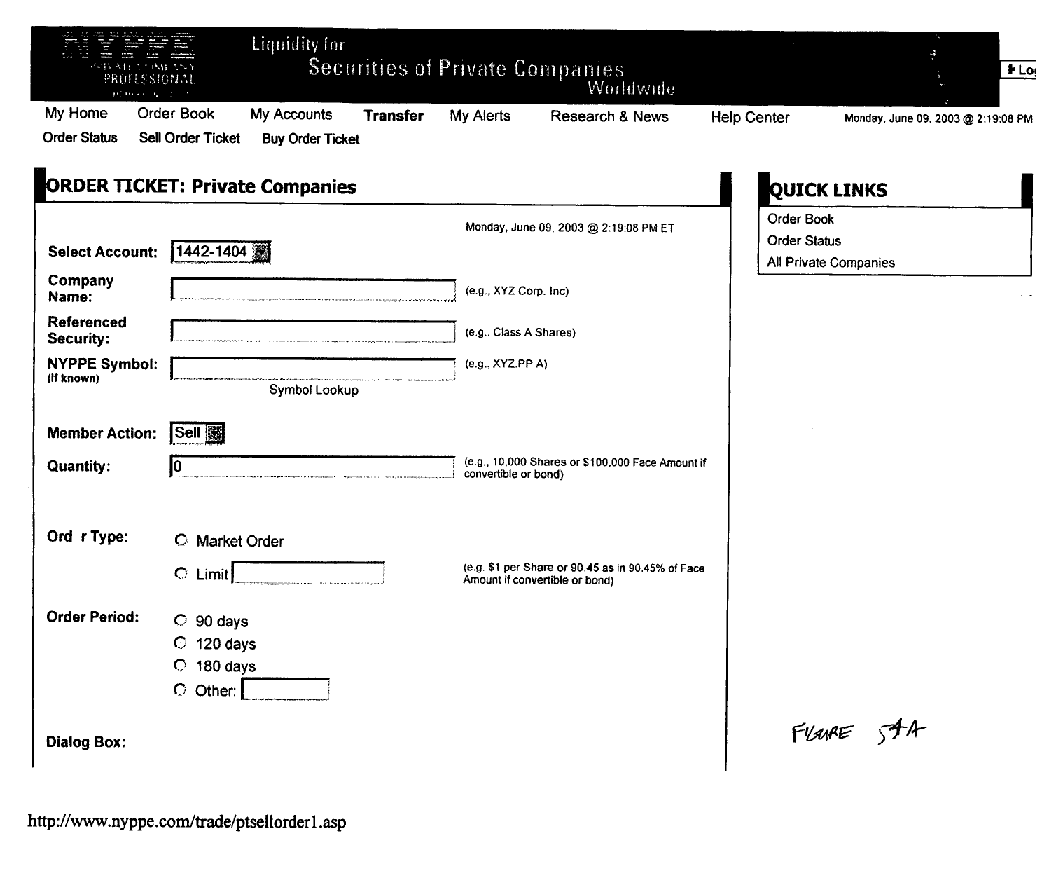

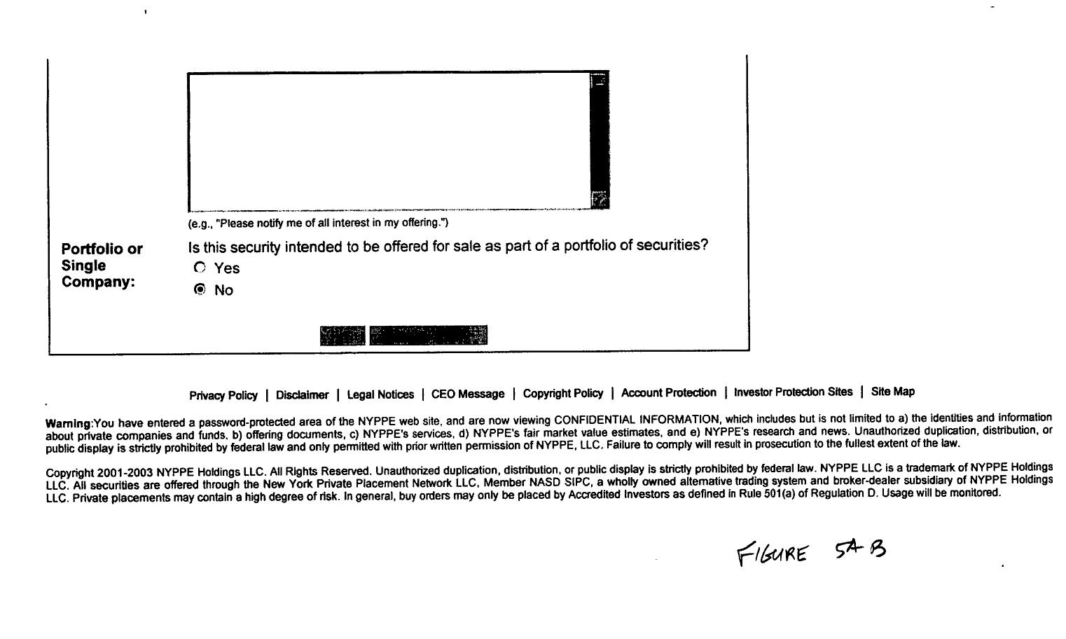

For example, as shown in FIG. 53A, in the case of the symbol used for a given interest may include an indicator of PE representing a private equity issuer. And the PE may be followed by an indicator, e.g., “A”, of the class of restricted interest associated with that private equity issuer.

With respect to the featured orders section 272, the information presented includes a quantity 274, a best bid indication 276, a best offer indication 278, and a quantity offered 280. The bid indications are expressed in dollars or face.

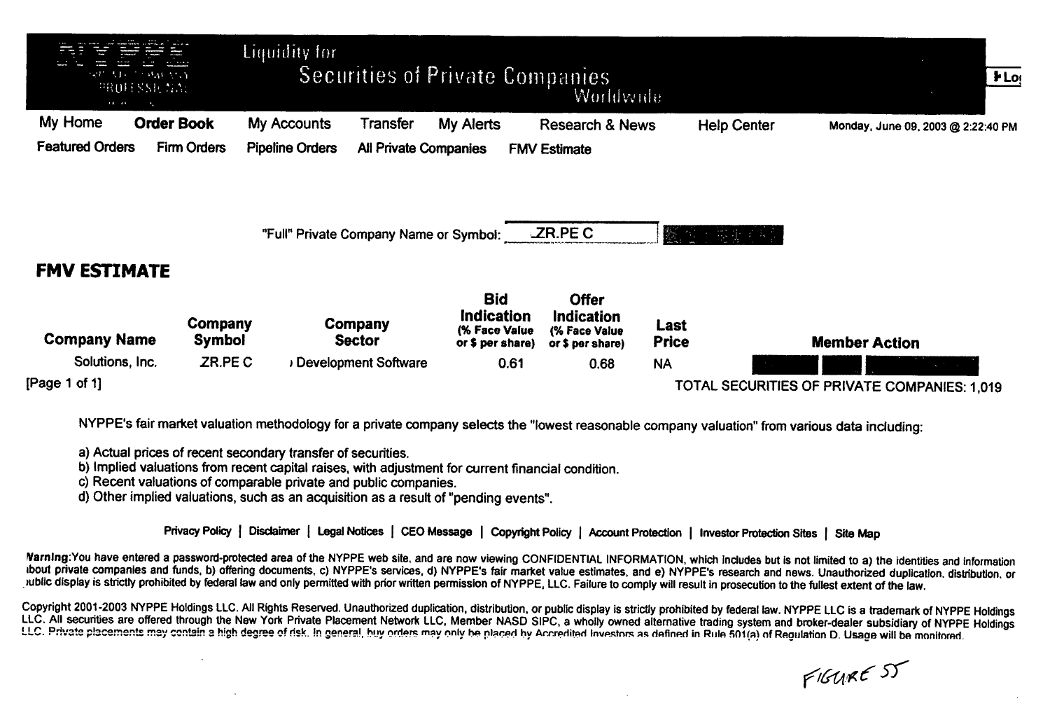

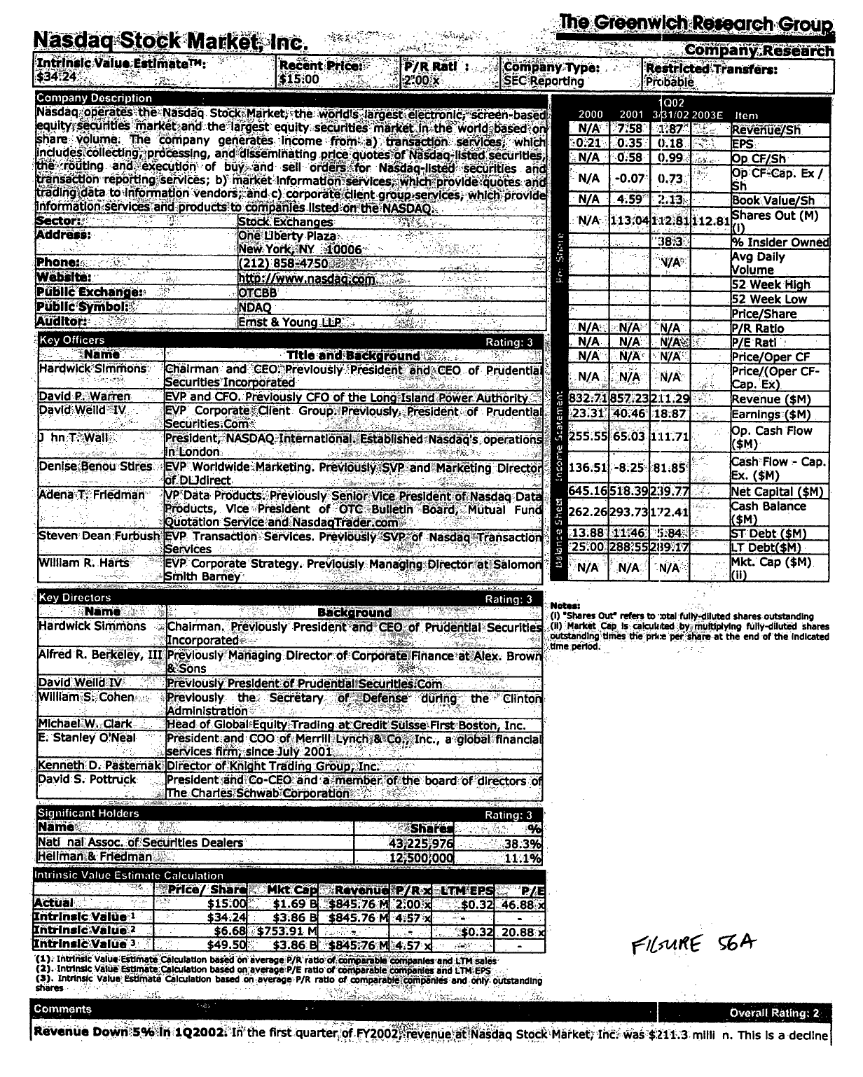

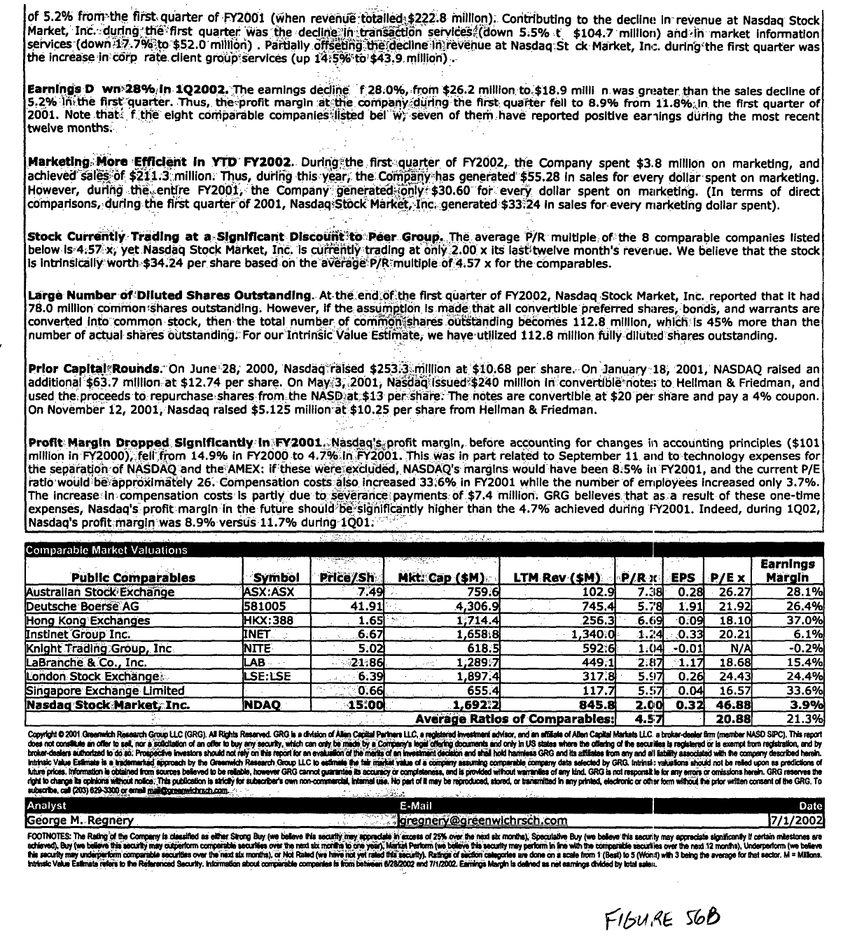

The order ticket, as shown in FIGS. 54A and 54B is similarly expressed in shares or face amount rather than as a percentage. In other pagers of the website associated with private companies, the bid and offer indications are also expressed as $ per share or face value. As shown in FIG. 55, however, the page on which estimated fair market value is expressed as a percentage of face value or $ per share.

1. A method comprising
receiving from users, buy or sell orders, each of the buy or sell orders being for an amount of an identified restricted interest to be subjected to a secondary transfer at a proposed value, and
displaying the buy and sell orders for review by online users.

2. The method of claim 1 in which the restricted interests comprise interests in limited partnerships.

3. The method of claim 1 in which the restricted interests comprise interests in private companies.

4. The method of claim 1 also including
displaying information about an issuer of the restricted interest.

5. The method of claim 4 also including
obtaining permission of the issuer of the restricted interest to display the information about the issuer.

6. The method of claim 1 in which the proposed value is expressed relative to an asset value associated with the interest.

7. The method of claim 6 in which the proposed value is expressed as a percentage of the net asset value of the interest.

8. The method of claim 1 in which the proposed value takes account of characteristics of the issuer of the interest.

9. The method of claim 1 in which the proposed value takes account of historic information associated with the issuer or the interest.

10. The method of claim 1 in which the proposed value takes account of market conditions.

11. The method of claim 1 in which the amount of the identified restricted interest represents a funded commitment and an unfunded commitment.

12. The method of claim 1 in which the online users comprise potential buyers and sellers of restricted interests.

13. The method of claim 1 in which the online users comprise an issuer of the restricted interest.

14. The method of claim 1 in which the restricted interest is identified by a symbol that includes an abbreviation representing the issuer of the interest uniquely as among other interests of a same type and by an identifier of the type of the interest.

15. The method of claim 14 also including a separator character between the abbreviation and the type.

16. The method of claim 15 in which the symbol is of the form XXXXX.YYY where XXXXX is an alphabetic string abbreviation of at least 3 characters and YYY is an alphabetic string identifier of a type.

17. The method of claim 1 in which the buy and sell orders are displayed only to online users who have demonstrated their compliance with regulatory or policy conditions to their being exposed to the orders.

18. A method comprising
receiving information related to the values of restricted interest in respective issuers,
estimating values of the restricted interests based on the received information, and
making the values accessible online to users.

19. The method of claim 18 in which at least some of the information is received from the issuers.

20. The method of claim 18 in which at least some of the information is received from the users.

21. The method of claim 18 in which at least some of the information is received from public sources.

22. The method of claim 18 in which at least some of the information is received from private sources.

23. The method of claim 18 in which the information includes data indicative of the reputations of the issuers.

24. The method of claim 18 in which the estimating is based on at least one of (enumerate the factors that determine the valuation).

25. The method of claim 18 in which the values are expressed relative to an asset value associated with the interest.

26. The method of claim 25 in which the proposed value is expressed as a percentage of the net asset value of the interest.

27. A method comprising
maintaining digital data representing valuations of previously issued restricted interests of respective issuers, and
providing the digital data for presentation to users.

28. The method of claim 27 in which the digital data is maintained on a server.

29. The method of claim 27 in which the valuations are expressed relative to asset values associated with the interests.

30. The method of claim 27 in which the valuations are expressed as percentages of the net asset values of the interests.

31. The method of claim 27 in which the digital data are provided in the form of a stream of digital data conveyed through a communication medium.

32. The method of claim 27 also including displaying the digital data to a user.

33. The method of claim 32 in which the digital data is displayed as a ticker.

34. The method of claim 32 in which the digital data is displayed by a party other than the party that maintains the data.

35. The method of claim 27 in which the digital data includes symbols representing issuers and numbers representing valuations.

36. The method of claim 35 in which each of the symbols includes an abbreviation representing the issuer of the interest uniquely as among other interests of a same type and includes an identifier of the type of the interest.

37. The method of claim 35 in which the digital data also includes a separator character between each of the abbreviations and the types.

38. The method of claim 37 in which each of the symbols is of the form XXXXX.YYY where XXXXX is an alphabetic string abbreviation of at least 3 characters and YYY is an alphabetic string identifier of a type.

39. A method comprising
maintaining information about progress of steps associated with a secondary transfer of a restricted interest of an issuer, and
enabling a user to review the progress electronically.

40. The method of claim 39 also including predefining steps associated with the secondary transfer of a particular type of restricted interest, and maintaining information about progress based on the predefined steps.

41. The method of claim 40 in which the predefined steps include steps to be performed by at least two different parties.

42. The method of claim 41 in which the two different parties include two of a buyer, a seller, an issuer, and an escrow agent.

43. The method of claim 39 in which the steps include steps performed by at least two different parties.

44. The method of claim 43 in which the two different parties include two of a buyer, a seller, an issuer, and an escrow agent.

45. The method of claim 39 in which enabling the user to review the progress electronically includes giving the user access to an online service that displays the progress.

46. The method of claim 39 in which the steps of the progress are organized by the parties who are to perform the steps or by chronological stages.

47. The method of claim 45 in which the progress is displayed in terms of the progress of each of at least two different parties in completing their respective steps.

48. The method of claim 39 in which the user is enabled to view documents associated with at least some of the steps.

49. The method of claim 40 in which the steps are predefined at least partially by the issuer of the interest.

50. A method comprising
receiving from a user of an online service a request for a valuation of an amount of a restricted interest that has been previously issued, and
generating the valuation based in part on stored information about an issuer of the restricted interest, and
providing the valuation online to the user.

51. The method of claim 50 in which the restricted interest includes a funded commitment and an unfunded commitment.

52. The method of claim 50 in which the restricted interest includes an interest in a limited partnership.

53. The method of claim 50 in which the restricted interest includes an interest in a private company.

54. The method of claim 50 in which the valuation includes information about the value of swapping the interest for another restricted interest.

55. The method of claim 50 in which the valuation is based in part on information received from the user about expected future performance of the interest.

56. The method of claim 50 in which the valuation is based upon (recite the factors) 57. The method of claim 50 in which the user is an owner of the interest.

58. The method of claim 50 in which the user is an agent acting on behalf of an owner of the interest.

59. The method of claim 50 also including receiving from the user a request for valuation of a portfolio of restricted interests, generating the valuation based on valuations of each of the interests, and providing the portfolio valuation online to the user.

60. A method comprising
expressing an order to buy or sell a restricted interest that has been previously issued in a digital format in which the identity of the interest is expressed as a predefined symbol, an amount of the interest is expressed in money, and a price for the interest is expressed in relationship to an asset value of the interest.

61. The method of claim 60 in which the order is expressed in fields of an online form.

62. The method of claim 60 in which the order expresses a funded aspect of the interest and an unfunded aspect of the interest.

63. A method comprising
receiving from an issuer of restricted interests that have previously been issued, policy information that defines the conditions under which the issuer will permit confidential information about the issuer or the restricted interests to be made available electronically to users, and
preventing the users from gaining electronic access to the confidential information except upon compliance with the conditions.

64. The method of claim 63 in which preventing access includes requiring the user to register.

65. The method of claim 63 including requiring the user to request permission to have access to the confidential information.

66. The method of claim 63 including requesting the issuer to approve access to the confidential information by the users based on information provided to the issuer.

67. A method comprising
predefining a set of documents to be made available to a user in connection with a transfer of a restricted interest that has been previously issued, the set of documents being predefined to satisfy applicable regulatory and policy requirements applicable to the transfer, and
making the set of documents accessible to the user online in connection with the transfer.

68. The method of claim 67 in which the set is predefined in part by an issuer of the interest.

69. The method of claim 67 in which the set includes a prior offering memorandum.

70. The method of claim 67 in which the set includes a recent financial statement.

71. A method comprising
receiving from a user information concerning historical performance of a restricted interest that has been previously issued, and
basing a valuation of interest in part on the historical performance information.

72. The method of claim 70 in which the historical performance information is confidential,

73. The method of claim 70 in which the user is an owner of the restricted interest.

74. The method of claim 70 in which the historical performance information comprises a sequence of return figures for a successive of periods of time.

75. A method comprising
receiving from a financial institution an online request to facilitate a transfer of a restricted interest that has previously been issued, from a seller to a buyer, and
serving the request by making an online market in restricted interests accessible to the seller and the buyer.

76. The method of claim 74 in which the seller is a customer of the financial institution.

77. A method comprising
receiving information about investment assets that have previously been issued, the information being useful to buyers or sellers of the securities, and
automatically generating research reports on the securities based on the information.

78. The method of claim 76 in which the reports include text generated automatically.

79. The method of claim 76 also including manually editing the automatically generated research reports.

80. The method of claim 76 in which the investment assets include restricted interests.

81. A method comprising
expressing a value of a restricted interest as a percentage of a nominal net asset value underlying the interest, and
making the value expressed as a percentage available to users electronically.
